(19) United States
(12) Patent Application Publication
(10) Pub. No.: US 2013/0325474 A1
(43) Pub. Date: Dec. 5, 2013

(54) SPEECH RECOGNITION ADAPTATION SYSTEMS BASED ON ADAPTATION DATA

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(21) Appl. No.: 13/485,738

(22) Filed: May 31, 2012

(51) Int. Cl. G10L 15/04; G10L 15/00; G10L 11/00

(52) U.S. Cl. 704/251; 704/200; 704/231; 704/E15.005

(57) ABSTRACT

Computationally implemented methods and systems include receiving indication of initiation of a speech-facilitated transaction between a party and a target device, and receiving adaptation data correlated to the party. The receiving is facilitated by a particular device associated with the party. The adaptation data is at least partly based on previous adaptation data derived at least in part from one or more previous speech interactions of the party. The methods and systems also include applying the received adaptation data correlated to the party to the target device, and processing speech from the party using the target device to which the received adaptation data has been applied. In addition to the foregoing, other aspects are described in the claims, drawings, and text.

### BACKGROUND

This application is related portable speech adaptation data.

### SUMMARY

A computationally implemented method includes, but is not limited to, receiving indication of initiation of a speech-facilitated transaction between a particular party and a target device, receiving adaptation data correlated to the particular party, said receiving facilitated by a particular device associated with the particular party, wherein the adaptation data is at least partly based on previous adaptation data derived at least in part from one or more previous speech interactions of the particular party, applying the received adaptation data correlated to the particular party to the target device, and processing speech from the particular party using the target device to which the received adaptation data has been applied. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally-implemented system includes, but is not limited to, means for receiving indication of initiation of a speech-facilitated transaction between a particular party and a target device, means for receiving adaptation data correlated to the particular party, said receiving facilitated by a particular device associated with the particular party, wherein the adaptation data is at least partly based on previous adaptation data derived at least in part from one or more previous speech interactions of the particular party, means for applying the received adaptation data correlated to the particular party to the target device, and means for processing speech from the particular party using the target device to which the received adaptation data has been applied.

A computationally-implemented system includes, but is not limited to, circuitry for receiving indication of initiation of a speech-facilitated transaction between a particular party and a target device, circuitry for receiving adaptation data correlated to the particular party, said receiving facilitated by a particular device associated with the particular party, wherein the adaptation data is at least partly based on previous adaptation data derived at least in part from one or more previous speech interactions of the particular party, circuitry for applying the received adaptation data correlated to the particular party to the target device, and circuitry for processing speech from the particular party using the target device to which the received adaptation data has been applied.

A computer program product comprising an article of manufacture bears instructions including, but not limited to, one or more instructions for receiving indication of initiation of a speech-facilitated transaction between a particular party and a target device, one or more instructions for receiving adaptation data correlated to the particular party, said receiving facilitated by a particular device associated with the particular party, wherein the adaptation data is at least partly based on previous adaptation data derived at least in part from one or more previous speech interactions of the particular party, one or more instructions for applying the received adaptation data correlated to the particular party to the target device, and one or more instructions for processing speech from the particular party using the target device to which the received adaptation data has been applied.

A computationally-implemented method that specifies that a plurality of transistors and/or switches reconfigure themselves into a machine that carries out the following including, but not limited to, receiving indication of initiation of a speech-facilitated transaction between a particular party and a target device, receiving adaptation data correlated to the particular party, said receiving facilitated by a particular device associated with the particular party, wherein the adaptation data is at least partly based on previous adaptation data derived at least in part from one or more previous speech interactions of the particular party, applying the received adaptation data correlated to the particular party to the target device, and processing speech from the particular party using the target device to which the received adaptation data has been applied.

A computer architecture comprising at least one level, comprising architecture configured to be receiving indication of initiation of a speech-facilitated transaction between a particular party and a target device, architecture configured to be receiving adaptation data correlated to the particular party, said receiving facilitated by a particular device associated with the particular party, wherein the adaptation data is at least partly based on previous adaptation data derived at least in part from one or more previous speech interactions of the particular party, architecture configured to be applying the received adaptation data correlated to the particular party to the target device, and architecture configured to be processing speech from the particular party using the target device to which the received adaptation data has been applied.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of a terminal device 30 operating in an exemplary environment 100, according to an embodiment.

FIG. 2, including FIGS. 2A-2B, shows a particular perspective of the speech-facilitated transaction initiation between particular party and target device indicator receiving module 52 of the terminal device 30 of environment 100 of FIG. 1.

FIG. 3, including FIGS. 3A-3K, shows a particular perspective of the particular party-correlated previous speech interaction based adaptation data from particular-party associated particular device receiving module 54 of the terminal device 30 of environment 100 of FIG. 1.

FIG. 4, including FIGS. 4A-4C, shows a particular perspective of the received adaptation data to target device applying module 56 of the terminal device 30 of environment 100 of FIG. 1.

FIG. 5, including FIGS. 5A-5C, shows a particular perspective of the target device particular party speech processing using received adaptation data module 58 of the terminal device 30 of environment 100 of FIG. 1.

FIG. 6 is a high-level logic flowchart of a process, e.g., operational flow 600, according to an embodiment.

FIG. 7A is a high-level logic flowchart of a process depicting alternate implementations of an indication of initiation receiving operation 502 of FIG. 6.

FIG. 7B is a high-level logic flowchart of a process depicting alternate implementations of the indication of initiation receiving operation 502 of FIG. 6.

FIG. 7C is a high-level logic flowchart of a process depicting alternate implementations of the indication of initiation receiving operation 502 of FIG. 6.

FIG. 8A is a high-level logic flowchart of a process depicting alternate implementations of an adaptation data receiving operation 504 of FIG. 6.

FIG. 8B is a high-level logic flowchart of a process depicting alternate implementations of the adaptation data receiving operation 504 of FIG. 6.

FIG. 8C is a high-level logic flowchart of a process depicting alternate implementations of the adaptation data receiving operation 504 of FIG. 6.

FIG. 8D is a high-level logic flowchart of a process depicting alternate implementations of the adaptation data receiving operation 504 of FIG. 6.

FIG. 8E is a high-level logic flowchart of a process depicting alternate implementations of the adaptation data receiving operation 504 of FIG. 6.

FIG. 8F is a high-level logic flowchart of a process depicting alternate implementations of the adaptation data receiving operation 504 of FIG. 6.

FIG. 8G is a high-level logic flowchart of a process depicting alternate implementations of the adaptation data receiving operation 504 of FIG. 6.

FIG. 8H is a high-level logic flowchart of a process depicting alternate implementations of the adaptation data receiving operation 504 of FIG. 6.

FIG. 8I is a high-level logic flowchart of a process depicting alternate implementations of the adaptation data receiving operation 504 of FIG. 6.

FIG. 8J is a high-level logic flowchart of a process depicting alternate implementations of the adaptation data receiving operation 504 of FIG. 6.

FIG. 8K is a high-level logic flowchart of a process depicting alternate implementations of the adaptation data receiving operation 504 of FIG. 6.

FIG. 8L is a high-level logic flowchart of a process depicting alternate implementations of the adaptation data receiving operation 504 of FIG. 6.

FIG. 8M is a high-level logic flowchart of a process depicting alternate implementations of the adaptation data receiving operation 504 of FIG. 6.

FIG. 8N is a high-level logic flowchart of a process depicting alternate implementations of the adaptation data receiving operation 504 of FIG. 6.

FIG. 8P is a high-level logic flowchart of a process depicting alternate implementations of the adaptation data receiving operation 504 of FIG. 6.

FIG. 9A is a high-level logic flowchart of a process depicting alternate implementations of a received adaptation data applying operation 506 of FIG. 6.

FIG. 9B is a high-level logic flowchart of a process depicting alternate implementations of the received adaptation data applying operation 506 of FIG. 6.

FIG. 9C is a high-level logic flowchart of a process depicting alternate implementations of the received adaptation data applying operation 506 of FIG. 6.

FIG. 10A is a high-level logic flowchart of a process depicting alternate implementations of a speech processing operation 508 of FIG. 6.

FIG. 10B is a high-level logic flowchart of a process depicting alternate implementations of the speech processing operation 508 of FIG. 6.

FIG. 10C is a high-level logic flowchart of a process depicting alternate implementations of the speech processing operation 508 of FIG. 6.

FIG. 10D is a high-level logic flowchart of a process depicting alternate implementations of the speech processing operation 508 of FIG. 6.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The proliferation of automation in many transactions is apparent. For example, Automated Teller Machines (“ATMs”) dispense money and receive deposits. Airline ticket counter machines check passengers in, dispense tickets, and allow passengers to change or upgrade flights. Train and subway ticket counter machines allow passengers to purchase a ticket to a particular destination without invoking a human interaction at all. Many groceries and pharmacies have self service checkout machines which allow a consumer to pay for goods purchased by interacting only with a machine. Large companies now staff telephone answering systems with machines that interact with customers, and invoke a human in the transaction only if there is a problem with the machine-facilitated transaction.

Nevertheless, as such automation increases, convenience and accessibility may decrease. Self-checkout machines at grocery stores may be difficult to operate. ATMs and ticket counter machines may be mostly inaccessible to disabled persons or persons requiring special access. Where before, the interaction with a human would allow disabled persons to complete transactions with relative ease, if a disabled person is unable to push the buttons on an ATM, there is little the machine can do to facilitate the transaction to completion. While some of these public terminals allow speech operations, they are configured to the most generic forms of speech, which may be less useful in recognizing particular speakers, thereby leading to frustration for users attempting to speak to the machine. This problem may be especially challenging for the disabled, who already may face significant challenges in completing transactions with automated machines.

In addition, smartphones and tablet devices also now are configured to receive speech commands. Speech and voice controlled automobile systems now appear regularly in motor vehicles, even in economical, mass-produced vehicles. Home entertainment devices, e.g., disc players, televisions, radios, stereos, and the like, may respond to speech commands. Additionally, home security systems may respond to speech commands. In an office setting, a worker's computer may respond to speech from that worker, allowing faster, more efficient work flows. Such systems and machines may be trained to operate with particular users, either through explicit training or through repeated interactions. Nevertheless, when that system is upgraded or replaced, e.g., a new TV is bought, that training may be lost with the device.

Thus, adaptation data for speech recognition systems may be separated from the device which recognizes the speech, and may be more closely associated with a user, e.g., through a device carried by the user, or through a network location associated with the user. In accordance with various embodiments, computationally implemented methods, systems, circuitry, articles of manufacture, and computer program products are designed to, among other things, provide an interface for receiving indication of initiation of a speech-facilitated transaction between a particular party and a target device, receiving adaptation data correlated to the particular party, said receiving facilitated by a particular device associated with the particular party, wherein the adaptation data is at least partly based on previous adaptation data derived at least in part from one or more previous speech interactions of the particular party, applying the received adaptation data correlated to the particular party to the target device, and processing speech from the particular party using the target device to which the received adaptation data has been applied.

The foregoing summary is illustrative only and is not intended to be in any way limiting. In addition to the illustrative aspects, embodiments, and features described above, further aspects, embodiments, and features will become apparent by reference to the drawings and the following detailed description.

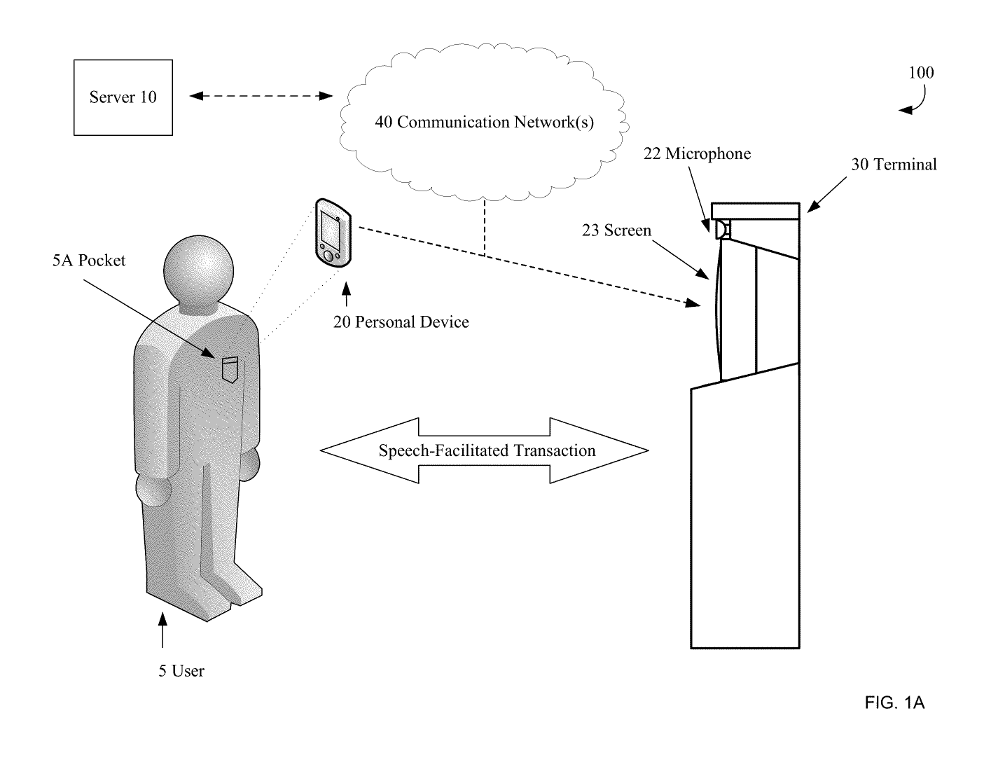

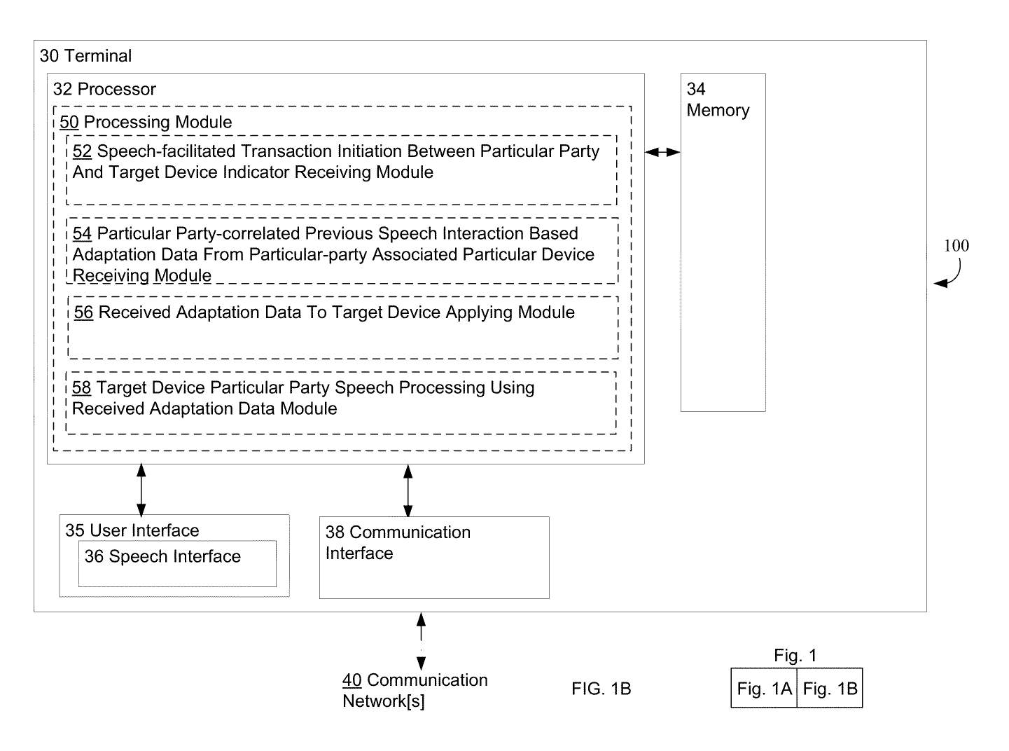

Referring now to FIG. 1, FIG. 1 illustrates an example environment 100 in which the methods, systems, circuitry, articles of manufacture, and computer program products and architecture, in accordance with various embodiments, may be implemented by terminal device 30. The terminal device 30, in various embodiments, may be endowed with logic that is designed for receiving indication of initiation of a speech-facilitated transaction between a particular party and a target device, receiving adaptation data correlated to the particular party, said receiving facilitated by a particular device associated with the particular party, wherein the adaptation data is at least partly based on previous adaptation data derived at least in part from one or more previous speech interactions of the particular party, applying the received adaptation data correlated to the particular party to the target device, and processing speech from the particular party using the target device to which the received adaptation data has been applied.

Referring again to the exemplary embodiment 100 of FIG. 1, a user 5 may engage in a speech-facilitated transaction with a terminal device 30. Terminal device 30 may include a microphone 22 and a screen 23. In some embodiments, screen 23 may be a touchscreen. Although FIG. 1A depicts terminal device 30 as a terminal for simplicity of illustration, terminal device 30 could be any device that is configured to receive speech. For example, terminal device 30 may be a terminal, a computer, a navigation system, a phone, a piece of home electronics (e.g., a DVD player, Blu-Ray player, media player, game system, television, receiver, alarm clock, and the like). Terminal device 30 may, in some embodiments, be a home security system, a safe lock, a door lock, a kitchen appliance configured to receive speech, and the like. In some embodiments, terminal device 30 may be a motorized vehicle, e.g., a car, boat, airplane, motorcycle, golf cart, wheelchair, and the like. In some embodiments, terminal device 30 may be a piece of portable electronics, e.g., a laptop computer, a netbook computer, a tablet device, a smartphone, a cellular phone, a radio, a portable navigation system, or any other piece of electronics capable of receiving speech. Terminal device 30 may be a part of an enterprise solution, e.g., a common workstation in an office, a copier, a scanner, a personal workstation in a cubicle, an office directory, an interactive screen, and a telephone. These examples and lists are not meant to be exhaustive, but merely to illustrate a few examples of the terminal device.

In an embodiment, personal device 20 may facilitate the transmission of adaptation data to the terminal 30. In FIG. 1A, personal device 20 is shown as a phone-type device that fits into pocket 5A of the user. Nevertheless, in other embodiments, personal device 20 may be any size and have any specification. Personal device 20 may be a custom device of any shape or size, configured to transmit, receive, and store data. Personal device 20 may include, but is not limited to, a smartphone device, a tablet device, a personal computer device, a laptop device, a keychain device, a key, a personal digital assistant device, a modified memory stick, a universal remote control, or any other piece of electronics. In addition, personal device 20 may be a modified object that is worn, e.g., eyeglasses, a wallet, a credit card, a watch, a chain, or an article of clothing. Anything that is configured to store, transmit, and receive data may be a personal device 20, and personal device 20 is not limited in size to devices that are capable of being carried by a user. Additionally, personal device 20 may not be in direct proximity to the user, e.g., personal device 20 may be a computer sitting on a desk in a user's home or office.

In some embodiments, terminal 30 receives adaptation data from the personal device 20, in a process that will be described in more detail herein. In some embodiments, the adaptation data is transmitted over one or more communication network(s) 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to one or more communication networks, which may or may not interact with each other.

In some embodiments, the adaptation data does not come directly from the personal device 20. In some embodiments, personal device 20 merely facilitates communication of the adaptation data, e.g., by providing one or more of an address, credentials, instructions, authorization, and recommendations. For example, in some embodiments, personal device 20 provides a location at server 10 at which adaptation data may be received. In some embodiments, personal device 20 retrieves adaptation data from server 10 upon a request from the terminal device 30, and then relays or facilitates in the relaying of the adaptation data to terminal device 30.

In some embodiments, personal device 20 broadcasts the adaptation data regardless of whether a terminal device 30 is listening, e.g., at predetermined, regular, or otherwise-defined intervals. In other embodiments, personal device 20 listens for a request from a terminal device 30, and transmits or broadcasts adaptation data in response to that request. In some embodiments, user 5 determines when personal device 20 broadcasts adaptation data. In still other embodiments, a third party (not shown) triggers the transmission of adaptation data to the terminal device 30, in which the transmission is facilitated by the personal device 20.

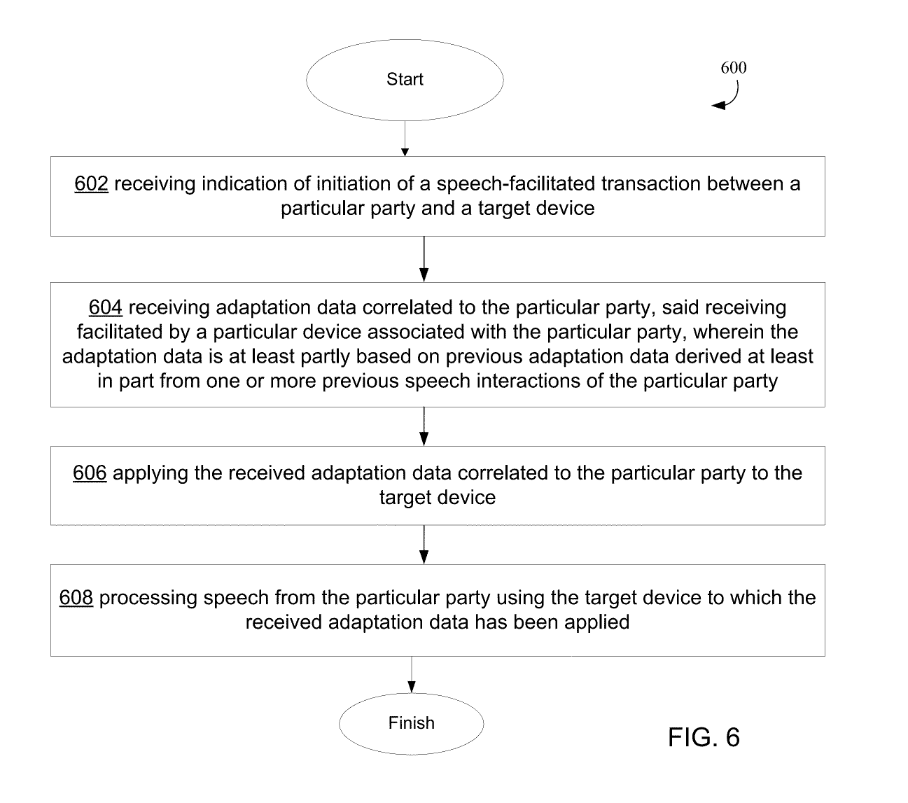

Referring again to the exemplary environment 100 depicted in FIG. 1, in various embodiments, the terminal device 30 may comprise, among other elements, a processor 32, a memory 34, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 6, 7A-7C, 8A-8P, 9A-9C, and 10A-10D. In some embodiments, processor 32 is designed to be configured to operate as processing module 50, which may include speech-facilitated transaction initiation between particular party and target device indicator receiving module 52, particular party-correlated previous speech interaction based adaptation data from particular-party associated particular device receiving module 54, received adaptation data to target device applying module 56, and target device particular party speech processing using received adaptation data module 58.

Referring again to the exemplary environment 100 of FIG. 1, terminal device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, terminal device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user. The user interface 35 also may include a speech interface 36, which is configured to receive and/or process speech as input.

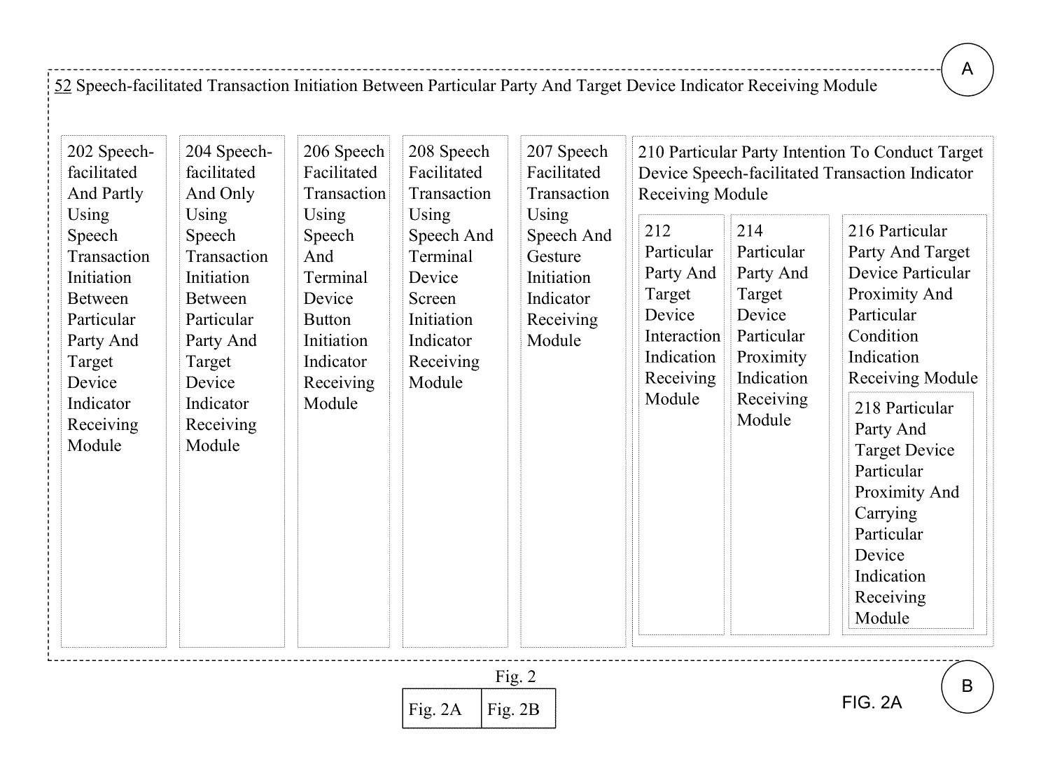

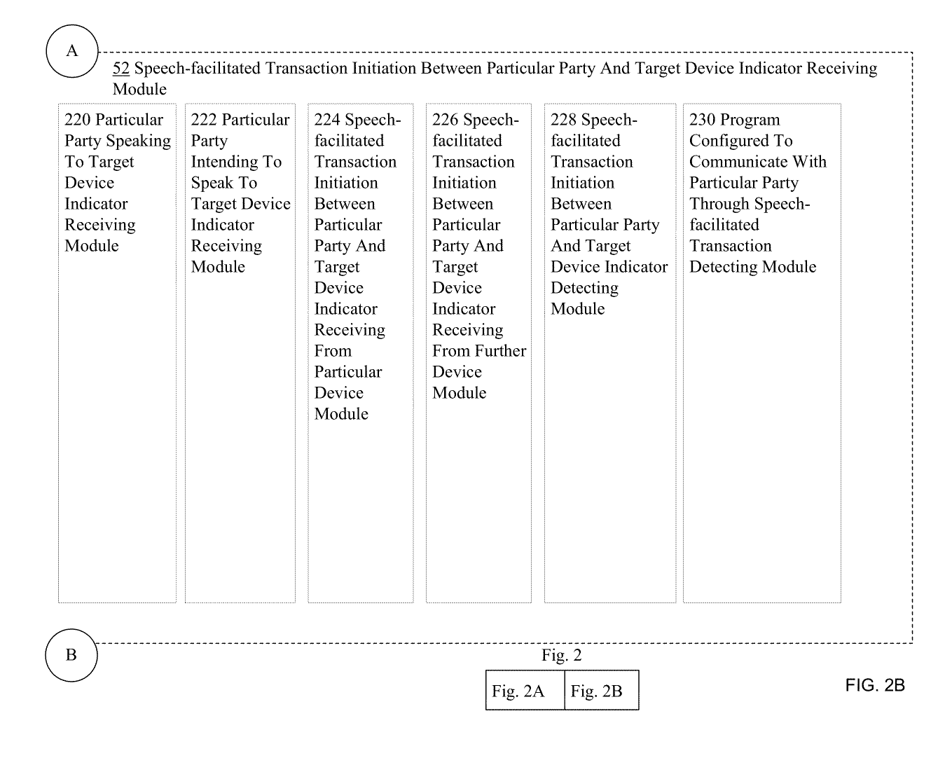

Referring now to FIG. 2, FIG. 2 illustrates an exemplary implementation of the speech-facilitated transaction initiation between particular party and target device indicator receiving module 52. As illustrated in FIG. 2, (e.g., FIG. 2A), the speech-facilitated transaction initiation between particular party and target device indicator receiving module 52 may include one or more sub-logic modules in various alternative implementations and embodiments. For example, in some embodiments, module 52 may include speech-facilitated and partly using speech transaction initiation between particular party and target device indicator receiving module 202, speech-facilitated and only using speech transaction initiation between particular party and target device indicator receiving module 204, speech facilitated transaction using speech and terminal device button initiation indicator receiving module 206, speech facilitated transaction using speech and terminal device screen initiation indicator receiving module 208, speech facilitated transaction using speech and gesture initiation indicator receiving module 207, and particular party intention to conduct target device speech-facilitated transaction indicator receiving module 210. In some embodiments, module 210 may include particular party and target device interaction indication receiving module 212, particular party and target device particular proximity indication receiving module 214, and particular party and target device particular proximity and particular condition indication receiving module 216 (e.g., which, in some embodiments, may include particular party and target device particular proximity and carrying particular device indication receiving module 218.

Referring again to FIG. 2 (e.g., FIG. 2B), module 52 may include particular party speaking to target device indicator receiving module 220, particular party intending to speak to target device indicator receiving module 222, speech-facilitated transaction initiation between particular party and target device indicator receiving from particular device module 224, speech-facilitated transaction initiation between particular party and target device indicator receiving from further device module 226, speech-facilitated transaction initiation between particular party and target device indicator detecting module 228, and program configured to communicate with particular party through speech-facilitated transaction launch detecting module 230.

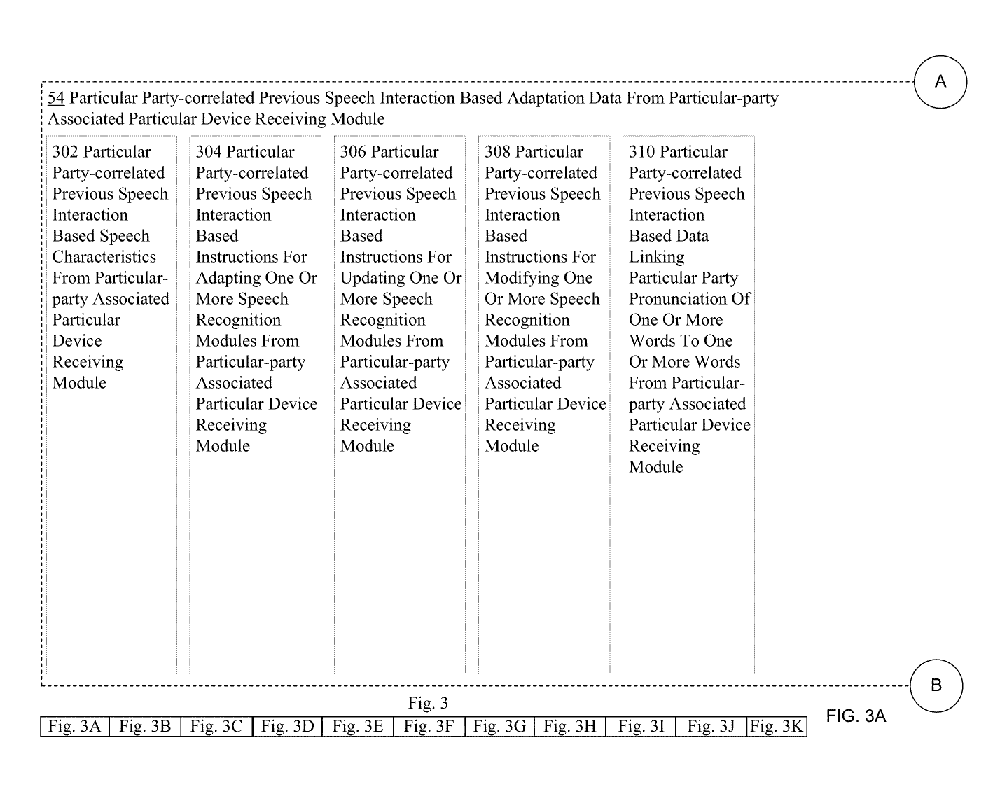

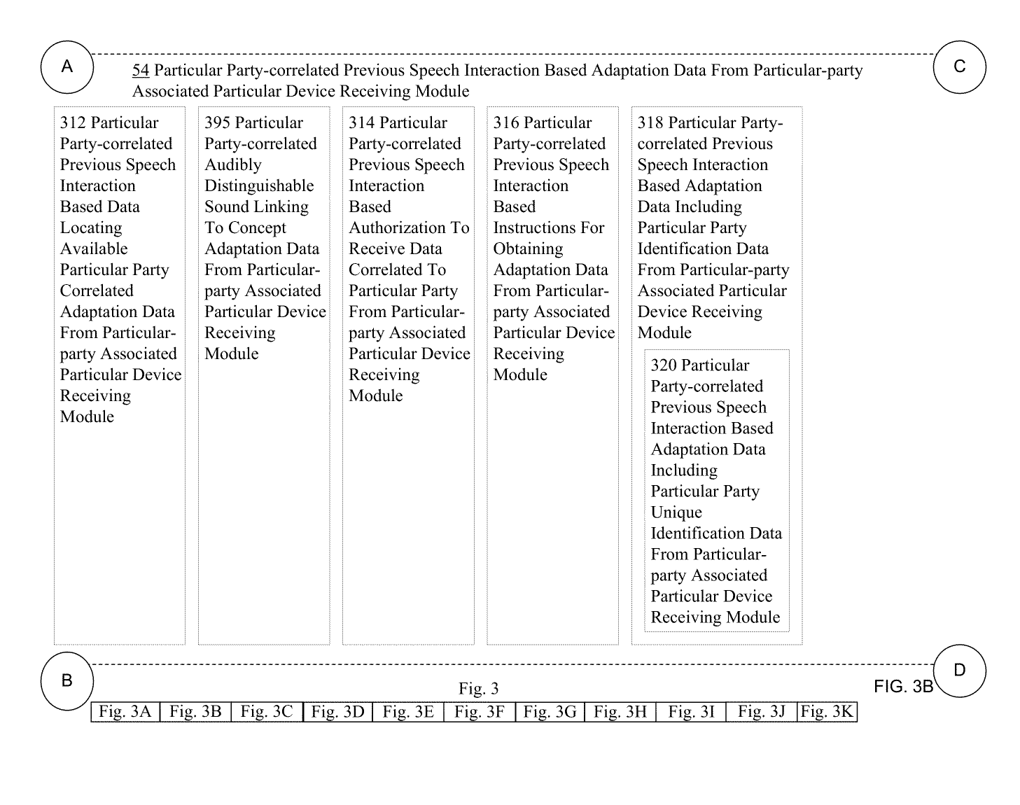

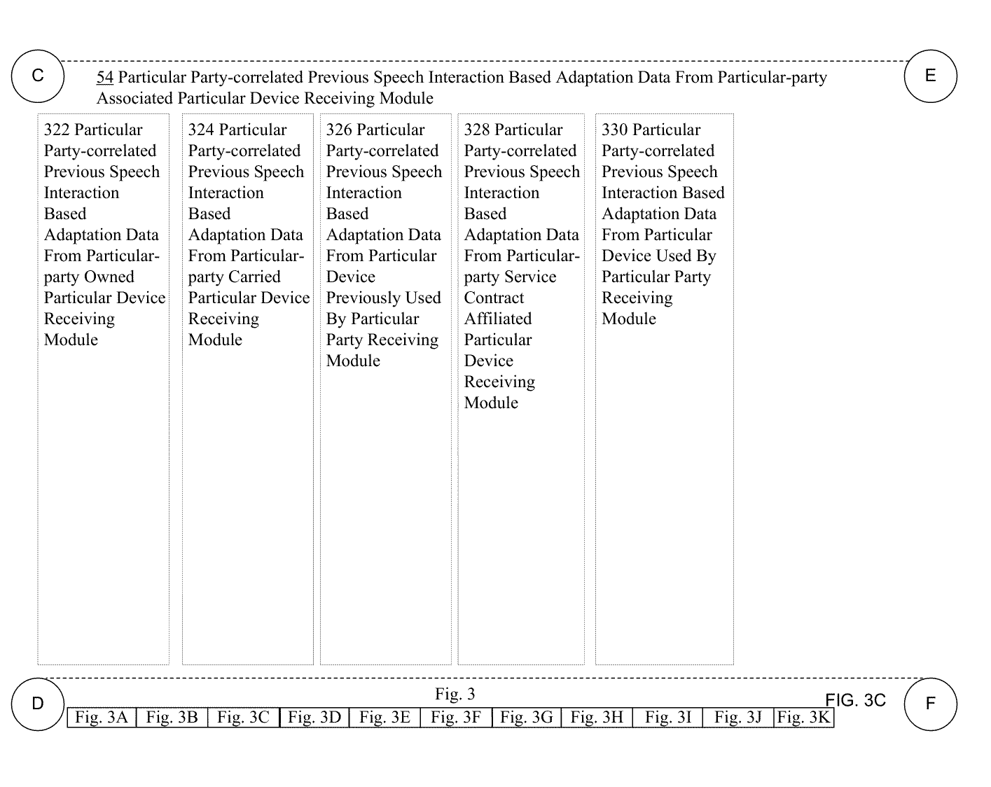

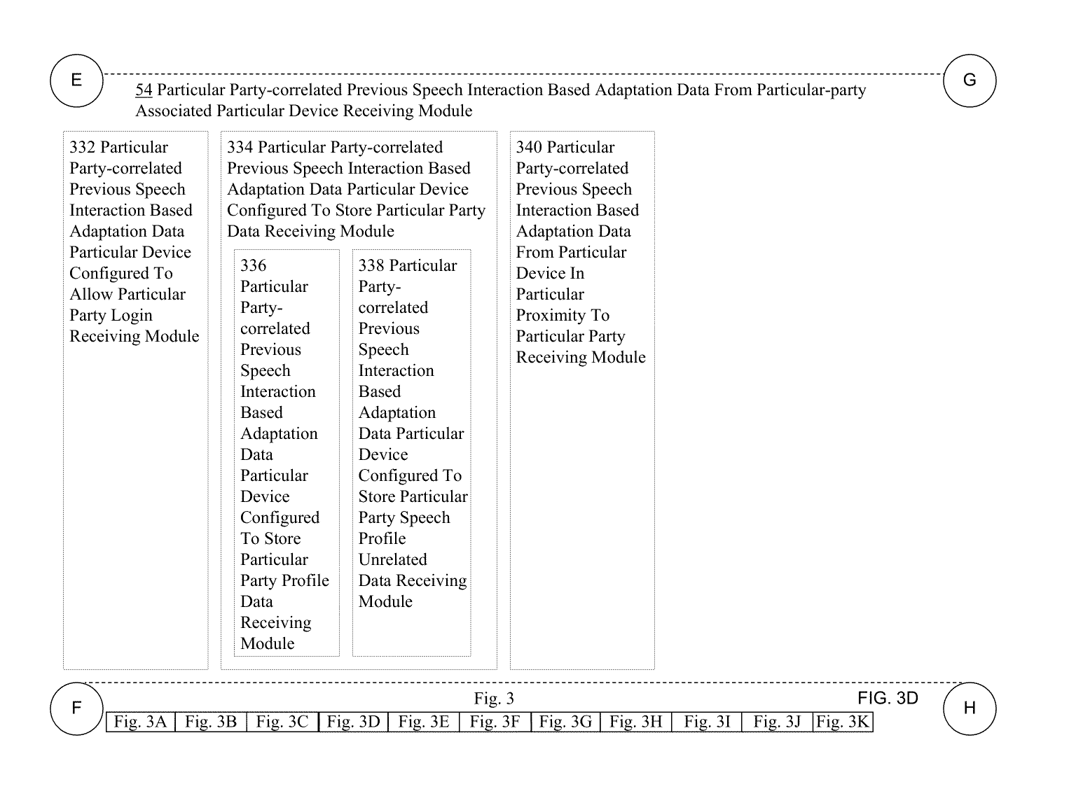

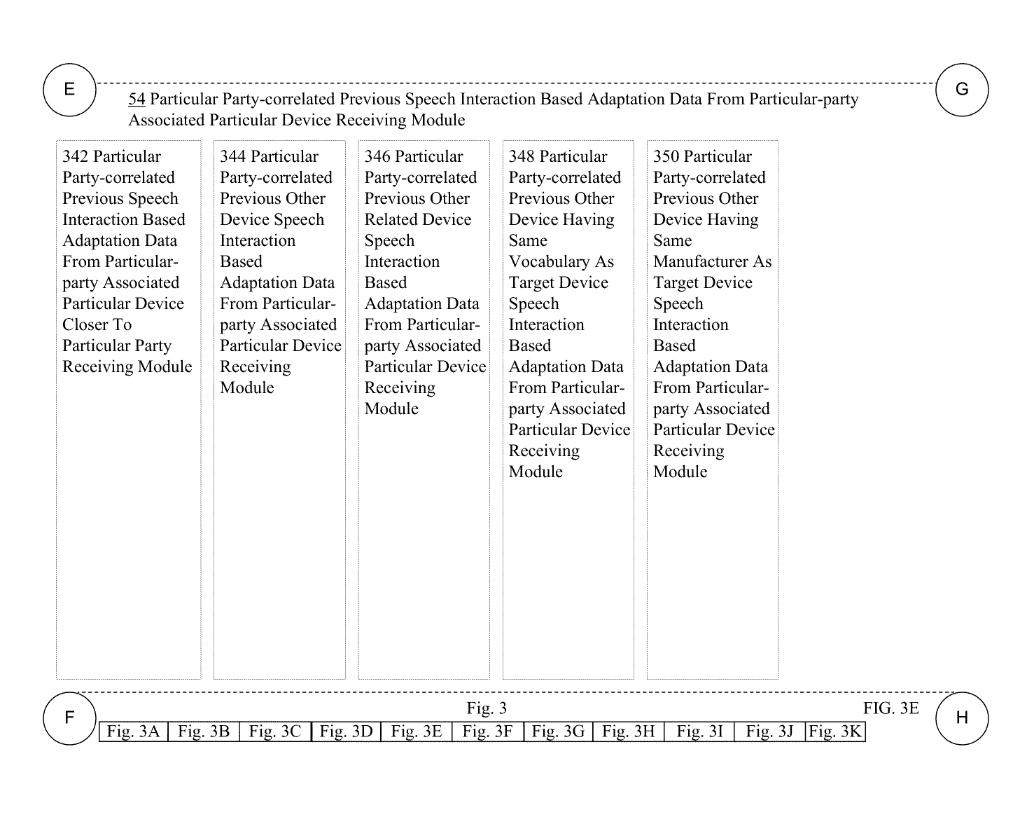

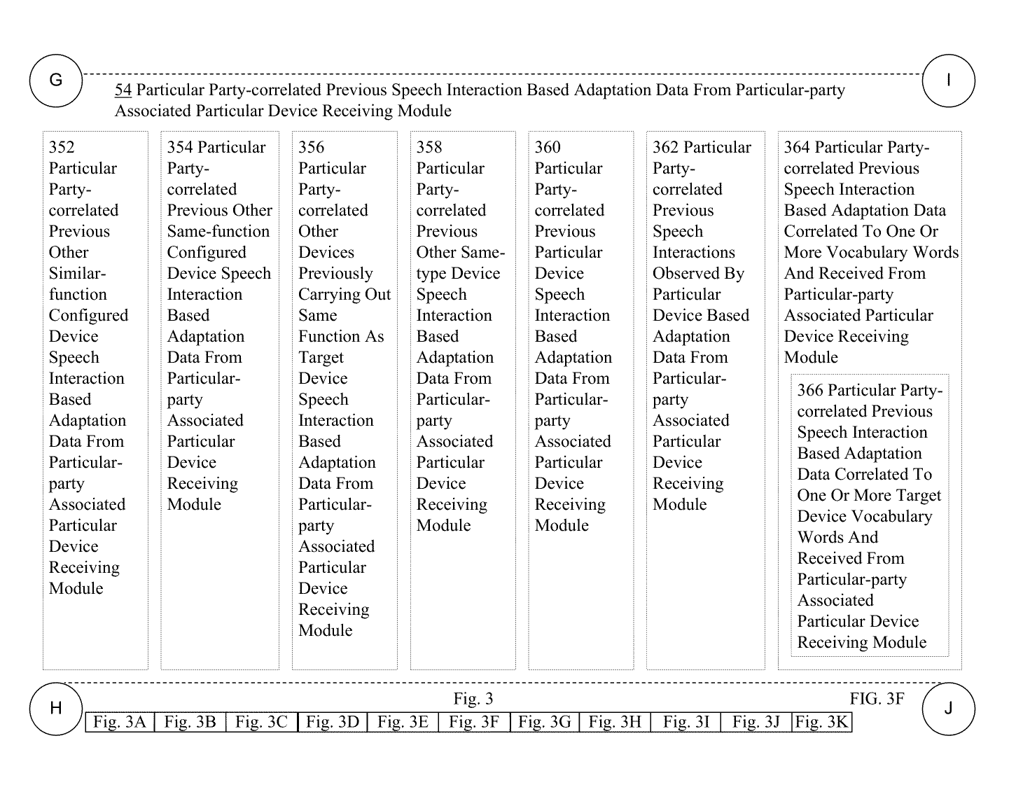

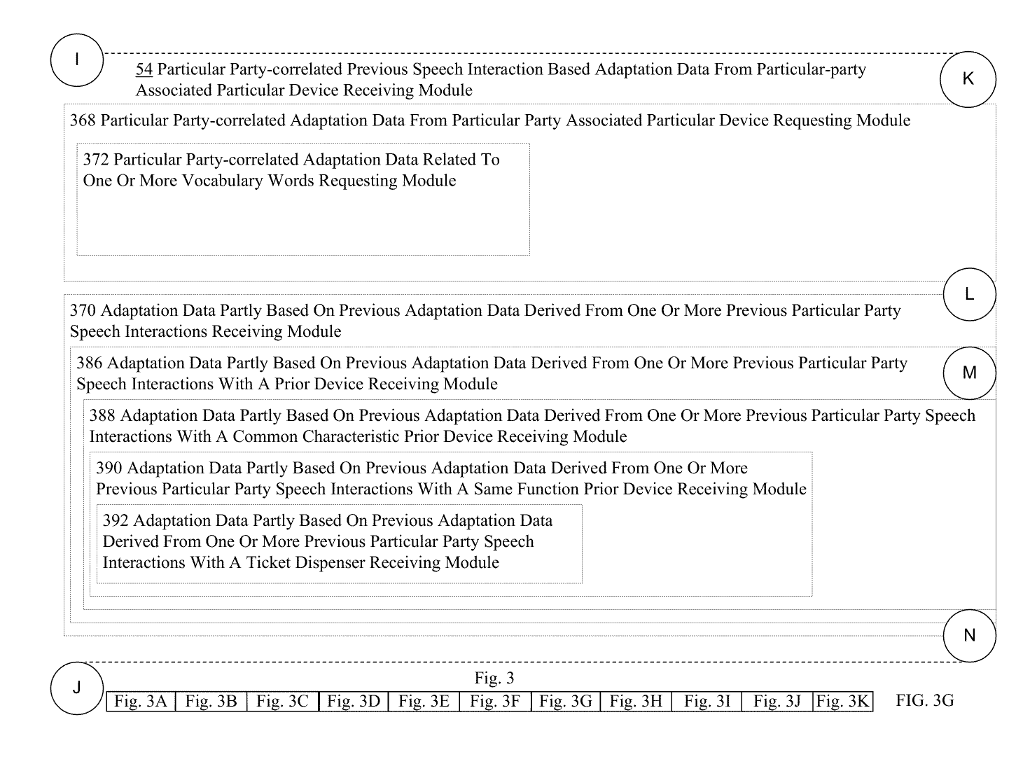

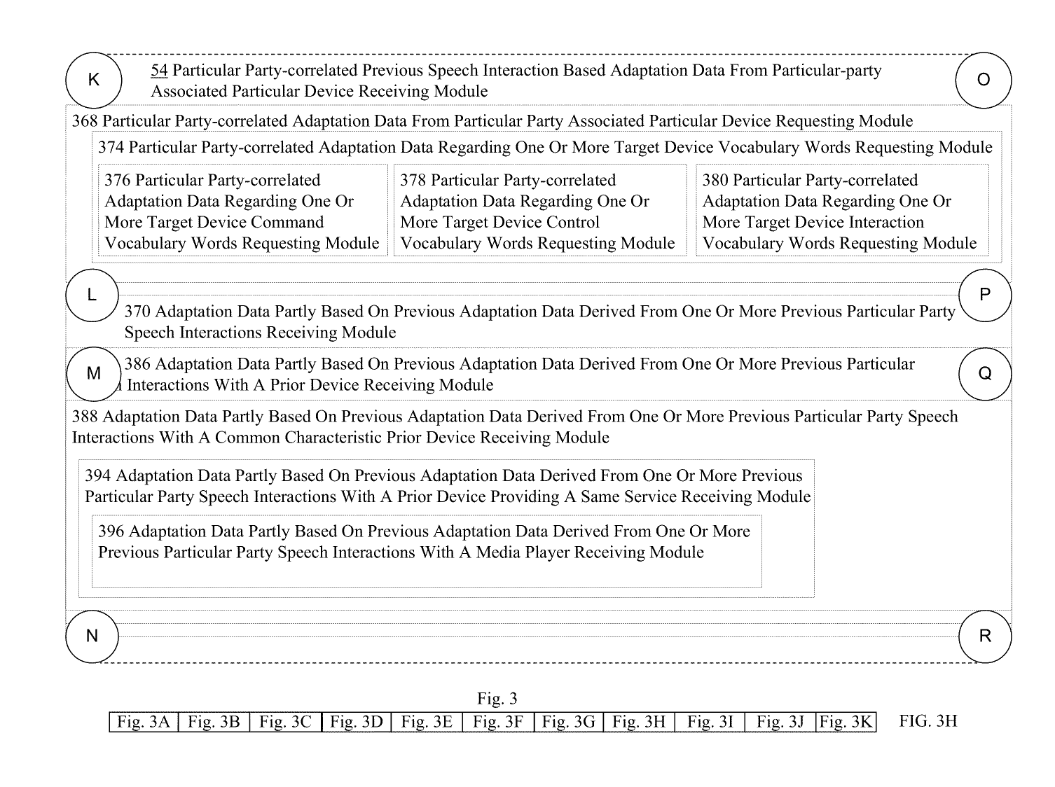

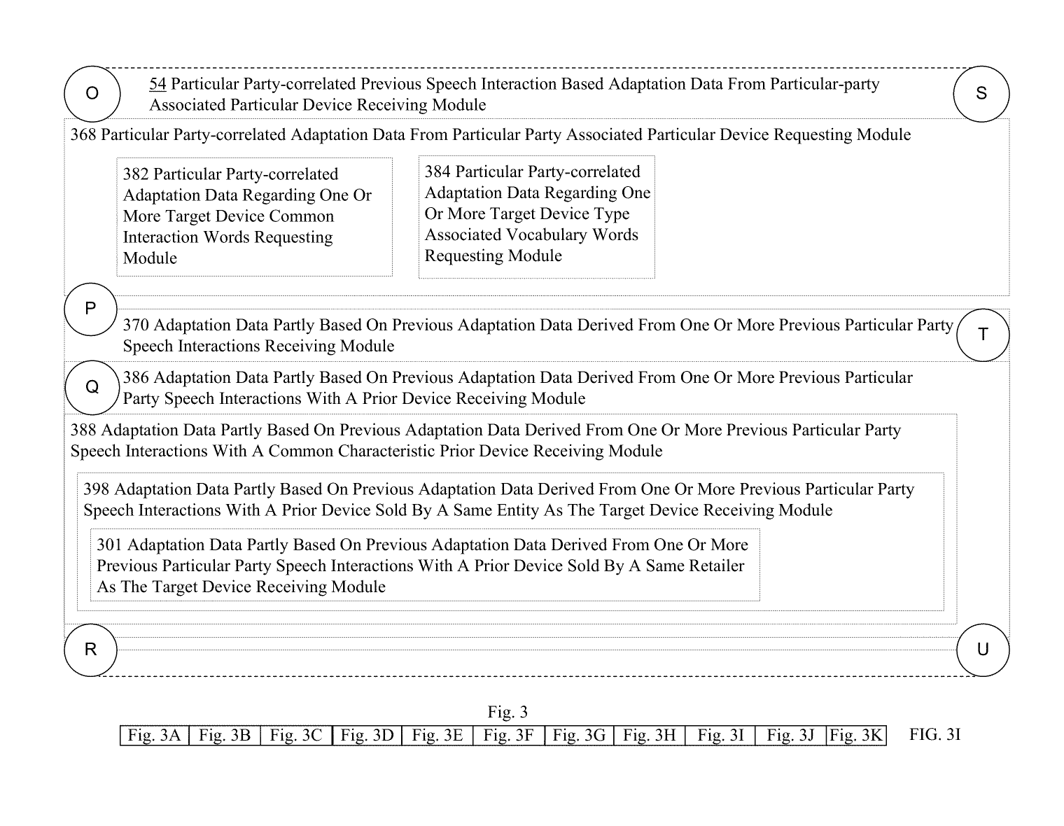

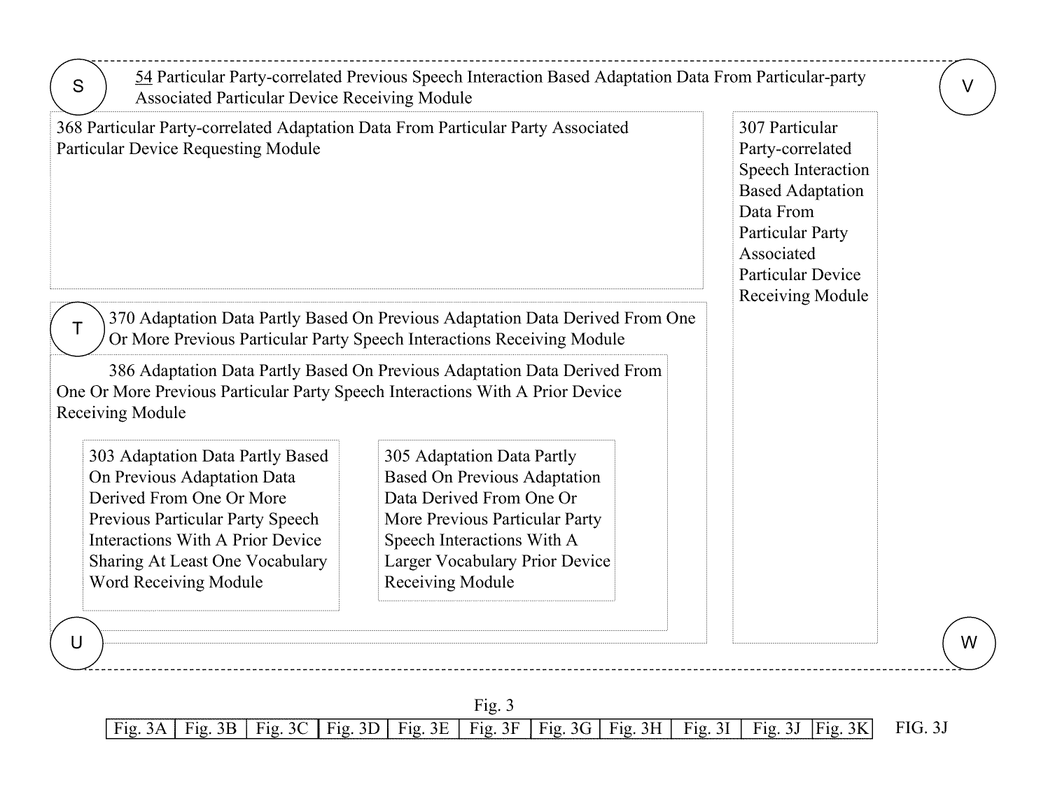

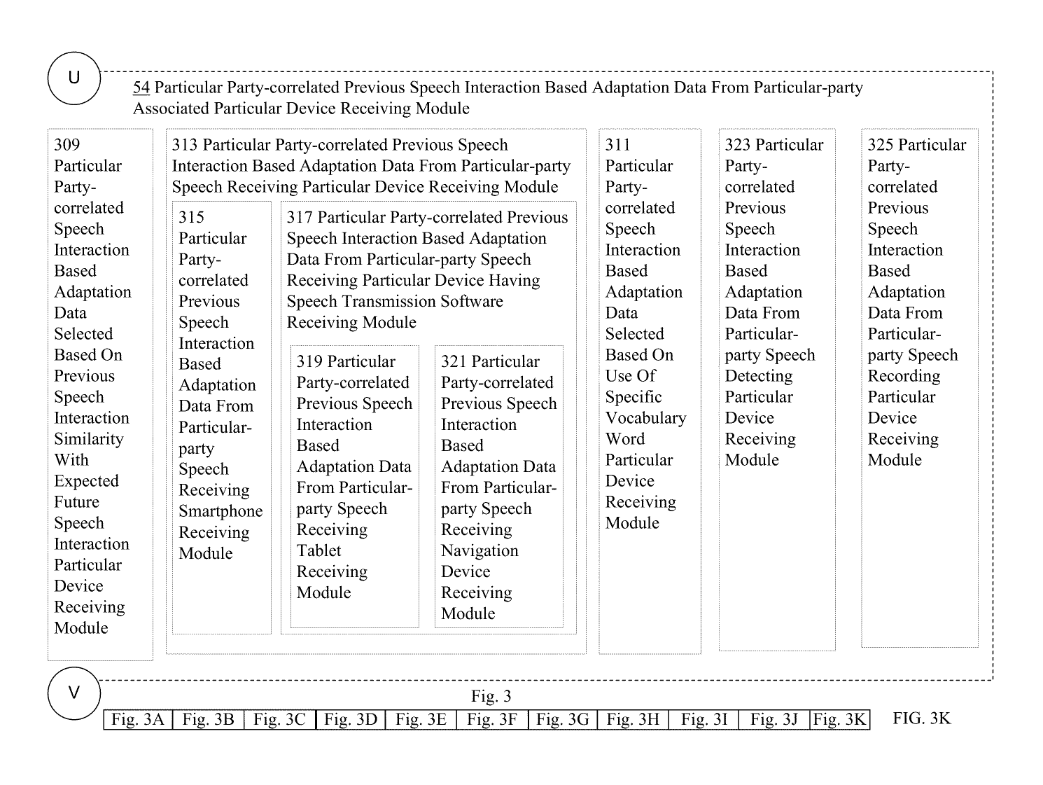

Referring now to FIG. 3, FIG. 3 illustrates an exemplary implementation of the particular party-correlated previous speech interaction based adaptation data from particular-party associated particular device receiving module 54. As illustrated in FIG. 3 (e.g., FIG. 3A), particular party-correlated previous speech interaction based adaptation data from particular-party associated particular device receiving module 54 may include particular party-correlated previous speech interaction based speech characteristics from particular-party associated particular device receiving module 302, particular party-correlated previous speech interaction based instructions for adapting one or more speech recognition modules from particular-party associated particular device receiving module 304, particular party-correlated previous speech interaction based instructions for updating one or more speech recognition modules from particular-party associated particular device receiving module 306, particular party-correlated previous speech interaction based instructions for modifying one or more speech recognition modules from particular-party associated particular device receiving module 308, and particular party-correlated previous speech interaction based data linking particular party pronunciation of one or more words to one or more words from particular-party associated particular device receiving module 310.

Referring again to FIG. 3 (e.g., FIG. 3B), module 54 may include particular party-correlated previous speech interaction based data locating available particular party correlated adaptation data from particular-party associated particular device receiving module 312, particular party-correlated audibly distinguishable sound linking to concept adaptation data from particular-party associated particular device receiving module 395, particular party-correlated previous speech interaction based authorization to receive data correlated to particular party from particular-party associated particular device receiving module 314, particular party-correlated previous speech interaction based instructions for obtaining adaptation data from particular-party associated particular device receiving module 316, and particular party-correlated previous speech interaction based adaptation data including particular party identification data from particular-party associated particular device receiving module 318 (e.g., which, in some embodiments, may include particular party-correlated previous speech interaction based adaptation data including particular party unique identification data from particular-party associated particular device receiving module 320).

Referring again to FIG. 3 (e.g., FIG. 3C), module 54 may include particular party-correlated previous speech interaction based adaptation data from particular-party owned particular device receiving module 322, particular party-correlated previous speech interaction based adaptation data from particular-party carried particular device receiving module 324, particular party-correlated previous speech interaction based adaptation data from particular device previously used by particular party receiving module 326, particular party-correlated previous speech interaction based adaptation data from particular-party service contract affiliated particular device receiving module 328, and particular party-correlated previous speech interaction based adaptation data from particular device used by particular party receiving module 330.

Referring again to FIG. 3 (e.g., FIG. 3D), module 54 may include particular party-correlated previous speech interaction based adaptation data particular device configured to allow particular party login receiving module 332, particular party-correlated previous speech interaction based adaptation data particular device configured to store particular party data receiving module 334 (e.g., which, in some embodiments, may include particular party-correlated previous speech interaction based adaptation data particular device configured to store particular party profile data receiving module 336 and particular party-correlated previous speech interaction based adaptation data particular device configured to store particular party speech profile unrelated data receiving module 338), and particular party-correlated previous speech interaction based adaptation data from particular device in particular proximity to particular party receiving module 340.

Referring again to FIG. 3 (e.g., FIG. 3E), module 54 may include particular party-correlated previous speech interaction based adaptation data from particular-party associated particular device closer to particular party receiving module 342, particular party-correlated previous other device speech interaction based adaptation data from particular-party associated particular device receiving module 344, particular party-correlated previous other related device speech interaction based adaptation data from particular-party associated particular device receiving module 346, particular party-correlated previous other device having same vocabulary as target device speech interaction based adaptation data from particular-party associated particular device receiving module 348, and particular party-correlated previous other device having same manufacturer as target device speech interaction based adaptation data from particular-party associated particular device receiving module 350.

Referring again to FIG. 3 (e.g., FIG. 3F), module 54 may include particular party-correlated previous other similar-function configured device speech interaction based adaptation data from particular-party associated particular device receiving module 352, particular party-correlated previous other same-function configured device speech interaction based adaptation data from particular-party associated particular device receiving module 354, particular party-correlated other devices previously carrying out same function as target device speech interaction based adaptation data from particular-party associated particular device receiving module 356, particular party-correlated previous other same-type device speech interaction based adaptation data from particular-party associated particular device receiving module 358, particular party-correlated previous particular device speech interaction based adaptation data from particular-party associated particular device receiving module 360, particular party-correlated previous speech interactions observed by particular device based adaptation data from particular-party associated particular device receiving module 362, and particular party-correlated previous speech interaction based adaptation data correlated to one or more vocabulary words and received from particular-party associated particular device receiving module 364 (e.g., which, in some embodiments, may include particular party-correlated previous speech interaction based adaptation data correlated to one or more target device vocabulary words and received from particular-party associated particular device receiving module 366.

Referring again to FIG. 3 (e.g., FIG. 3G), module 54 may include particular party-correlated adaptation data from particular party associated particular device requesting module 368 (e.g., which, in some embodiments, may include particular party-correlated adaptation data related to one or more vocabulary words requesting module 372) and adaptation data partly based on previous adaptation data derived from one or more previous particular party speech interactions receiving module 370. In some embodiments, module 370 may include adaptation data partly based on previous adaptation data derived from one or more previous particular party speech interactions with a prior device receiving module 386. In some embodiments, module 386 may further include adaptation data partly based on previous adaptation data derived from one or more previous particular party speech interactions with a common characteristic prior device receiving module 388. In some embodiments, module 388 may further include adaptation data partly based on previous adaptation data derived from one or more previous particular party speech interactions with a same function prior device receiving module 390. In some embodiments, module 390 may further include adaptation data partly based on previous adaptation data derived from one or more previous particular party speech interactions with a ticket dispenser receiving module 392.

Referring again to FIG. 3 (e.g., FIG. 3H), module 368 of module 54 may further include particular party-correlated adaptation data regarding one or more target device vocabulary words requesting module 374. In some embodiments, module 374 may further include particular party-correlated adaptation data regarding one or more target device command vocabulary words requesting module 376, particular party-correlated adaptation data regarding one or more target device control vocabulary words requesting module 378, and particular party-correlated adaptation data regarding one or more target device interaction vocabulary words requesting module 380. In some embodiments, module 388 of module 386 of module 370 of module 54 may further include adaptation data partly based on previous adaptation data derived from one or more previous particular party speech interactions with a prior device providing a same service receiving module 394. In some embodiments, module 394 may further include adaptation data partly based on previous adaptation data derived from one or more previous particular party speech interactions with a media player receiving module 396.

Referring again to FIG. 3 (e.g., FIG. 3I), module 368 of module 54 may further include particular party-correlated adaptation data regarding one or more target device common interaction words requesting module 382 and particular party-correlated adaptation data regarding one or more target device type associated vocabulary words requesting module 384. In some embodiments, module 388 of module 386 of module 370 of module 54 may further include adaptation data partly based on previous adaptation data derived from one or more previous particular party speech interactions with a prior device sold by a same entity as the target device receiving module 398. In some embodiments, module 398 may include adaptation data partly based on previous adaptation data derived from one or more previous particular party speech interactions with a prior device sold by a same retailer as the target device receiving module 301.

Referring again to FIG. 3 (e.g., FIG. 3J), in some embodiments, module 386 of module 370 of module 54 may further include adaptation data partly based on previous adaptation data derived from one or more previous particular party speech interactions with a prior device sharing at least one vocabulary word receiving module 303. Module 303 may further include adaptation data partly based on previous adaptation data derived from one or more previous particular party speech interactions with a larger vocabulary prior device receiving module 305. In some embodiments, module 54 may include particular party-correlated speech interaction based adaptation data from particular party associated particular device receiving module 307.

Referring again to FIG. 3 (e.g., FIG. 3K), module 54 may include particular party-correlated speech interaction based adaptation data selected based on previous speech interaction similarity with expected future speech interaction particular device receiving module 309, particular party-correlated previous speech interaction based adaptation data from particular-party speech detecting particular device receiving module 323, and particular party-correlated previous speech interaction based adaptation data from particular-party speech recording particular device receiving module 325. In some embodiments, module 309 may include particular party-correlated speech interaction based adaptation data selected based on use of specific vocabulary word particular device receiving module 311 and particular party-correlated previous speech interaction based adaptation data from particular-party speech receiving particular device receiving module 313. In some embodiments, module 313 may include particular party-correlated previous speech interaction based adaptation data from particular-party speech receiving smartphone receiving module 315 and particular party-correlated previous speech interaction based adaptation data from particular-party speech receiving particular device having speech transmission software receiving module 317. In some embodiments, module 317 may further include particular party-correlated previous speech interaction based adaptation data from particular-party speech receiving tablet receiving module 319 and particular party-correlated previous speech interaction based adaptation data from particular-party speech receiving navigation device receiving module 321.

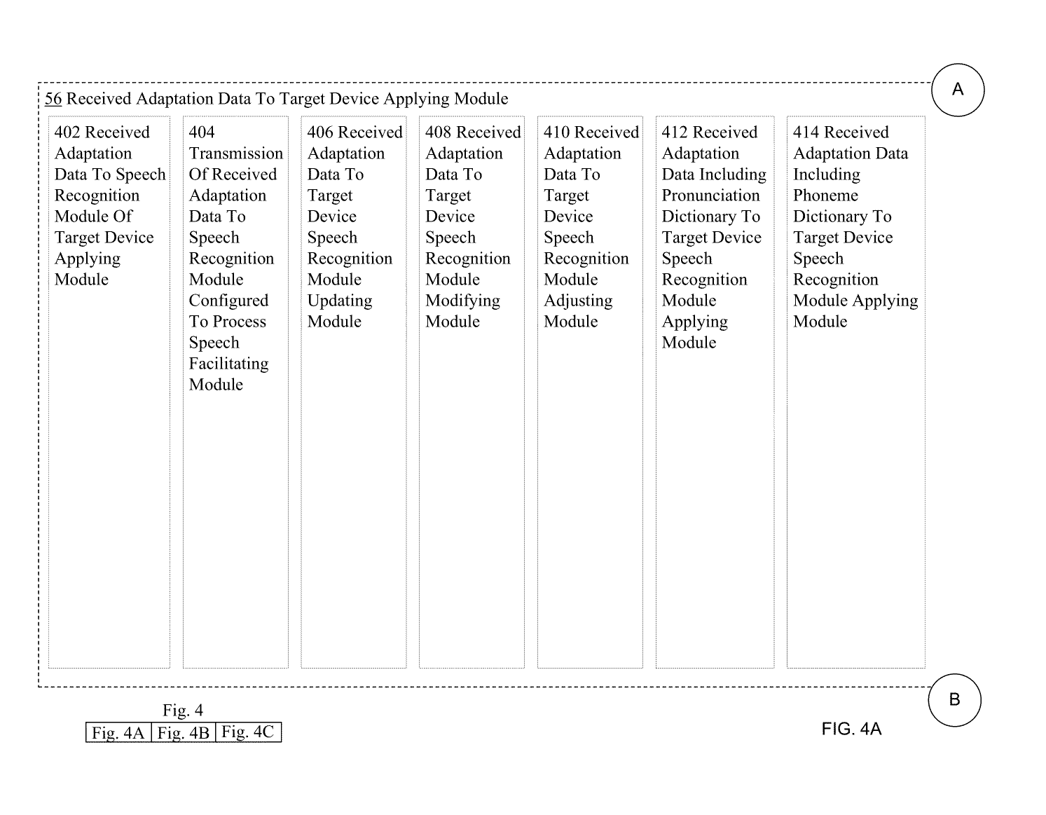

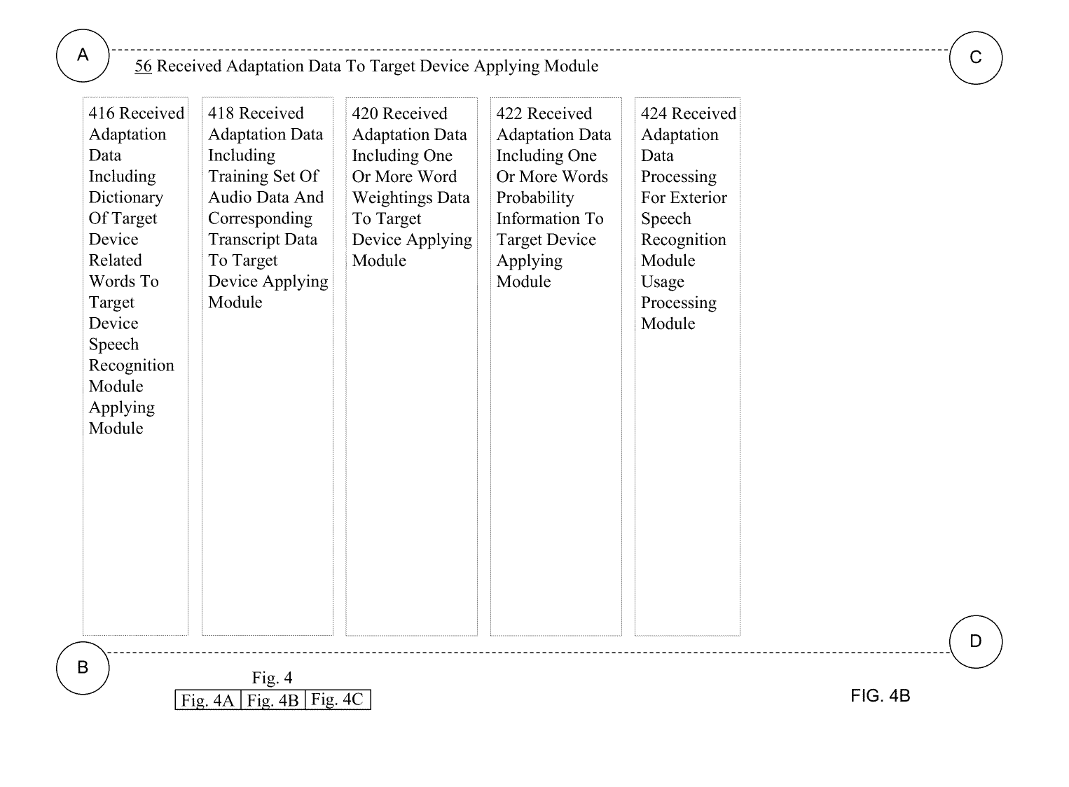

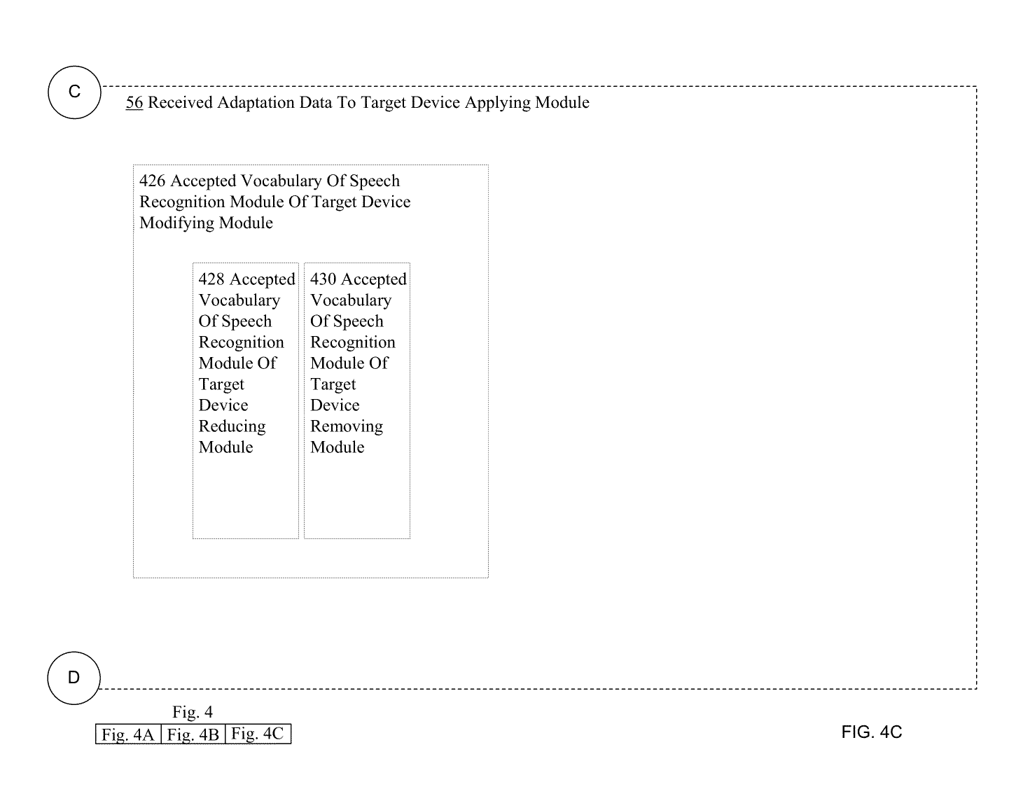

Referring now to FIG. 4, FIG. 4 illustrates an exemplary implementation of the received adaptation data to target device applying module 56. As shown in FIG. 4 (e.g., FIG. 4A), received adaptation data to target device applying module 56 may include received adaptation data to speech recognition module of target device applying module 402, transmission of received adaptation data to speech recognition module configured to process speech facilitating module 404, received adaptation data to target device speech recognition module updating module 406, received adaptation data to target device speech recognition module modifying module 408, received adaptation data to target device speech recognition module adjusting module 410, received adaptation data including pronunciation dictionary to target device speech recognition module applying module 412, and received adaptation data including phoneme dictionary to target device speech recognition module applying module 414.

Referring again to FIG. 4 (e.g., FIG. 4B), module 56 may include received adaptation data including dictionary of target device related words to target device speech recognition module applying module 416, received adaptation data including training set of audio data and corresponding transcript data to target device applying module 418, received adaptation data including one or more word weightings data to target device applying module 420, received adaptation data including one or more words probability information to target device applying module 422, received adaptation data processing for exterior speech recognition module usage processing module 424, and accepted vocabulary of speech recognition module of target device modifying module 426.

Referring again to FIG. 4 (e.g., FIG. 4C), module 56 may include accepted vocabulary of speech recognition module of target device reducing module 428 and accepted vocabulary of speech recognition module of target device removing module 430.

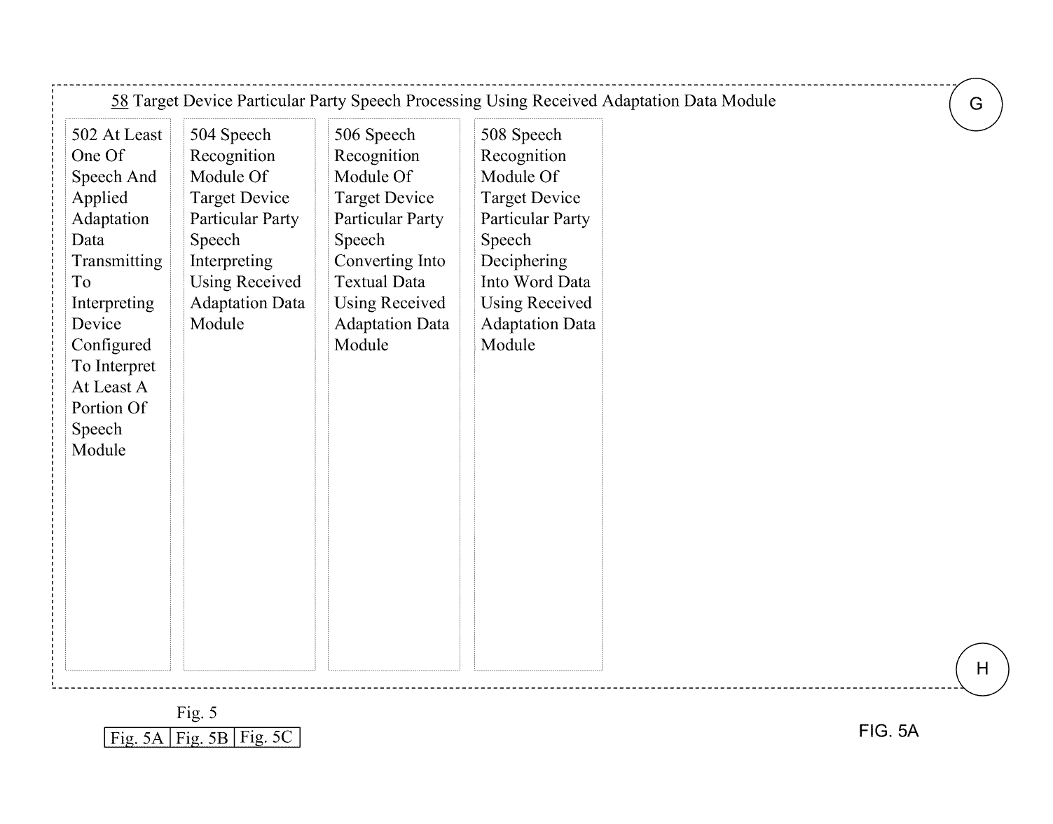

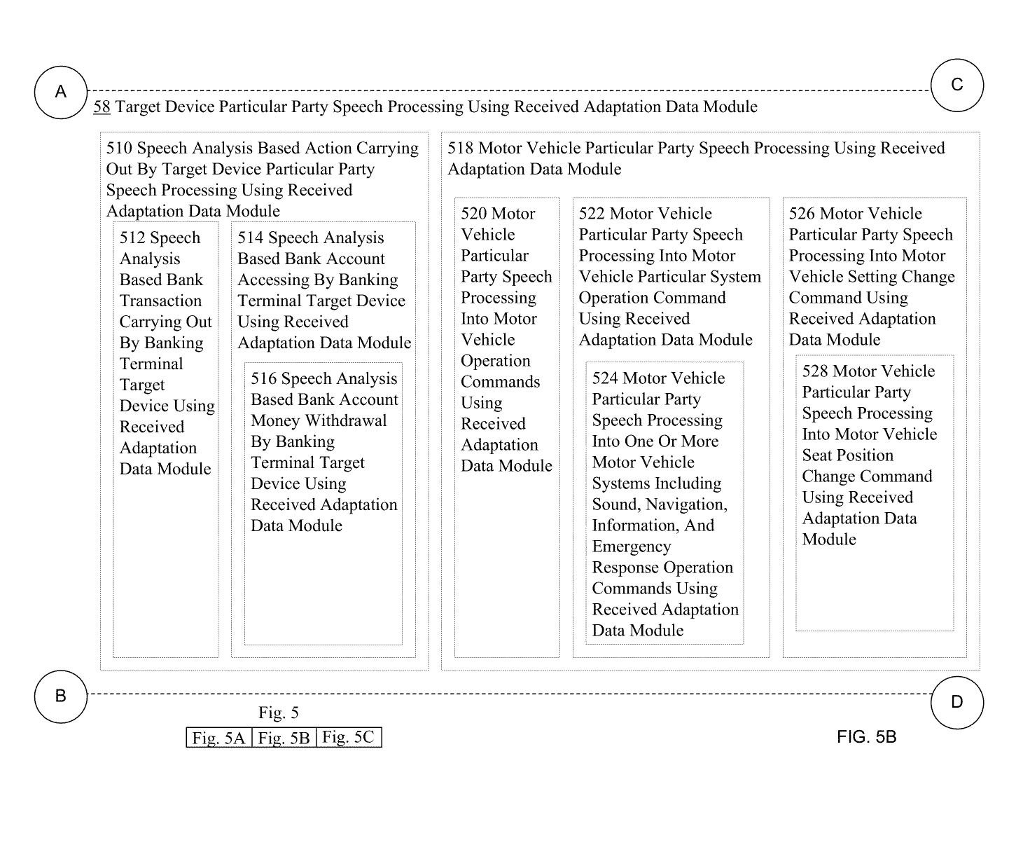

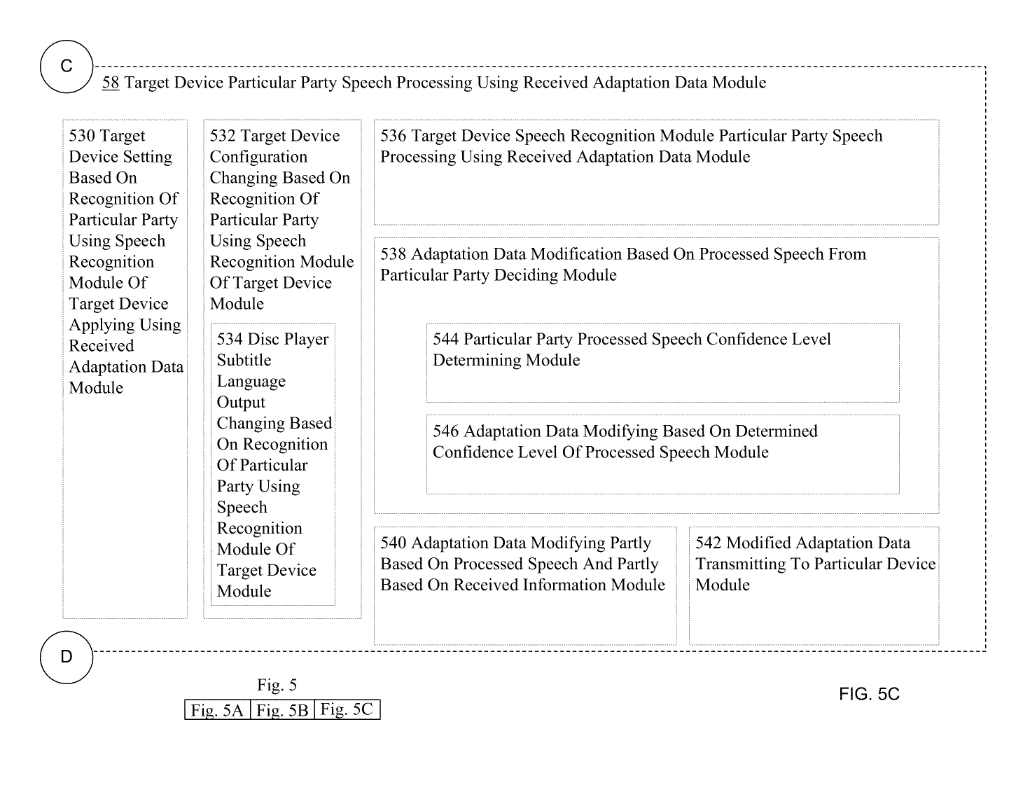

Referring now to FIG. 5, FIG. 5 illustrates an exemplary implementation of the target device particular party speech processing using received adaptation data module 58. For example, as shown in FIG. 5 (e.g., FIG. 5A), target device particular party speech processing using received adaptation data module 58 may include at least one of speech and applied adaptation data transmitting to interpreting device configured to interpret at least a portion of speech module 502, speech recognition module of target device particular party speech interpreting using received adaptation data module 504, speech recognition module of target device particular party speech converting into textual data using received adaptation data module 506, and speech recognition module of target device particular party speech deciphering into word data using received adaptation data module 508.

Referring again to FIG. 5 (e.g., FIG. 5B), module 58 may include speech analysis based action carrying out by target device particular party speech processing using received adaptation data module 510 and motor vehicle particular party speech processing using received adaptation data module 518. In some embodiments, module 510 may include speech analysis based bank transaction carrying out by banking terminal target device using received adaptation data module 512 and speech analysis based bank transaction carrying out by banking terminal target device using received adaptation data module 514 (e.g., which, in some embodiments, may include speech analysis based bank account money withdrawal by banking terminal target device using received adaptation data module 516. In some embodiments, module 518 may include motor vehicle particular party speech processing into motor vehicle operation commands using received adaptation data module 520, motor vehicle particular party speech processing into motor vehicle particular system operation command using received adaptation data module 522 (e.g., which, in some embodiments, may include motor vehicle particular party speech processing into one or more motor vehicle systems including sound, navigation, information, and emergency response operation commands using received adaptation data module 524), and motor vehicle particular party speech processing into motor vehicle setting change command using received adaptation data module 526 (e.g., which, in some embodiments, may include motor vehicle particular party speech processing into motor vehicle seat position change command using received adaptation data module 528.

Referring again to FIG. 5 (e.g., FIG. 5C), module 58 may include target device setting based on recognition of particular party using speech recognition module of target device applying using received adaptation data module 530 and target device configuration changing based on recognition of particular party using speech recognition module of target device module 532 (e.g., which, in some embodiments, may include disc player subtitle language output changing based on recognition of particular party using speech recognition module of target device module 534). In some embodiments, module 58 may include target device speech recognition module particular party speech processing using received adaptation data module 536 (e.g., which, in some embodiments, may include particular party processed speech confidence level determining module 544 and adaptation data modifying based on determined confidence level of processed speech module 546), adaptation data modification based on processed speech from particular party deciding module 538, adaptation data modifying partly based on processed speech and partly based on received information module 540, and modified adaptation data transmitting to particular device module 542.

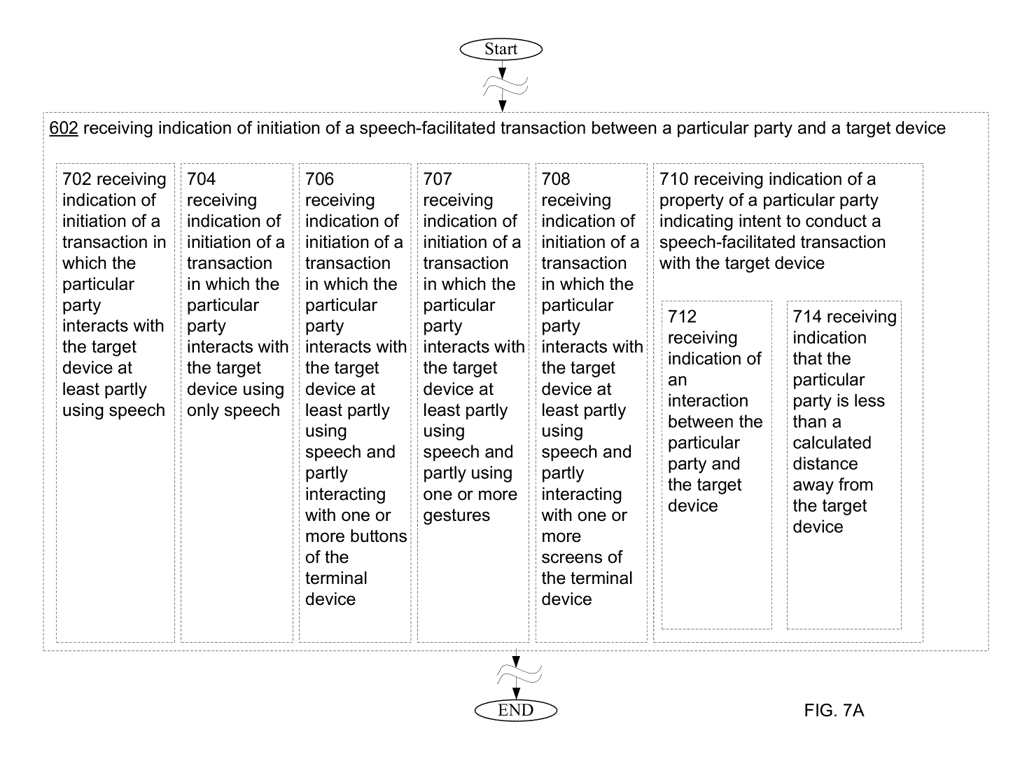

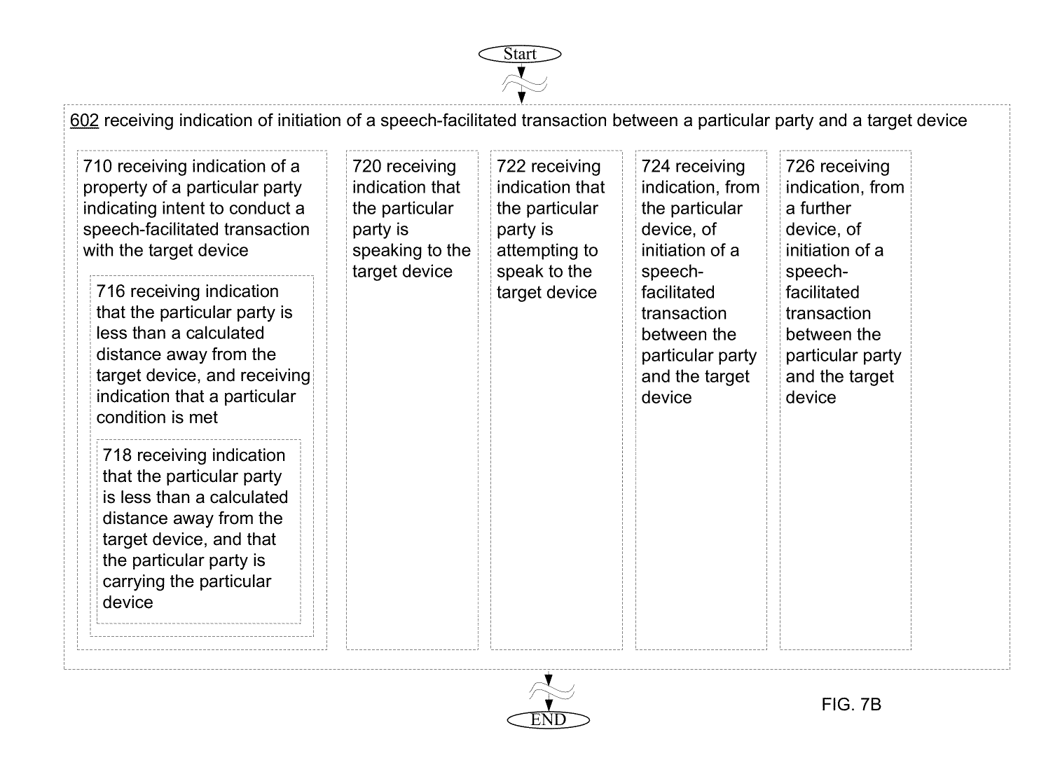

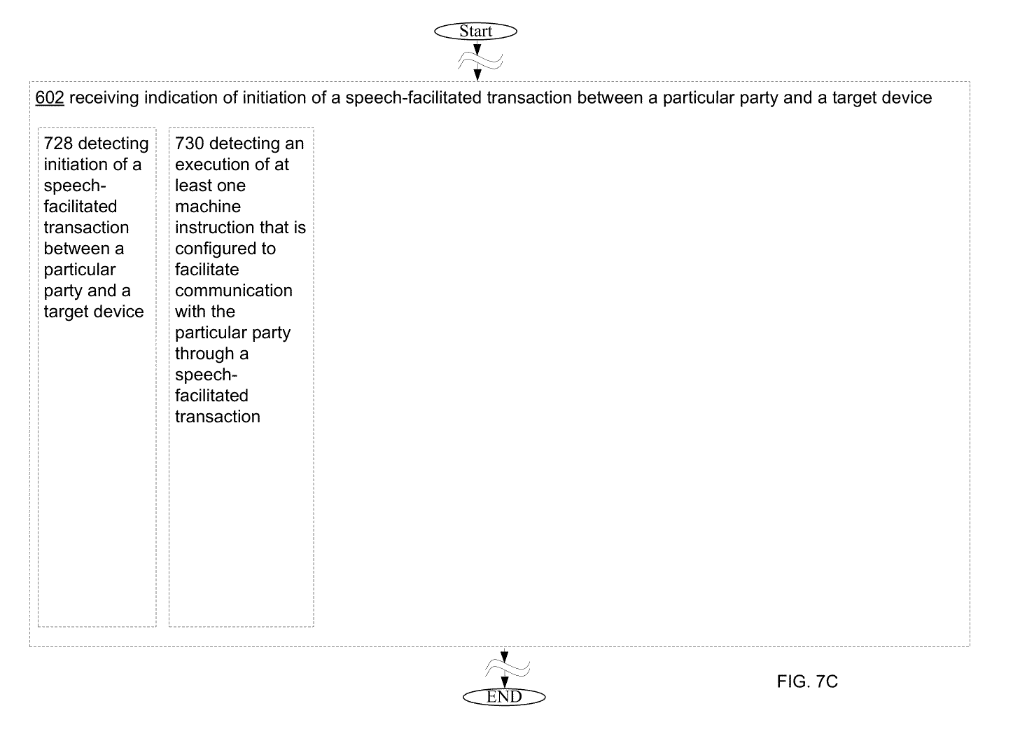

A more detailed discussion related to terminal device 30 of FIG. 1 now will be provided with respect to the processes and operations to be described herein. Referring now to FIG. 6, FIG. 6 illustrates an operational flow 600 representing example operations for, among other methods, receiving indication of initiation of a speech-facilitated transaction between a particular party and a target device, receiving adaptation data correlated to the particular party, said receiving facilitated by a particular device associated with the particular party, wherein the adaptation data is at least partly based on previous adaptation data derived at least in part from one or more previous speech interactions of the particular party, applying the received adaptation data correlated to the particular party to the target device, and processing speech from the particular party using the target device to which the received adaptation data has been applied. In FIG. 6 and in the following FIGS. 7-10 that include various examples of operational flows, discussions and explanations will be provided with respect to the exemplary environment 100 as described above and as illustrated in FIG. 1, and with respect to other examples (e.g., as provided in FIGS. 2-5) and contexts. It should be understood that the operational flows may be executed in a number of other environments and contexts, and/or in modified versions of the systems shown in FIGS. 2-5. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 6 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 6 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

Portions of this application may reference trademarked companies and products merely for exemplary purposes. All trademarks remain the sole property of the trademark owner, and in each case where a trademarked product or company is used, a similar product or company may be replaced.

Referring again to FIG. 6, FIG. 6 shows operation 600 that includes operation 602 depicting receiving indication of initiation of a speech-facilitated transaction between a particular party and a target device. For example, FIG. 1 shows speech-facilitated transaction initiation between particular party and target device indicator receiving module 52 receiving indication (e.g., an electronic signal sent from an interface unit) of initiation (e.g., beginning, or about to begin, e.g., a user walks up to a terminal, and may or may not begin speaking) of a speech-facilitated transaction (e.g., an interaction between a user and a terminal, e.g., a bank terminal) in which at least one component of the interaction uses speech (e.g., the user says “show me my balance” to the machine in order to display the balance on the machine) between a particular party (e.g., a user that wants to withdraw money from an ATM terminal) and a target device (e.g., an ATM terminal).

It is noted that the “indication” does not need to be an electronic signal. The indication may come from a user interaction, from a condition being met, from the detection of a condition being met, or from a change in state of a sensor or device. The indication may be that the user has moved into a particular position, or has pushed a button, or is talking to the machine, or pressed a button on a portable device, or said a particular word or words, or made a gesture, or was captured on a video camera. The indication may be an indication of an RFID tag

Referring again to FIG. 6, FIG. 6 shows operation 600 that also includes operation 604 depicting receiving adaptation data correlated to the particular party, said receiving facilitated by a particular device associated with the particular party, wherein the adaptation data is at least partly based on previous adaptation data derived at least in part from one or more previous speech interactions of the particular party. For example, FIG. 1 shows particular party-correlated previous speech interaction based adaptation data from particular-party associated particular device receiving module 54 receiving (e.g., either locally or remotely) adaptation data (e.g., data related to speech processing, in this case, a model for that user for words commonly used at an ATM like “withdraw” and “balance”) correlated to the particular party (e.g., related to the way that the particular party speaks the words “withdraw,” “balance,” “one hundred,” and “twenty”), said receiving facilitated (e.g., assisted in at least one step, e.g., sends the adaptation data or provides a location where the adaptation data may be retrieved) by a particular device (e.g., a smartphone) associated with the particular party (e.g., carried by the particular party, or stores information regarding the particular party), wherein the adaptation data is at least partly based on previous adaptation data (e.g., adaptation data from a prior interaction or conversation) derived at least in part from one or more previous speech interactions (e.g., the user taking into a microphone at his computer).

Referring again to FIG. 6, FIG. 6 shows operation 600 that further includes operation 606 depicting applying the received adaptation data correlated to the particular party to the target device. For example, FIG. 1 shows received adaptation data to target device speech recognition module applying module 56 applying the received adaptation data (e.g., the model for the particular user for commonly used ATM words is applied to the ATM's default model for the commonly used ATM words, replacing the default definitions with the user-specific definitions) correlated to the particular party (e.g., related to the way the particular party speaks) to the target device (the ATM terminal).

Referring again to FIG. 6, FIG. 6 shows operation 600 that still further includes operation 608 depicting processing speech from the particular party using the target device to which the received adaptation data has been applied. For example, FIG. 1 shows target device speech recognition module received speech processing module 58 processing speech (e.g., the verbal command “withdraw one hundred dollars” from the particular party (e.g., the user of the ATM) using the target device (e.g., the ATM Terminal) to which the received adaptation data (e.g., the user's specific model for commonly used ATM words) has been applied.

FIGS. 7A-7B depict various implementations of operation 602, according to embodiments. Referring now to FIG. 7A, operation 602 may include operation 702 depicting receiving indication of initiation of a transaction in which the particular party interacts with the target device at least partly using speech. For example, FIG. 2 shows speech-facilitated and partly using speech transaction initiation between particular party and target device indicator receiving module 202 receiving indication (e.g., receiving a signal from a motion sensor) of initiation of a transaction (e.g., a user walks within a particular proximity of an airline ticket dispensing terminal) in which the particular party (e.g., a user who wants to print out his airline ticket) interacts with the target device (e.g., the airline ticket dispensing terminal) at least partly using speech (e.g., the user says which transaction he wants to perform, e.g., “print boarding pass,” but may key in his flight number manually).

Referring again to FIG. 7A, operation 602 may include operation 704 depicting receiving indication of initiation of a transaction in which the particular party interacts with the target device using only speech. For example, FIG. 2 shows speech-facilitated and only using speech transaction initiation between particular party and target device indicator receiving module 204 receiving indication (e.g., receiving a signal from a credit card reader) of initiation of a transaction (e.g., a user swipes a credit card in a public pay computer in a hotel) in which the particular party interacts with the target device (a public pay computer) using only speech (e.g., there is no keyboard or mouse, just voice prompts).

Referring again to FIG. 7A, operation 602 may include operation 706 depicting receiving indication of initiation of a transaction in which the particular party interacts with the target device at least partly using speech and partly interacting with one or more buttons of the terminal device. For example, FIG. 2 shows speech facilitated transaction using speech and terminal device button initiation indicator receiving module 206 receiving indication (e.g., receiving a signal that a user has powered on the locking interface mechanism of the safe, either by pressing a button or flipping a switch) of initiation of a transaction (e.g., a transaction to gain entry to a safe locked by electronic means) in which the particular party (e.g., the person desiring access to the safe) interacts with the target device (e.g., the safe and the interface for unlocking it) at least partly using speech (e.g., speaking a command to the safe, or speaking a predefined phrase that partially unlocks the safe) and partly interacting with one or more buttons of the terminal device (e.g., a keypad on which the user enters a code in order to unlock the safe after speaking the predefined phrase).

Referring again to FIG. 7A, operation 602 may include operation 707 depicting receiving indication of initiation of a transaction in which the particular party interacts with the target device at least partly using speech and partly using one or more gestures. For example, FIG. 2 shows speech facilitated transaction using speech and gesture initiation indicator receiving module 209 receiving indication (e.g., a signal that an object has been placed on a particular surface) of initiation of a transaction (e.g., a user wants to purchase grocery items from a self-checkout) in which the particular party (e.g., the buyer of groceries) interacts with the target device (e.g., the self-checkout station) at least partly using speech (e.g., speaks “check out” to the terminal to indicate no more groceries) and partly using one or more gestures (e.g., hand movements or facial movements to indicate “yes” or “no”).

For another example, FIG. 2 shows speech facilitated transaction using speech and gesture initiation indicator receiving module 209 receiving indication (e.g., a login to a computer terminal in an enterprise business setting) of initiation of a transaction (e.g., an employee of the company wants to use this particular terminal) in which the particular party (e.g., a person who communicates through speech and gestures) interacts with the target device (e.g., a computer usable by all company employees with a valid login) at least partly using speech (e.g., speech-to-text inside a word processing document) and partly using one or more gestures (e.g., specific hand or facial gestures designed to open and close various programs).

Referring again to FIG. 7A, operation 602 may include operation 708 depicting receiving indication of initiation of a transaction in which the particular party interacts with the target device at least partly using speech and partly interacting with one or more screens of the terminal device. For example, FIG. 2 shows speech facilitated transaction using speech and terminal device screen initiation indicator receiving module 208 receiving indication of initiation of a transaction (e.g., detecting an RFID-equipped device located on the person of the user) in which the particular party (e.g., the person who walks into a cab) interacts with the target device (e.g., a device inside a taxi cab for paying fares and entering the address) at least partly using speech (e.g., speaking the destination) and partly interacting with one or more screens of the terminal device (e.g., using a touchscreen to confirm the correct location of the destination after it has been spoken by the particular party).

Referring again to FIG. 7A, operation 602 may include operation 710 depicting receiving indication of a property of a particular party indicating intent to conduct a speech-facilitated transaction with the target device. For example, FIG. 2 shows particular party intention to conduct target device speech-facilitated transaction indicator receiving module 210 receiving indication of the particular party's (e.g., a user) one or more steps taken (e.g., holds an RFID identification card up to an electronic lock) to conduct a speech-facilitated transaction (e.g., audible password verification) with the target device (e.g., a door lock).

Referring again to FIG. 7A, operation 710 may include operation 712 depicting receiving indication of an interaction between the particular party and the target device. For example, FIG. 2 shows particular party and target device interaction indication receiving module 712 receiving indication of an interaction (e.g., an opening of a program, or an activation of a piece of hardware or software) between the particular party (a computer user, in either a home or an enterprise setting) and the target device (e.g., a desktop computer, or a laptop).

Referring again to FIG. 7A, operation 710 may include operation 714 depicting receiving indication that the particular party is less than a calculated distance away from the target device. For example, FIG. 2 shows particular party and target device particular proximity indication receiving module 214 receiving indication (e.g., a signal) that the particular party (e.g., the user of a pharmacy terminal to check on a prescription) is less than a calculated distance away (e.g., less than one (1) meter, indicating a desire to use that terminal) from the target device (e.g., the pharmacy information terminal).

Referring now to FIG. 7B, operation 710 may include operation 716 depicting receiving indication that the particular party is less than a calculated distance away from the target device, and receiving indication that a particular condition is met. For example, FIG. 2 shows particular party and target device particular proximity and particular condition indication receiving module 216 receiving indication that the particular party (e.g., the user) is within a particular proximity (e.g., less than one meter away, and in the direction such that the user can see the screen) of the target device (e.g., a hotel check-in system that has optional use of speech interaction or non-speech interaction), and receiving indication that a particular condition is met (e.g., it is an eligible time for hotel check-in).

Referring again to FIG. 7B, operation 716 may include operation 718 depicting receiving indication that the particular party is less than a calculated distance away from the target device, and that the particular party is carrying the particular device. For example, FIG. 2 shows particular party and target device particular proximity and carrying particular device indication receiving module 218 receiving indication (e.g., an electronic message from a device configured to detect indications) that the particular party (e.g., the user) is within a particular proximity (e.g., within one (1) meter) of the target device (e.g., an airline ticket terminal), and that the particular party (e.g., the user) is carrying the particular device (e.g., the user's smartphone, or the user's memory stick storing the adaptation data, or the user's device that contains the address for retrieving the adaptation data).

Referring again to FIG. 7B, operation 602 may include operation 720 depicting receiving indication that the particular party is speaking to the target device. For example, FIG. 2 shows particular party speaking to target device indicator receiving module 220 receiving indication (e.g., receiving data from which it can be inferred) that the particular party (e.g., the user) is speaking to the target device (e.g., the speech-enabled television).

Referring again to FIG. 7B, operation 602 may include operation 722 depicting receiving indication that the particular party is attempting to speak to the target device. For example, FIG. 2 shows particular party intending to speak to target device indicator receiving module 222 receiving indication (e.g., receiving data indicating) that the particular party (e.g., the user) is attempting to speak (e.g., is trying to speak but is not able, or has started to speak) to the target device (e.g., the home security system control panel).

Referring again to FIG. 7B, operation 602 may include operation 724 depicting receiving indication, from the particular device, of initiation of a speech-facilitated transaction between the particular party and the target device. For example, FIG. 2 shows speech-facilitated transaction initiation between particular party and target device indicator receiving from particular device module 224 receiving indication (e.g., a signal or transmission of data), from the particular device (e.g., the user's smartphone), of initiation of a speech-facilitated transaction between the particular party (e.g., the user and owner of the smartphone) and the target device (e.g., an automated teller machine).

Referring again to FIG. 7B, operation 602 may include operation 726 depicting receiving indication, from a further device, of initiation of a speech-facilitated transaction between the particular party and the target device. For example, FIG. 2 shows speech-facilitated transaction initiation between particular party and target device indicator receiving from further device module 226 receiving indication (e.g., a transmission of data), from a further device (e.g., a device that is not the particular device, e.g., a microphone on a ticket processing terminal), of initiation of a speech-facilitated transaction (e.g., buying a ticket to see a movie) between the particular party (e.g., the user who desires to buy a movie ticket) and the target device (e.g., the ticket processing terminal). It is noted that the further device may be the target device, may be part of the target device, may be related to the target device, or may be discrete from and/or unrelated to the target device.

Referring now to FIG. 7C, operation 602 may include operation 728 depicting detecting initiation of a speech-facilitated transaction between a particular party and a target device. For example, FIG. 2 shows speech-facilitated transaction initiation between particular party and target device indicator detecting module 228 detecting initiation (e.g., determining a start) of a speech-facilitated transaction (e.g., an arming or disarming of a door lock) between a particular party (e.g., a homeowner) and a target device (e.g., a security system).

Referring again to FIG. 7C, operation 602 may include operation 730 depicting detecting an execution of at least one machine instruction that is configured to facilitate communication with the particular party through a speech-facilitated transaction. For example, FIG. 2 shows program configured to communicate with particular party through speech-facilitated transaction launch detecting module 230 detecting an execution of at least one machine instruction (e.g., detecting carrying out of a program or a routine on a machine, e.g., on a user's smartphone) that is configured to facilitate communication (e.g., to receive speech or portions of speech, or one or more voice models) with the particular party (e.g., the user) through a speech-facilitated transaction (e.g., ordering food from an automated drive-thru window).

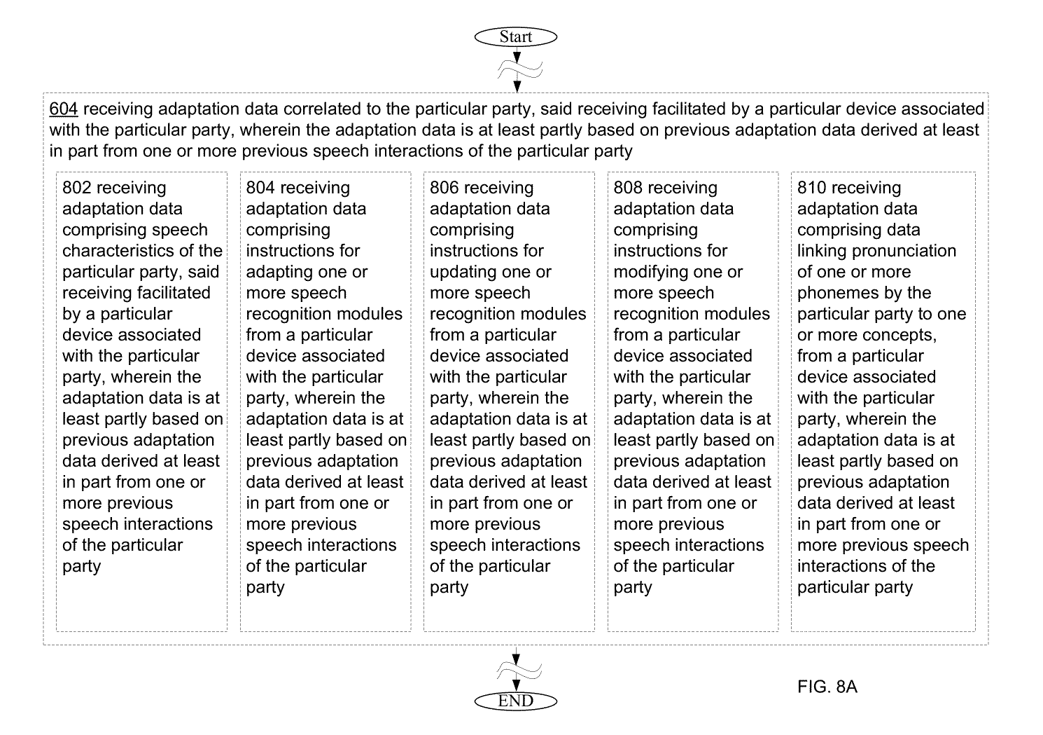

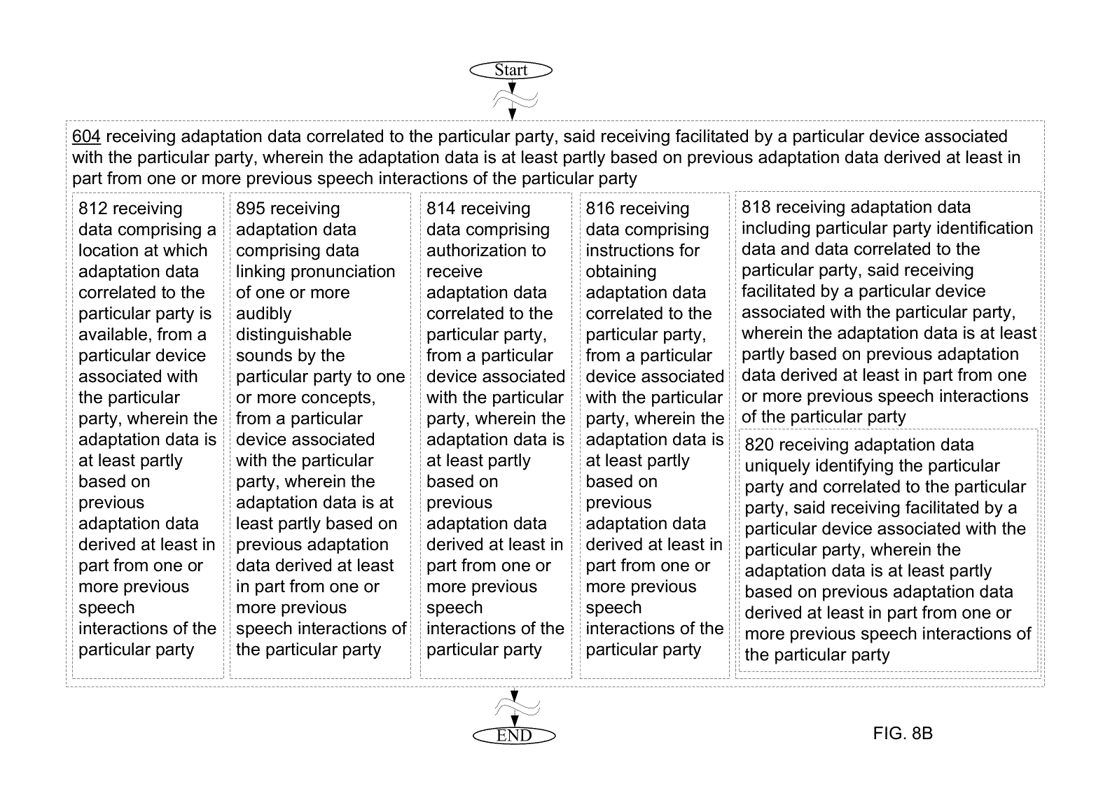

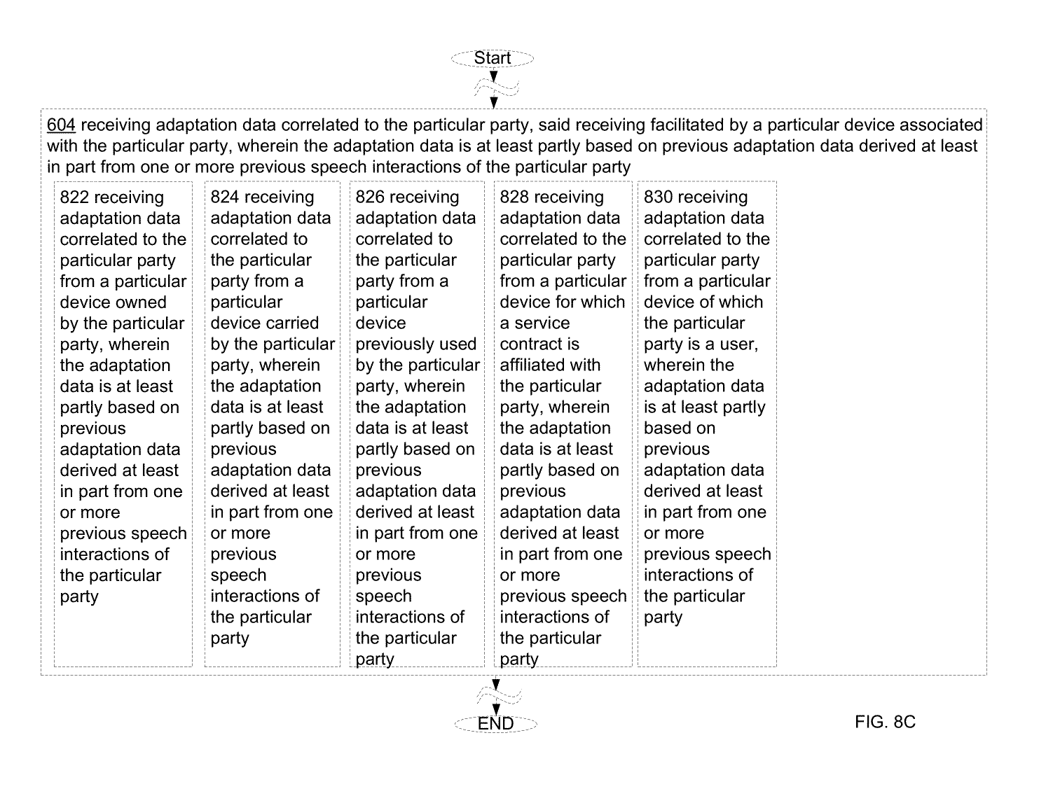

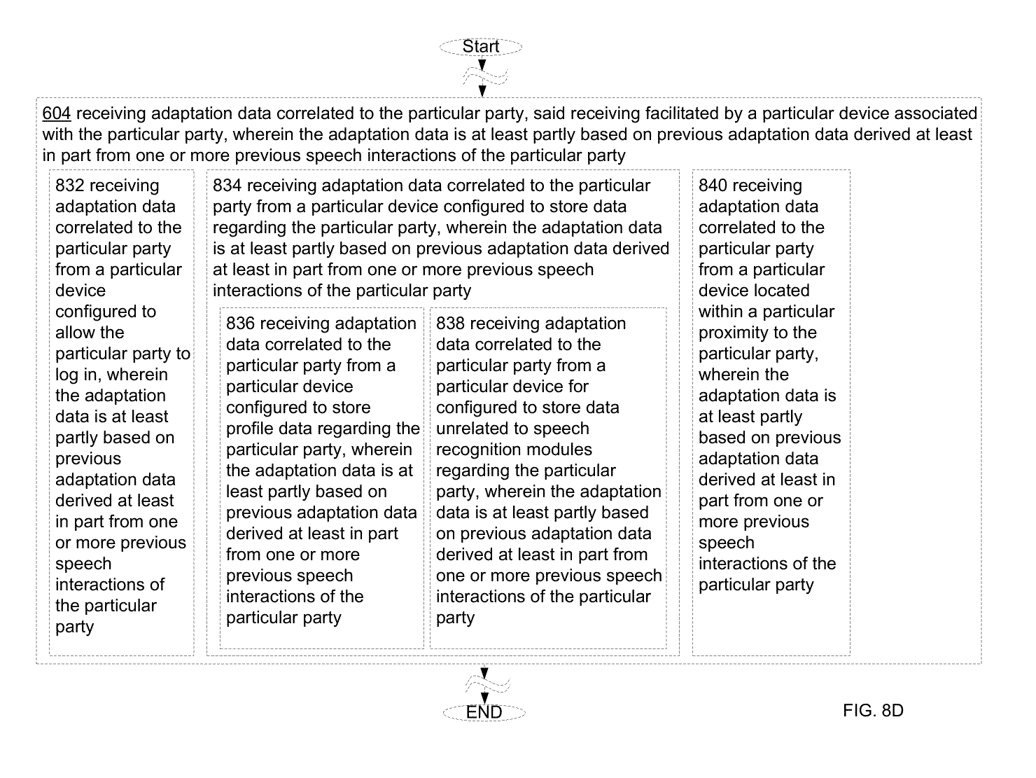

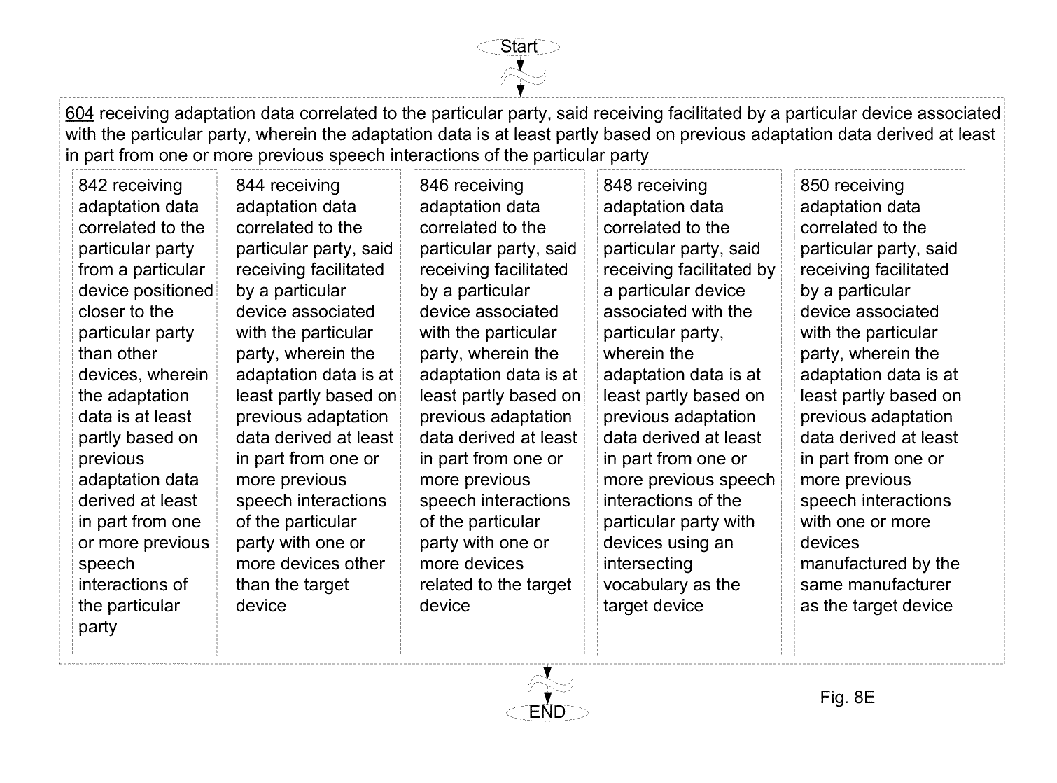

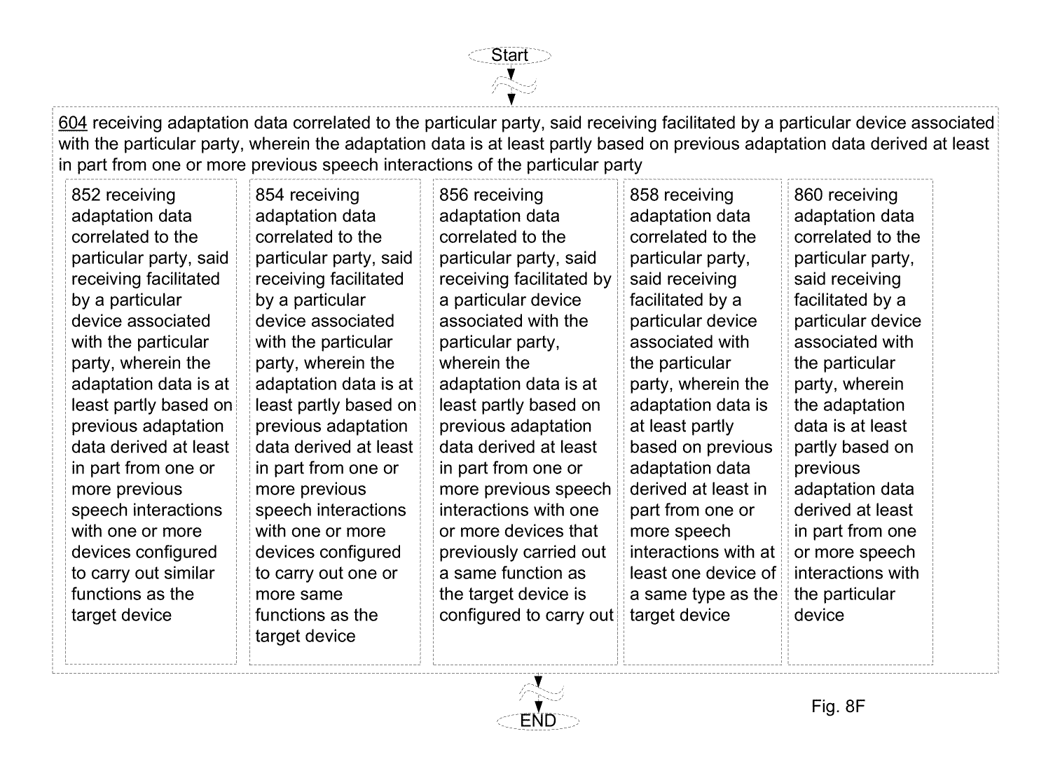

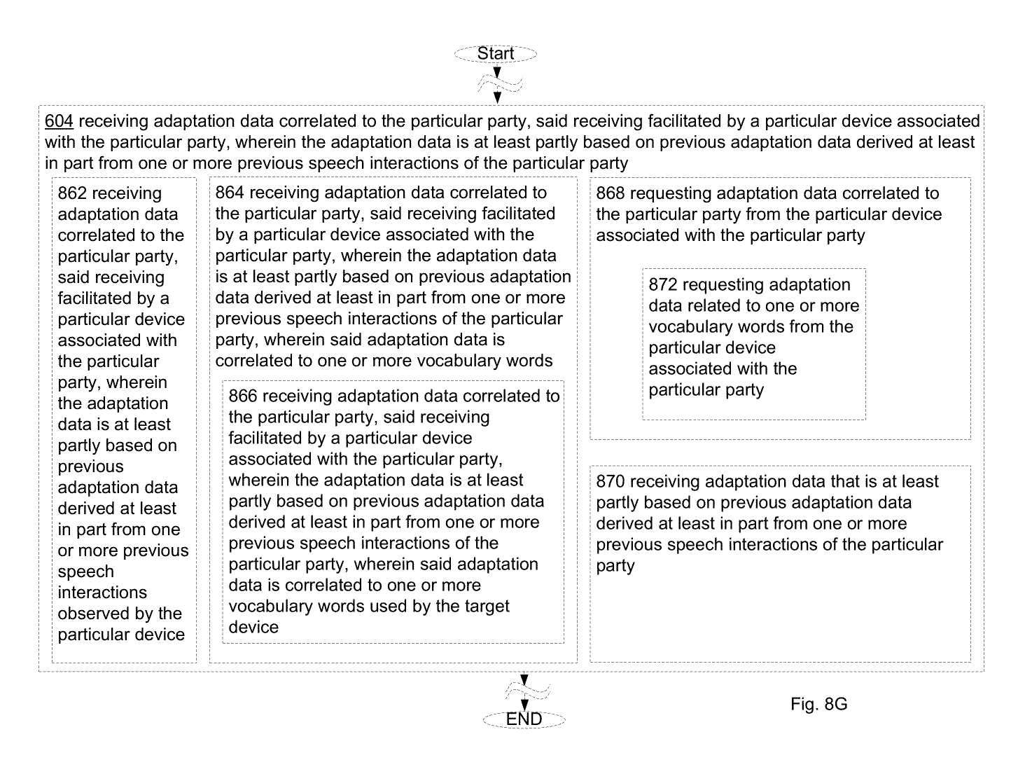

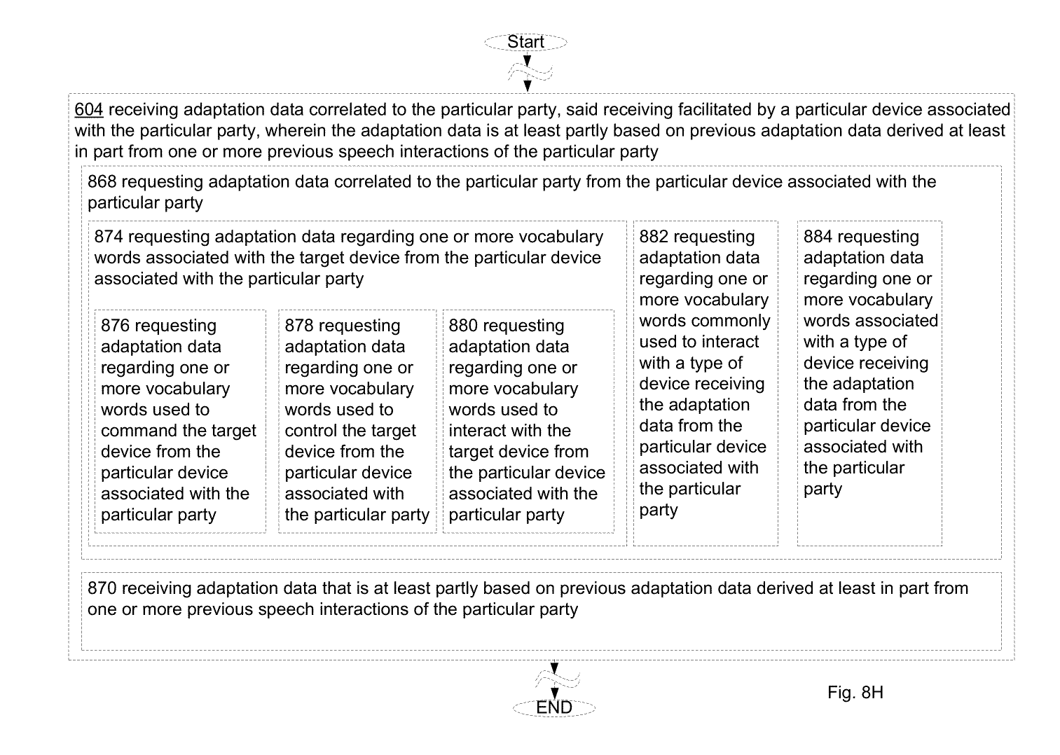

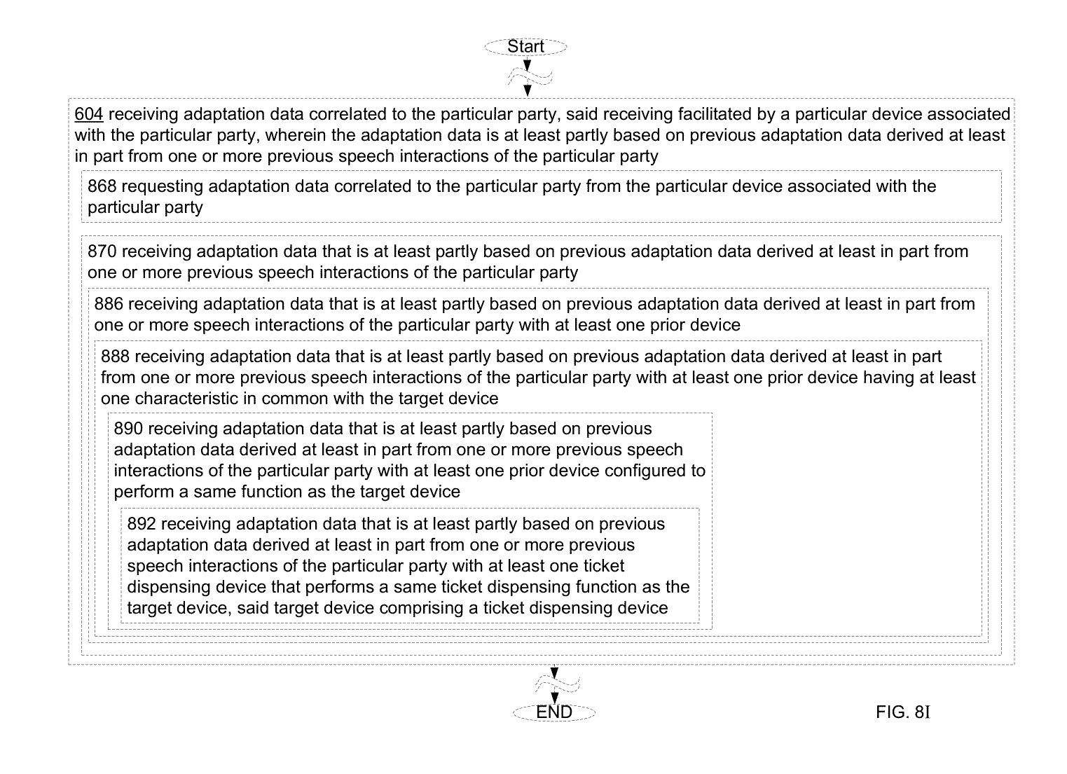

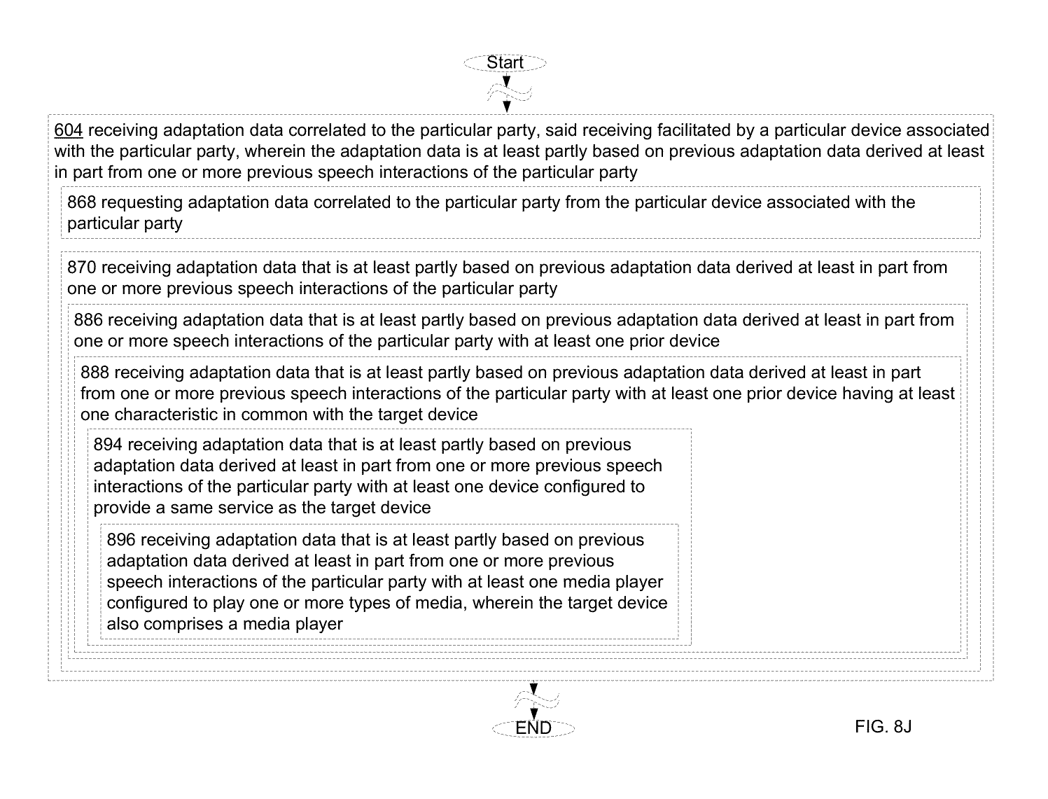

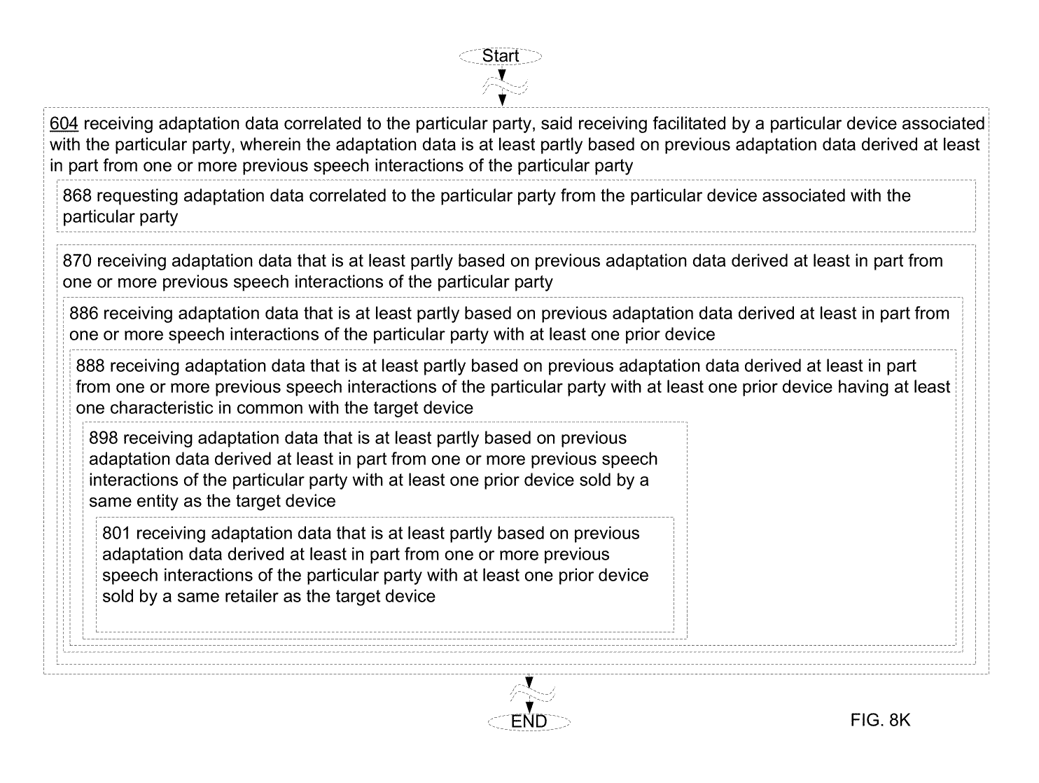

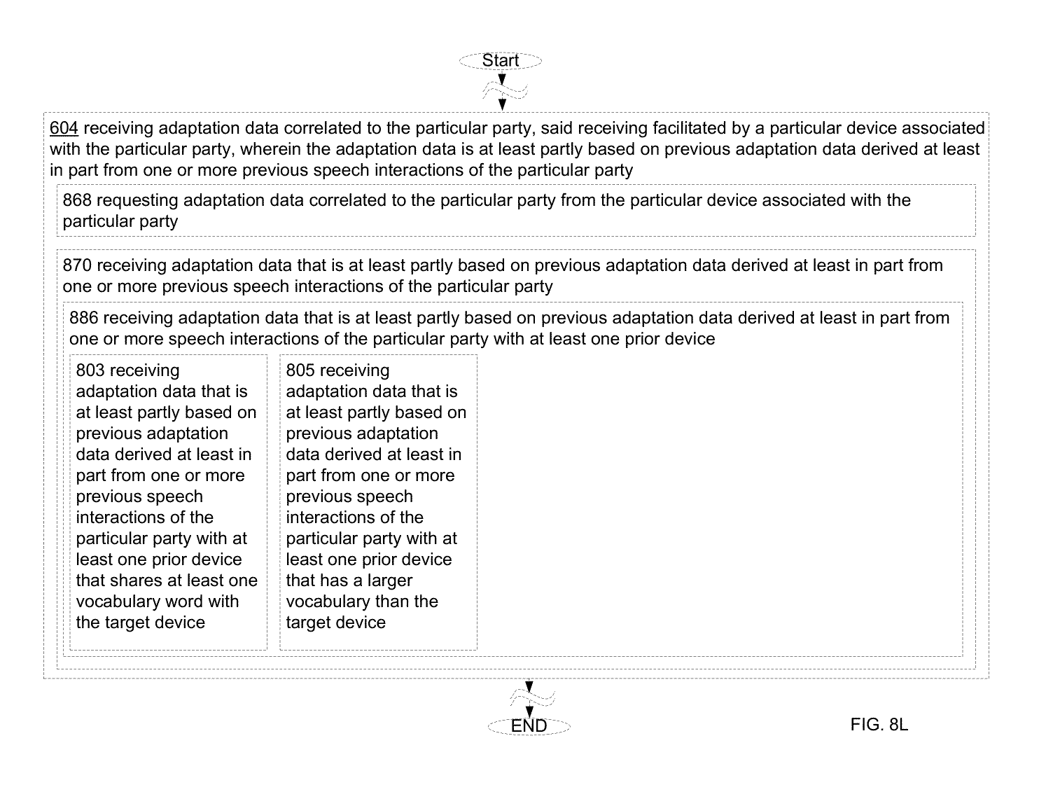

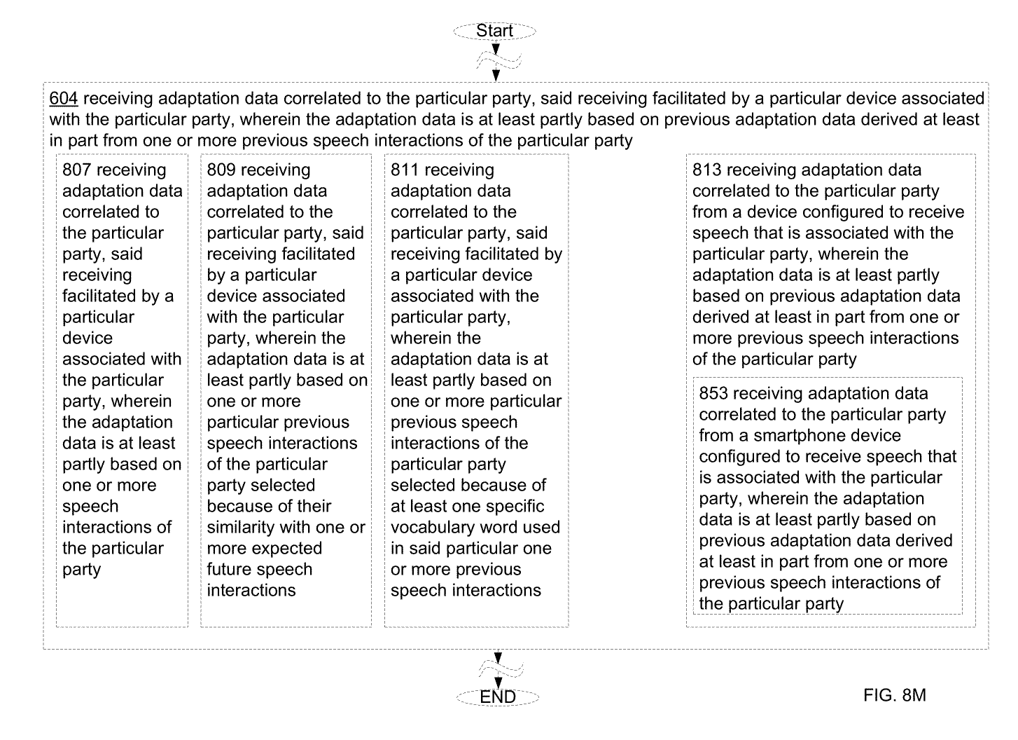

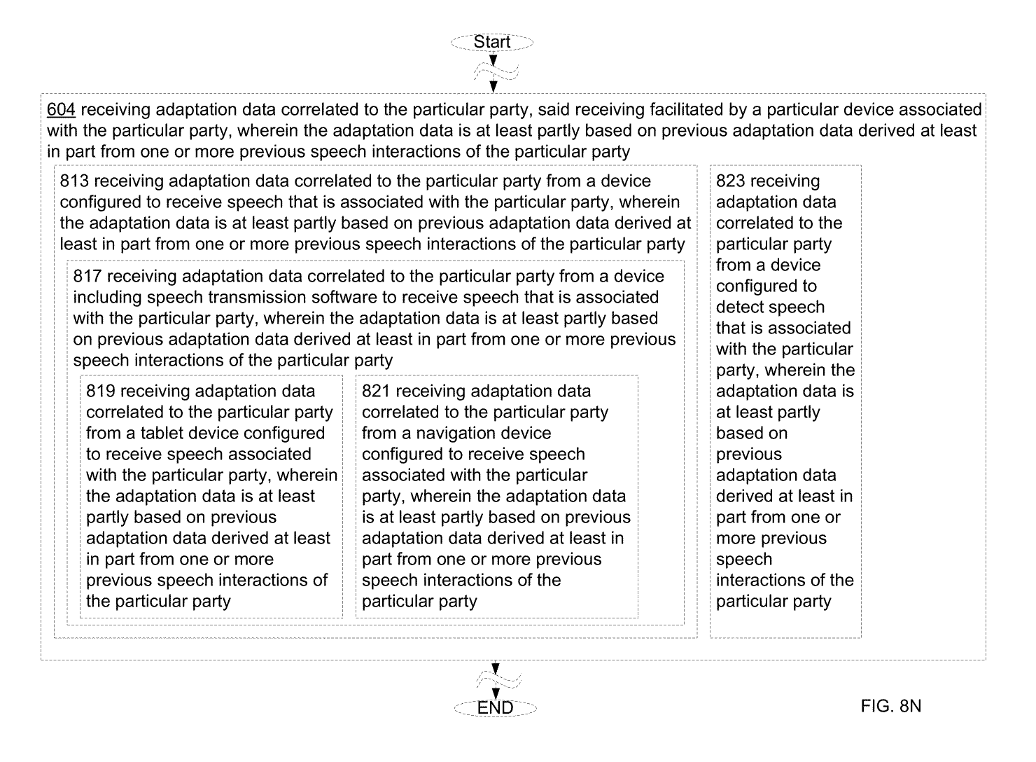

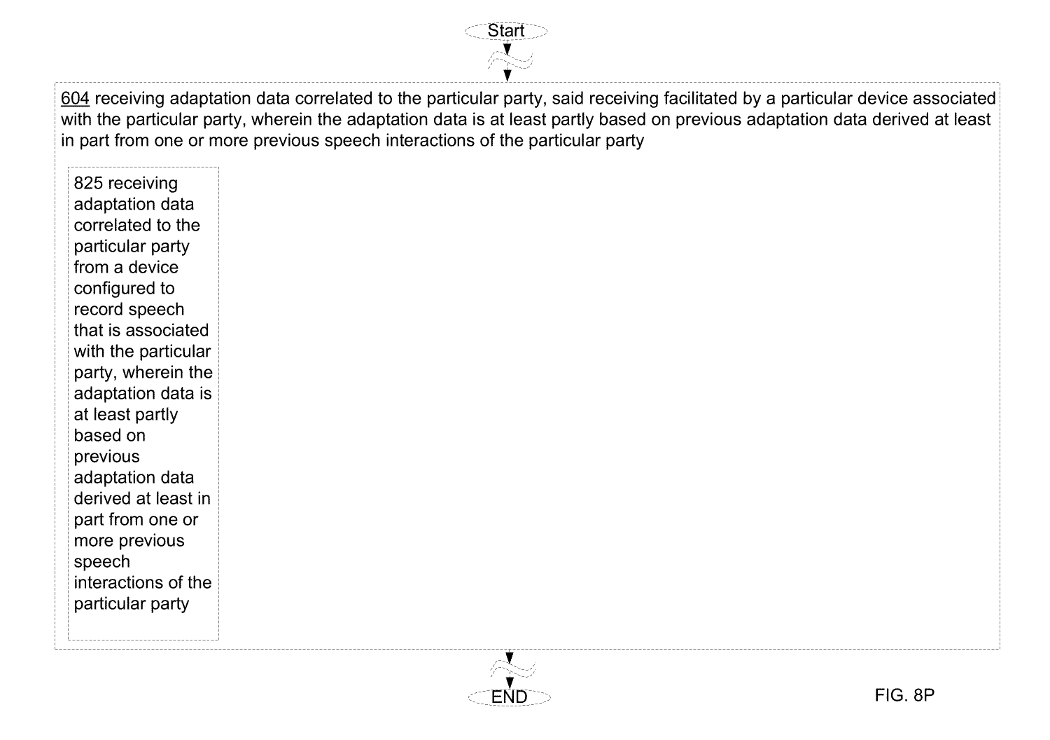

FIGS. 8A-8P depict various implementations of operation 604, according to embodiments. Referring now to FIG. 8A, operation 604 may include operation 802 depicting receiving adaptation data comprising speech characteristics of the particular party, said receiving facilitated by a particular device associated with the particular party, wherein the adaptation data is at least partly based on previous adaptation data derived at least in part from one or more previous speech interactions of the particular party. For example, FIG. 3 shows particular party-correlated previous speech interaction based speech characteristics from particular-party associated particular device receiving module 302 receiving adaptation data (e.g., data for modifying, changing, creating, updating, replacing, or otherwise interacting with the portions of the target device dealing with speech processing) comprising speech characteristics of the particular party (e.g., speech patterns for particular words, syllable recognition information, word recognition information, phoneme recognition information, sentence recognition information, pronunciation recognition information, and/or phrase recognition information), sad receiving facilitated by (e.g. the adaptation data is transmitted by) a particular device (e.g., a user's smartphone) associated with the particular party (e.g., in the particular party's possession), wherein the adaptation data is at least partly based on previous adaptation data (e.g., adaptation data that existed previously to the adaptation data that is transferred) derived at least in part from one or more previous speech interactions (e.g., speech interactions between a user and another person, or speech interactions between a user and another terminal) of the particular party (e.g., the user).

Referring again to FIG. 8A, operation 604 may include operation 804 depicting receiving adaptation data comprising instructions for adapting one or more speech recognition modules from a particular device associated with the particular party, wherein the adaptation data is at least partly based on previous adaptation data derived at least in part from one or more previous speech interactions of the particular party. For example, FIG. 3 shows particular party-correlated previous speech interaction based instructions for adapting one or more speech recognition modules from particular-party associated particular device receiving module 304 receiving adaptation data comprising instructions for adapting (e.g., instructions for modifying the speech recognition module in order to more efficiently process speech from the particular party) one or more speech recognition modules (e.g., hardware or software in the target device or an intermediary device) from a particular device (e.g., a device carried by the user that stores and/or transmits adaptation data) associated with the particular party (e.g., owned by the particular party), wherein the adaptation data is at least partly based on previous adaptation data (e.g., different adaption data) derived at least in part from one or more previous speech interactions (e.g., a user talking to his computer equipped with a microphone) of the particular party.

Referring again to FIG. 8A, operation 604 may include operation 806 depicting receiving adaptation data comprising instructions for updating one or more speech recognition modules from a particular device associated with the particular party, wherein the adaptation data is at least partly based on previous adaptation data derived at least in part from one or more previous speech interactions of the particular party. For example, FIG. 3 shows particular party-correlated previous speech interaction based instructions for updating one or more speech recognition modules from particular-party associated particular device receiving module 306 receiving adaptation data comprising instructions for updating (e.g., adding, replacing, modifying, or otherwise changing a module, or in the absence of an existing module, creating one) one or more speech recognition modules (e.g., hardware or software in the target device or an intermediary device configured to facilitate speech) from a particular device (e.g., a specialized adaptation data storage and transmitting device carried by the user, e.g., on a keychain) associated with the particular party (e.g., bought or registered by the particular party), wherein the adaptation data is at least partly based on previous adaptation data (e.g., different adaptation data) derived at least in part from one or more previous speech interactions (e.g., a user commanding a Blu-ray player to fast-forward, pause, stop, and play Blu-ray discs.

Referring again to FIG. 8A, operation 604 may include operation 808 depicting receiving adaptation data comprising instructions for modifying one or more speech recognition modules from a particular device associated with the particular party, wherein the adaptation data is at least partly based on previous adaptation data derived at least in part from one or more previous speech interactions of the particular party. For example, FIG. 3 shows particular party-correlated previous speech interaction based instructions for modifying one or more speech recognition modules from particular-party associated particular device receiving module 308 receiving adaptation data comprising instructions for modifying (e.g., changing in some way in order to potentially improve at least one aspect of) one or more speech recognition modules (e.g., hardware or software that is discrete and capable of independently operating and interfacing with the target device) from a particular device (e.g., a device designed to facilitate different types of access for disabled people, e.g., a specialized wheelchair), wherein the adaptation data is at least partly based on previous adaptation data (e.g., pronunciation keys for the particular party saying commonly-used words) derived at least in part from one or more previous speech interactions of the particular party (e.g., previous speech interactions with terminals of similar types, e.g., airline ticket dispensing terminals).

Referring again to FIG. 8A, operation 604 may include operation 810 depicting receiving adaptation data comprising data linking pronunciation of one or more phonemes by the particular party to one or more concepts, from a particular device associated with the particular party, wherein the adaptation data is at least partly based on previous adaptation data derived at least in part from one or more previous speech interactions of the particular party. For example, FIG. 3 shows particular party-correlated previous speech interaction based data linking particular party pronunciation of one or more words to one or more words from particular-party associated particular device receiving module 310 receiving adaptation data comprising data linking pronunciation of one or more phonemes (e.g., “/h/” /bcj/”) by the particular party (e.g., the person involved in the speech-facilitated transaction) to one or more concepts (e.g., the phoneme “/s/” is linked to the letter “-s” appended at the end of a word), from a particular device (e.g., an interface tablet carried by the user) associated with the particular party (e.g., the particular party is logged in as a user of the particular device), wherein the adaptation data is at least partly based on previous adaptation data (e.g., adaptation data of a same type, e.g., phonemes linked to concepts) derived at least in part from one or more previous speech interactions (e.g., the user training the interface tablet to respond to particular voice commands) of the particular party.

Referring now to FIG. 8B, operation 604 may include operation 812 depicting receiving data comprising a location at which adaptation data correlated to the particular party is available, from a particular device associated with the particular party, wherein the adaptation data is at least partly based on previous adaptation data derived at least in part from one or more previous speech interactions of the particular party. For example, FIG. 3 shows particular party-correlated previous speech interaction based data locating available particular party correlated adaptation data from particular-party associated particular device receiving module 312 receiving data comprising a location (e.g., a web address or server location address expressed as an IPv4 or IPv6 address) at which adaptation data (e.g., pronunciation models of the ten words most commonly used to interact with the target device) correlated to the particular party is available (e.g., able to be retrieved, either protected by a password, encryption, or otherwise unprotected), from a particular device (e.g., a small token that stores a location and an authentication password for accessing the data at the location) associated with the particular party (e.g., carried by the particular party, or stored inside an object on the particular party, e.g., inside a pair of eyeglasses), wherein the adaptation data is at least partly based on previous adaptation data (e.g., slightly different pronunciation models of the words most commonly used to interact with the target device, or a different set of words for interacting with a different target device) derived at least in part from one or more previous speech interactions (e.g., previous speech interactions with a motor vehicle) of the particular party.

Referring again to FIG. 8B, operation 604 may include operation 895 depicting receiving adaptation data comprising data linking pronunciation of one or more audibly distinguishable sounds by the particular party to one or more concepts, from a particular device associated with the particular party, wherein the adaptation data is at least partly based on previous adaptation data derived at least in part from one or more previous speech interactions of the particular party. For example, FIG. 3 shows particular party-correlated audibly distinguishable sound linking to concept adaptation data from particular-party associated particular device receiving module 395 receiving adaptation data comprising data linking pronunciation (e.g., the way the user pronounces) of one or more audibly distinguishable sounds (e.g., phonemes or morphemes) by the particular party (e.g., the user, having logged into his work computer, attempting to train the work computer to the user's voice) to one or more concepts (e.g., combinations of phonemes and morphemes into words such as “open Microsoft Word,” which opens the word processor for the user), from a particular device associated with the particular party (e.g., a USB “thumb” drive that is inserted into the work computer, such that the USB drive may or may not also include the user's credentials, verification, or login information), wherein the adaptation data is at least partly based on previous adaptation data (e.g., adaptation data derived from a previous training of a different computer) derived at least in part from one or more previous speech interactions of the particular party (e.g., the user previously trained on a different computer, which may or may not have been part of the enterprise solution, e.g., the computer could have been a home computer, or a computer from a different company, or from a different division of the same company).

Referring again to FIG. 8B, operation 604 may include operation 814 depicting receiving data comprising authorization to receive adaptation data correlated to the particular party, from a particular device associated with the particular party, wherein the adaptation data is at least partly based on previous adaptation data derived at least in part from one or more previous speech interactions of the particular party. For example, FIG. 3 shows particular party-correlated previous speech interaction based authorization to receive data correlated to particular party from particular-party associated particular device receiving module 314 receiving data comprising authorization (e.g., a code, password, key, security level setting, or other feature designed to provide access) to receive adaptation data (e.g., example accuracy rates of various speech models previously used, so that a system can pick one that it desires based on accuracy rates and projected type of usage) correlated to the particular party (e.g., the accuracy rates are, at least in part, based on previous interactions by the particular party), from a particular device associated with the particular party (e.g., transmitted from a cellular or wireless radio communication device carried by the particular party), wherein the adaptation data is at least partly based on previous adaptation data (e.g., other accuracy rates of various speech models that are updated after speech-facilitated interactions by the particular party) derived at least in part from one or more previous speech interactions of the particular party (e.g., each time a speech-facilitated interaction by the particular party is facilitated by the particular device, adaptation data is stored, and updated if warranted).

Referring again to FIG. 8B, operation 604 may include operation 816 depicting receiving data comprising instructions for obtaining adaptation data correlated to the particular party, from a particular device associated with the particular party, wherein the adaptation data is at least partly based on previous adaptation data derived at least in part from one or more previous speech interactions of the particular party. For example, FIG. 3 shows particular party-correlated previous speech interaction based instructions for obtaining adaptation data from particular-party associated particular device receiving module 316 receiving data comprising instructions for obtaining adaptation data (e.g., data including one or more of locations, login information, credential information, screens for displaying, software needed to obtain adaptation data, a list of hardware compatible with the adaptation data, etc.) correlated to the particular party (e.g., the instructions are for locating the adaptation data related to the particular party), from a particular device (e.g., a smartphone) associated with the particular party (e.g., the user has a service contract for the smartphone), wherein the adaptation data (e.g., speech model adaptation instructions) is at least partly based on previous adaptation data (e.g., less-recently updated speech model adaptation instructions) derived at least in part (e.g., the speech model adaptation information is updated based upon the success of the one or more previous speech interactions) from one or more previous speech interactions (e.g., interactions with speech facilitated systems, e.g., bank or credit card systems that use an automated answering and routing system) of the particular party.

Referring again to FIG. 8B, operation 604 may include operation 818 depicting receiving adaptation data including particular party identification data and data correlated to the particular party, said receiving facilitated by a particular device associated with the particular party, wherein the adaptation data is at least partly based on previous adaptation data derived at least in part from one or more previous speech interactions of the particular party. For example, FIG. 3 shows particular party-correlated previous speech interaction based adaptation data including particular party identification data from particular-party associated particular device receiving module 318 receiving adaptation data (e.g., a word acceptance algorithm tailored to the particular party, e.g., the user) including particular party identification data (e.g., data identifying the particular party, either in a specific (e.g., “John Smith”) or a non-specific (e.g., “Bank of America account holder”) manner and data correlated to the particular party (e.g., the aforementioned word acceptance algorithm), said receiving facilitated by a particular device (e.g., a smartphone that provides the location where the word acceptance algorithm may be retrieved, e.g., a website, e.g., “https://www.fakeurl.com/acceptancealgorithm0101011.html”) associated with the particular party (e.g., the user is carrying the smartphone), wherein the adaptation data is at least partly based on previous adaptation data (e.g., an earlier version of the word acceptance algorithm) derived at least in part from one or more previous speech interactions (e.g., a user's speech interaction with an automated phone answering and routing system) of the particular party.

Referring again to FIG. 8B, operation 818 may include operation 820 depicting receiving adaptation data uniquely identifying the particular party and correlated to the particular party, said receiving facilitated by a particular device associated with the particular party, wherein the adaptation data is at least partly based on previous adaptation data derived at least in part from one or more previous speech interactions of the particular party. For example, FIG. 3 shows particular party-correlated previous speech interaction based adaptation data including particular party unique identification data from particular-party associated particular device receiving module 320 receiving adaptation data (e.g., a probabilistic word model based on that particular user and the target device to which the user is interacting, which is a subset of the total adaptation data facilitated by the particular device, which may include a library of probabilistic word models for different target devices, e.g., different models for an ATM machine and a DVD player) uniquely identifying the particular party (e.g., the probabilistic word model of John Smith, or the probabilistic word model of a user having the username SpaceBot_{—}0901)) and correlated to the particular party, said receiving facilitated by a particular device (e.g., a headset and microphone which also is capable of storing and/or transmitting and receiving data) associated with the particular party (e.g., being worn by the user), wherein the adaptation data (e.g., the probabilistic word model) is at least partly based on previous adaptation data (e.g., a prior probabilistic word model that is updated at periodic intervals) derived at least in part from one or more previous speech interactions (e.g., speech interactions using the particular device, e.g., the headset and microphone) of the particular party (e.g., the user wearing the headset and microphone).

Referring now to FIG. 8C, operation 604 may include operation 822 depicting receiving adaptation data correlated to the particular party from a particular device owned by the particular party, wherein the adaptation data is at least partly based on previous adaptation data derived at least in part from one or more previous speech interactions of the particular party. For example, FIG. 3 shows particular party-correlated previous speech interaction based adaptation data from particular-party owned particular device receiving module 322 receiving adaptation data (e.g., an expected response-based algorithm) correlated to the particular party (e.g., tailored to one or more of the particular party's speech characteristics and expected responses) from a particular device (e.g., a key for a motor vehicle that stores adaptation data) owned by the particular party (e.g., the owner of the motor vehicle owns the key), wherein the adaptation data is at least partly based on previous adaptation data (e.g., a prior expected response-based algorithm) derived at least in part from one or more previous speech interactions (e.g., previous times the driver has used the key to start the motor vehicle and interacted with the motor vehicle using speech) of the particular party (e.g., the user).

Referring again to FIG. 8C, operation 604 may include operation 824 depicting receiving adaptation data correlated to the particular party from a particular device carried by the particular party, wherein the adaptation data is at least partly based on previous adaptation data derived at least in part from one or more previous speech interactions of the particular party. For example, FIG. 3 shows particular party-correlated previous speech interaction based adaptation data from particular-party carried particular device receiving module 324 receiving adaptation data (e.g., a best-model selection algorithm) correlated to the particular party (e.g., at least a portion of the algorithm is related to the user in some manner), from a particular device carried by the particular party (e.g., an identification badge configured to store and transmit data), wherein the adaptation data is at least partly based on previous adaptation data (e.g., a prior best-model selection algorithm, which may have had fewer models, different models, or a different manner of selecting models) derived at least in part from one or more previous speech interactions (e.g., each interaction with a different type of device creates a new model and changes the selection process of the model) of the particular party (e.g., the user).

Referring again to FIG. 8C, operation 604 may include operation 826 depicting receiving adaptation data correlated to the particular party from a particular device previously used by the particular party, wherein the adaptation data is at least partly based on previous adaptation data derived at least in part from one or more previous speech interactions of the particular party. For example, FIG. 3 shows particular party-correlated previous speech interaction based adaptation data from particular device previously used by particular party receiving module 326 receiving adaptation data (e.g., a word conversion hypothesizer) correlated to the particular party (e.g., the user, and the word conversion hypothesizer has at least one feature that is based on at least one property of the user's speech) from a particular device (e.g., a user's smartphone) previously used by the particular party (e.g., the user has previously operated the cellphone, such operation being any function, regardless of whether it is speech-facilitated), wherein the adaptation data is at least partly based on previous adaptation data (e.g., an earlier word conversion hypothesizer, which may be the same word conversion hypothesizer, if no modifications have been made) derived at least in part from one or more previous speech interactions of the particular party (e.g., a base word conversion hypothesizer was loaded on the particular device, and after each speech interaction by the particular party, a decision is made regarding whether to update or modify the word conversion hypothesizer, based on a result or a perceived result of the speech interaction with the particular party).

Referring again to FIG. 8C, operation 604 may include operation 828 depicting receiving adaptation data correlated to the particular party from a particular device for which a service contract is affiliated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party service contract affiliated particular device receiving module 328 receiving adaptation data (e.g., a continuous word recognition module) correlated to the particular party (e.g., the continuous word recognition module has been tailored to the particular party based on speech patterns of the particular party) from a particular device (e.g., a cellular telephone) for which a service contract (e.g., a two-year contract for cellular service with AT&T) is affiliated with the particular party (e.g., it is the user that signed the contract for cellular service with AT&T that covers the cellular telephone), wherein the adaptation data (e.g., the continuous word recognition module) is least partly based on previous adaptation data (e.g., an incomplete continuous word recognition module that was previously not used, but after a number of speech interactions, had enough data for a complete continuous word recognition module that is used to assist in speech-facilitated transactions) derived at least in part from one or more previous speech interactions (e.g., interactions with devices that use a combination of hardware or software to recognize speech) of the particular party.

Referring again to FIG. 8C, operation 604 may include operation 830 depicting receiving adaptation data correlated to the particular party from a particular device of which the particular party is a user, wherein the adaptation data is at least partly based on previous adaptation data derived at least in part from one or more previous speech interactions of the particular party. For example, FIG. 3 shows particular party-correlated previous speech interaction based adaptation data from particular device used by particular party receiving module 330 receiving adaptation data (e.g., tailored utterance recognition information) correlated to the particular party (e.g., the utterance recognition information is tailored to the particular party, e.g., the user) from a particular device (e.g., a laptop computer) of which the particular party is a user (e.g., the particular party has at least once used the laptop computer, or the laptop computer is configured to recognize the particular party as a person who has access to use the laptop computer), wherein the adaptation data (e.g., the tailored utterance recognition information) is at least partly based on previous adaptation data (e.g., prior tailored utterance recognition information, which may be compiled from the particular party as well as other users, e.g., other users of the laptop computer, or other users generally) derived at least in part from one or more previous speech interactions of the particular party (e.g., the particular party, as well as other parties, may communicate with the laptop computer through a speech interaction).

Referring now to FIG. 8D, operation 604 may include operation 832 depicting receiving adaptation data correlated to the particular party from a particular device configured to allow the particular party to log in, wherein the adaptation data is at least partly based on previous adaptation data derived at least in part from one or more previous speech interactions of the particular party. For example, FIG. 3 shows particular party-correlated previous speech interaction based adaptation data particular device configured to allow particular party login receiving module 332 receiving adaptation data (e.g., adaptable word templates) correlated to the particular party (e.g., a user) from a particular device configured to allow the particular party to log in (e.g., a generic speech facilitation unit that is reusable, e.g., may be distributed or handed out, e.g., inside a museum, or in an airplane, and that allows user login, and once a user logs in, retrieves the adaptation data, e.g., the adaptable word templates for that user, from a central repository), wherein the adaptation data (e.g., the adaptable word templates) is at least partly based on previous adaptation data (e.g., the selection of an adaptable word template is based on previous selections of an adaptable word template and the perceived result, e.g., the system may know that adaptable word template A2 was used twice, and adaptable word template A4 was used three times, and adaptable word template B4 was used eight times, and other adaptable word templates C2, B6, A3, and A7 were each used once, then an adaptable word template with characteristics of B4 and characteristics specific to the expected speech interaction may be chosen as the adaptation data, e.g., adaptable word template C4) derived at least in part (e.g., the selection of the adaptable word template is at least partially controlled by previous selections of adaptable word templates) from one or more previous speech interactions (e.g., at least one previous speech interaction for which an adaptable word template was selected) of the particular party.

Referring now to FIG. 8D, operation 604 may include operation 834 depicting receiving adaptation data correlated to the particular party from a particular device configured to store data regarding the particular party, wherein the adaptation data is at least partly based on previous adaptation data derived at least in part from one or more previous speech interactions of the particular party. For example, FIG. 3 shows particular party-correlated previous speech interaction based adaptation data particular device configured to store particular party data receiving module 334 receiving adaptation data (e.g., a speech processing algorithm specification) correlated to the particular party (e.g., at least a portion of the speech processing algorithm specification is related to the user) from a particular device (e.g., a smartphone) configured to store data regarding the particular party (e.g., demographic data, identification data, or any other type of data about the user), wherein the adaptation data (e.g., the speech processing algorithm specification) is at least partly based on previous adaptation data (e.g., an older version of the speech processing algorithm specification) derived at least in part from one or more previous speech interactions of the particular party (e.g., the older version of the speech processing algorithm specification is based on previous speech interactions the user as with various machines configured to receive speech as input).

Referring again to FIG. 8D, operation 834 may include operation 836 depicting receiving adaptation data correlated to the particular party from a particular device configured to store profile data regarding the particular party, wherein the adaptation data is at least partly based on previous adaptation data derived at least in part from one or more previous speech interactions of the particular party. For example, FIG. 3 shows particular party-correlated previous speech interaction based adaptation data particular device configured to store particular party profile data receiving module 336 receiving adaptation data (e.g., algorithm selection data) correlated to the particular party (e.g., the algorithm selection data is based on selecting the best algorithm for the particular user involved in the speech-facilitated transaction) from a particular device (e.g., a server stored remotely from the user) configured to store profile data (e.g., data about the user) regarding the particular party (e.g., the user), wherein the adaptation data (e.g., algorithm selection data) is at least partly based on previous adaptation data (e.g., previous versions of the algorithm selection data, which may be the same as the algorithm selection data) derived at least in part (e.g., the algorithm selection data may be based on many factors, of which the speech characteristics of the user may be one) from one or more previous speech interactions of the particular party (e.g., a particular algorithm is selected based on the algorithm selection data from a previous speech interaction, and a perceived success of the previous speech interaction is determined, and the selected particular algorithm is stored along with its success rate, as well as various other characteristics of the speech interaction, e.g., which words were used, and what type of machine the user interacted with).

Referring again to FIG. 8D, operation 834 may include operation 838 depicting receiving adaptation data correlated to the particular party from a particular device configured to store data unrelated to speech recognition modules regarding the particular party, wherein the adaptation data is at least partly based on previous adaptation data derived at least in part from one or more previous speech interactions of the particular party. For example, FIG. 3 shows particular party-correlated previous speech interaction based adaptation data particular device configured to store particular party speech profile unrelated data receiving module 338 receiving adaptation data (e.g., phoneme mapping algorithm) correlated to the particular party (e.g., the user) from a particular device (e.g., a digital music player) configured to store data (e.g., music preference information, e.g., or information regarding a social network profile, e.g., a Facebook or Twitter profile) unrelated to speech recognition modules regarding the particular party (e.g., the user), wherein the adaptation data (e.g., the phoneme mapping algorithm) is at least partly based on previous adaptation data (e.g., a previous phoneme mapping algorithm that is different only in its processing of the “w” sound phoneme) derived at least in part from one or more previous speech interactions of the particular party (e.g., the phoneme mapping algorithm is modifiable by speech interactions that the user undertakes.

Referring again to FIG. 8D, operation 604 may include operation 840 depicting receiving adaptation data correlated to the particular party from a particular device located within a particular proximity to the particular party, wherein the adaptation data is at least partly based on previous adaptation data derived at least in part from one or more previous speech interactions of the particular party. For example, FIG. 3 shows particular party-correlated previous speech interaction based adaptation data from particular device in particular proximity to particular party receiving module 340 receiving adaptation data (e.g., instructions for modifying a vocable recognition system) correlated to the particular party (e.g., the user, and the instructions for modifying are correlated to the user) from a particular device (e.g., from an object on a keychain) located within a particular proximity to the particular party (e.g., the particular party is located within a sphere 1 m in diameter around the object on the keychain), wherein the adaptation data (e.g., instructions for modifying a vocable recognition system) is at least partly based on previous adaptation data (e.g., prior instructions for modifying a vocable recognition system) derived at least in part from one or more previous speech interactions of the particular party (e.g., the prior instructions are at least partly based on observed outcomes of previous speech interactions).

Referring now to FIG. 8E, operation 604 may include operation 842 depicting receiving adaptation data correlated to the particular party from a particular device positioned closer to the particular party than other devices, wherein the adaptation data is at least partly based on previous adaptation data derived at least in part from one or more previous speech interactions of the particular party. For example, FIG. 3 shows particular party-correlated previous speech interaction based adaptation data from particular-party associated particular device closer to particular party receiving module 342 receiving adaptation data (e.g., a speech disfluency recognition algorithm) correlated to the particular party (e.g., the algorithm is tailored to recognize speech disfluencies of the particular party, e.g., the user) from a particular device (e.g., a smartphone) positioned closer to the particular party (e.g., the user) than other devices (e.g., other smartphones carried by other people, e.g., in order to distinguish, in a group, between the particular party's smartphone and other smartphones which may or may not be proffering adaptation data), wherein the adaptation data (e.g., the speech disfluency recognition algorithm) is at least partly based on previous adaptation data (e.g., an outdated or previously used speech disfluency recognition algorithm) derived at least in part from one or more previous speech interactions of the particular party (e.g., stored previous speech interactions of the particular party are retrieved from locations at which such interactions are stored, and the speech is analyzed for speech disfluencies, which are then identified and categorized so that they may be recognized in future speech interactions).

Referring again to FIG. 8E, operation 604 may include operation 844 depicting receiving adaptation data correlated to the particular party, said receiving facilitated by a particular device associated with the particular party, wherein the adaptation data is at least partly based on previous adaptation data derived at least in part from one or more previous speech interactions of the particular party with one or more devices other than the target device. For example, FIG. 3 shows particular party-correlated previous other device speech interaction based adaptation data from particular-party associated particular device receiving module 344 receiving adaptation data (e.g., a speech disfluency deletion algorithm) correlated to the particular party (e.g., the user), said receiving facilitated by a particular device (e.g., the particular device, e.g., a tablet or smartphone, may provide an address or instructions for receiving the adaptation data) associated with the particular party (e.g., the user), wherein the adaptation data (e.g., the speech disfluency deletion algorithm) is at least partly based on previous adaptation data (e.g., older speech disfluency deletion algorithms) derived at least in part from one or more previous speech interactions (e.g., speech-facilitated transactions between the user and a device configured to accept speech as input) of the particular party (e.g., the user) with one or more devices (e.g., a big screen television that accepts speech input) other than the target device (e.g., a speech-enabled DVD player).

Referring again to FIG. 8E, operation 604 may include operation 846 depicting receiving adaptation data correlated to the particular party, said receiving facilitated by a particular device associated with the particular party, wherein the adaptation data is at least partly based on previous adaptation data derived at least in part from one or more previous speech interactions of the particular party with one or more devices related to the target device. For example, FIG. 3 shows particular party-correlated previous other related device speech interaction based adaptation data from particular-party associated particular device receiving module 346 receiving adaptation data (e.g., a discourse marker ignoring algorithm) correlated to the particular party (e.g., the user), said receiving facilitated by a particular device (e.g., a universal remote control) associated with the particular party (e.g., the user owns the universal remote control), wherein the adaptation data (e.g., the discourse marker ignoring algorithm) is at least partly based on previous adaptation data (e.g., previous discourse marker ignoring algorithms) derived at least in part from one or more previous speech interactions (e.g., setting the volume) of the particular party (e.g., the user), with one or more devices (e.g., an audio visual receiver) related to the target device (e.g., a Blu-Ray player, related to the A/V receiver in that they are both components of common home theater systems).

Referring again to FIG. 8E, operation 604 may include operation 848 depicting receiving adaptation data correlated to the particular party, said receiving facilitated by a particular device associated with the particular party, wherein the adaptation data is at least partly based on previous adaptation data derived at least in part from one or more previous speech interactions of the particular party with devices using an intersecting vocabulary as the target device. For example, FIG. 3 shows particular party-correlated previous other device having same vocabulary as target device speech interaction based adaptation data from particular-party associated particular device receiving module 348 receiving adaptation data (e.g., non-purposeful filler filter algorithm) correlated to the particular party (e.g., the user), said receiving facilitated by a particular device (e.g., a networked home computer) associated with the particular party (e.g., owned, set up, or used by the user), wherein the adaptation data (e.g., the non-purposeful filler filter algorithm) is at least partly based on previous adaptation data (e.g., a previous non-purposeful filler filter algorithm) derived at least in part from one or more previous speech interactions of the particular party (e.g., voice commands from the user) with devices (e.g., media players) using an intersecting vocabulary (e.g., having at least one word the same, e.g., “power off”) as the target device (e.g., video game systems).

Referring again to FIG. 8E, operation 604 may include operation 850 depicting receiving adaptation data correlated to the particular party, said receiving facilitated by a particular device associated with the particular party, wherein the adaptation data is at least partly based on previous adaptation data derived at least in part from one or more previous speech interactions with one or more devices manufactured by the same manufacturer as the target device. For example, FIG. 3 shows particular party-correlated previous other device having same manufacturer as target device speech interaction based adaptation data from particular-party associated particular device receiving module 350 receiving adaptation data (e.g., particularized vocabulary adjuster) correlated to the particular party (e.g., the user), said receiving facilitated by a particular device (e.g., an adaptation data storage device carried by users and configured to store, transmit, and receive adaptation data) associated with the particular party (e.g., stores data correlated to the user), wherein the adaptation data is at least partly based on previous adaptation data (e.g., a previous particularized vocabulary adjuster) derived at least in part from one or more previous speech interactions with one or more devices (e.g., Apple iPhone) manufactured by the same manufacturer (e.g., Apple) as the target device (e.g., Apple TV).

Referring now to FIG. 8F, operation 604 may include operation 852 depicting receiving adaptation data correlated to the particular party, said receiving facilitated by a particular device associated with the particular party, wherein the adaptation data is at least partly based on previous adaptation data derived at least in part from one or more previous speech interactions with one or more devices configured to carry out similar functions as the target device. For example, FIG. 3 shows particular party-correlated previous other similar-function configured device speech interaction based adaptation data from particular-party associated particular device receiving module 352 receiving adaptation data (e.g., vocabulary word weighting modification algorithm) correlated to the particular party (e.g., a user), said receiving facilitated by a particular device (e.g., a speech facilitating tool) associated with the particular party (e.g., kept in the particular party's house), wherein the adaptation data is at least partly based on previous adaptation data (e.g., a previous vocabulary word weighting modification algorithm) derived at least in part from one or more previous speech interactions (e.g., operating a device at least partially through speech) with one or more devices (e.g., a stereo system and a radio) configured to carry out similar functions (e.g., playing sound, having a volume control) as the target device (e.g., a speech input enabled television).

Referring again to FIG. 8F, operation 604 may include operation 854 depicting receiving adaptation data correlated to the particular party, said receiving facilitated by a particular device associated with the particular party, wherein the adaptation data is at least partly based on previous adaptation data derived at least in part from one or more previous speech interactions with one or more devices configured to carry out one or more same functions as the target device. For example, FIG. 3 shows particular party-correlated previous other same-function configured device speech interaction based adaptation data from particular-party associated particular device receiving module 354 receiving adaptation data (e.g., a speech deviation algorithm, e.g., based on the user's speech patterns under particular conditions, e.g., stress) correlated to the particular party (e.g., the user), said receiving facilitated by a particular device (e.g., a home monitoring system) associated with the particular party (e.g., installed in the user's home), wherein the adaptation data (e.g., the speech deviation algorithm) is at least partly based on previous adaptation data (e.g., a previous speech deviation algorithm) derived at least in part from one or more previous speech interactions with one or more devices (e.g., a door lock system) configured to carry out one or more same functions (e.g., locking) as the target device (e.g., a safe, or an interior door or window locking system).

Referring again to FIG. 8F, operation 604 may include operation 856 depicting receiving adaptation data correlated to the particular party, said receiving facilitated by a particular device associated with the particular party, wherein the adaptation data is at least partly based on previous adaptation data derived at least in part from one or more previous speech interactions with one or more devices that previously carried out a same function as the target device is configured to carry out. For example, FIG. 3 shows particular party-correlated other devices previously carrying out same function as target device speech interaction based adaptation data from particular-party associated particular device receiving module 356 receiving adaptation data (e.g., non-lexical vocable discarding algorithm) correlated to the particular party (e.g., the user), said receiving facilitated by a particular device (e.g., a smartphone) associated with the particular party (e.g., the user), wherein the adaptation data is at least partly based on previous adaptation data (e.g., a previous non-lexical vocable discarding algorithm) derived at least in part from one or more previous speech interactions (e.g., programming the previous DVD player) with one or more devices (e.g., old, possibly now-discarded DVD players) that previously carried out a same function (e.g., playing DVDs) as the target device (e.g., a new DVD player) is configured to carry out.

Referring again to FIG. 8F, operation 604 may include operation 858 depicting receiving adaptation data correlated to the particular party, said receiving facilitated by a particular device associated with the particular party, wherein the adaptation data is at least partly based on previous adaptation data derived at least in part from one or more speech interactions with at least one device of a same type as the target device. For example, FIG. 3 shows particular party-correlated previous other same-type device speech interaction based adaptation data from particular-party associated particular device receiving module 358 receiving adaptation data (e.g., instructions for an adaptation control module) correlated to the particular party (e.g., tailored to the user), said receiving facilitated by a particular device (e.g., a hand-held PDA) associated with the particular party (e.g., owned by the user), wherein the adaptation data (e.g., the instructions for an adaptation control module) is at least partly based on previous adaptation data (e.g., a previous instruction for an adaptation control module) derived at least in part from one or more speech interactions with at least one device (e.g., a netbook) of a same type (e.g., a computer) as the target device (e.g., a desktop computer).

Referring again to FIG. 8F, operation 604 may include operation 860 depicting receiving adaptation data correlated to the particular party, said receiving facilitated by a particular device associated with the particular party, wherein the adaptation data is at least partly based on previous adaptation data derived at least in part from one or more speech interactions with the particular device. For example, FIG. 3 shows particular party-correlated previous particular device speech interaction based adaptation data from particular-party associated particular device receiving module 360 receiving adaptation data (e.g., a phoneme pronunciation guide) correlated to the particular party (e.g., the user), said receiving facilitated by a particular device (e.g., a smartphone) associated with the particular party (e.g., owned or operated by the user), wherein the adaptation data (e.g., the phoneme pronunciation guide) is at least partly based on previous adaptation data (e.g., an earlier version, which may be identical, of the phoneme pronunciation guide) derived at least in part from one or more speech interactions (e.g., programming the device, or making a call on the device) with the particular device (e.g., the smartphone).

Referring now to FIG. 8G, operation 604 may include operation 862 depicting receiving adaptation data correlated to the particular party, said receiving facilitated by a particular device associated with the particular party, wherein the adaptation data is at least partly based on previous adaptation data derived at least in part from one or more previous speech interactions observed by the particular device. For example, FIG. 3 shows particular party-correlated previous speech interactions observed by particular device based adaptation data from particular-party associated particular device receiving module 362 receiving adaptation data (e.g., a syllable pronunciation guide) correlated to the particular party (e.g., the user), said receiving facilitated by a particular device (e.g., a smartphone) associated with the particular party (e.g., carried by the particular party), wherein the adaptation data (e.g., the syllable pronunciation guide) is at least partly based on previous adaptation data (e.g., a previous syllable pronunciation guide) derived at least in part from one or more previous speech interactions (e.g., the user interacting with a terminal that accepts speech) observed (e.g., recorded by the smartphone's microphone) by the particular device (e.g., the smartphone).

Referring again to FIG. 8G, operation 604 may include operation 864 depicting receiving adaptation data correlated to the particular party, said receiving facilitated by a particular device associated with the particular party, wherein the adaptation data is at least partly based on previous adaptation data derived at least in part from one or more previous speech interactions of the particular party, wherein said adaptation data is correlated to one or more vocabulary words. For example, FIG. 3 shows particular party-correlated previous speech interaction based adaptation data correlated to one or more vocabulary words and received from particular-party associated particular device receiving module 364 receiving adaptation data (e.g., a word pronunciation guide) correlated to the particular party (e.g., a guide of how the user pronounces words), said receiving facilitated by a particular device (e.g., a portable tablet computer) associated with the particular party (e.g., operated by the user), wherein the adaptation data (e.g., the word pronunciation guide) is at least partly based on previous adaptation data (e.g., a previous word pronunciation guide, which may be the same, or may have different or fewer words, or may have different or more pronunciations, or different favorite pronunciations of words) derived at least in part from one or more previous speech interactions of the particular party (e.g., speech-facilitated transactions between the user and at least one device configured to receive speech input), wherein said adaptation data is correlated to one or more vocabulary words (e.g., the adaptation data deals with one or more vocabulary words).

Referring again to FIG. 8G, operation 864 may include operation 866 depicting receiving adaptation data correlated to the particular party, said receiving facilitated by a particular device associated with the particular party, wherein the adaptation data is at least partly based on previous adaptation data derived at least in part from one or more previous speech interactions of the particular party, wherein said adaptation data is correlated to one or more vocabulary words used by the target device. For example, FIG. 3 shows particular party-correlated previous speech interaction based adaptation data correlated to one or more target device vocabulary words and received from particular-party associated particular device receiving module 366 receiving adaptation data (e.g., a subset of a word pronunciation guide) correlated to the particular party (e.g., a guide of the pronunciation keys for at least one word), said receiving facilitated by a particular device (e.g., a pocket electronic dictionary device, or a pocket translator device) associated with the particular party (e.g., owned by the user), wherein the adaptation data is correlated to one or more vocabulary words used by the target device (e.g., the one or more vocabulary words used by the target device, e.g., an Automated Teller Machine, may be “deposit,” and the one or more vocabulary words used by the target device may be included in, but not necessarily exclusively, the subset of the word pronunciation guide).

Referring again to FIG. 8G, operation 604 may include operation 868 depicting requesting adaptation data correlated to the particular party from the particular device associated with the particular party. For example, FIG. 3 shows particular party-correlated adaptation data from particular party associated particular device requesting module 368 requesting adaptation data (e.g., a phoneme pronunciation guide) correlated to the particular party (e.g., the pronunciation guide is relative to the pronunciation of the user) from the particular device (e.g., the cellular smartphone, or the user's networked computer back at his house, or a server computer) associated with the particular party (e.g., that stores information regarding the particular party, e.g., the user).

Referring again to FIG. 8G, operation 604 may further include operation 870 depicting receiving adaptation data that is at least partly based on previous adaptation data derived at least in part from one or more previous speech interactions of the particular party. For example, FIG. 3 shows adaptation data partly based on previous adaptation data derived from one or more previous particular party speech interactions receiving module 870 receiving adaptation data (e.g., the phoneme pronunciation guide) correlated to the particular party (e.g., the user) that is at least partly based on previous adaptation data (e.g., a previous phoneme pronunciation guide) derived at least in part from one or more previous speech interactions of the particular party (e.g., the previous phoneme pronunciation guide is at least partly based on phoneme pronunciations detected in a previous speech interaction of the particular party).

Referring again to FIG. 8G, operation 868 may include operation 872 depicting requesting adaptation data related to one or more vocabulary words from the particular device associated with the particular party. For example, FIG. 3 shows particular party-correlated adaptation data related to one or more vocabulary words requesting module 372 requesting adaptation data (e.g., a word confidence factor lookup table, e.g., a lookup table for the confidence factor required to accept recognition of a particular word) related to one or more vocabulary words (e.g., particular words have a particular confidence factor, e.g., “yes” and “no” may use a low confidence factor since they are not easily confused, but city names (e.g., destinations, such as what might be used at an airline ticket terminal) may require a higher confidence factor in order to be accepted, depending on the particular user and the level of distinctness of their speech) from the particular device (e.g., a smartphone) associated with the particular party (e.g., associated by a third party as belonging to the user).

Referring now to FIG. 8H, operation 868 may include operation 874 depicting requesting adaptation data regarding one or more vocabulary words associated with the target device from the particular device associated with the particular party. For example, FIG. 3 shows particular party-correlated adaptation data regarding one or more target device vocabulary words requesting module 374 requesting adaptation data (e.g., a word pronunciation guide) regarding one or more vocabulary words (e.g., a numeric pronunciation guide with pronunciations for numbers like “twenty,” “three,” zero,” and “one hundred”) associated with the target device (e.g., the target device requests numeric speech input, e.g., a banking terminal) from the particular device (e.g., a smartphone) associated with the particular party (e.g., the user).

Referring again to FIG. 8H, operation 874 may include operation 876 depicting requesting adaptation data regarding one or more vocabulary words used to command the target device from the particular device associated with the particular party. For example, FIG. 3 shows particular party-correlated adaptation data regarding one or more target device command vocabulary words requesting module 376 requesting adaptation data (e.g., pronunciations of words commonly mispronounced or pronounced strangely by the user) regarding one or more vocabulary words (e.g., “play Pearl Jam,” and “increase volume”) used to command the target device (e.g., the sound system of a motor vehicle) from the particular device (e.g., the smart-key used to start the car, which can also transmit, receive, and store data) associated with the particular party (e.g., the driver).

Referring again to FIG. 8H, operation 874 may include operation 878 depicting requesting adaptation data regarding one or more vocabulary words used to control the target device from the particular device associated with the particular party. For example, FIG. 3 shows particular party-correlated adaptation data regarding one or more target device control vocabulary words requesting module 378 requesting adaptation data (e.g., a speech deviation algorithm for words often said in stressful conditions) regarding one or more vocabulary words (e.g., “call police,” “activate locking system,” “sound alarm”) used to control the target device (e.g., a home security system) from the particular device (e.g., a portion of the home security system) associated with the particular party (e.g., bought by the particular party).

Referring again to FIG. 8H, operation 874 may include operation 880 depicting requesting adaptation data regarding one or more vocabulary words used to interact with the target device from the particular device associated with the particular party. For example, FIG. 3 shows particular party-correlated adaptation data regarding one or more target device interaction vocabulary words requesting module 380 requesting adaptation data (e.g., a word frequency table for a user) regarding one or more vocabulary words (e.g., for an airline ticket counter, if the user travels to Boston a lot, the word “Boston” may have a higher frequency than the word “Austin,” which, while similar sounding, is different, and may aid the target device in deciphering the user's intent) used to interact with the target device (e.g., an airline ticket counter) from the particular device (e.g., a smartphone) associated with the particular party (e.g., the user).

Referring again to FIG. 8H, operation 868 may include operation 882 depicting requesting adaptation data regarding one or more vocabulary words commonly used to interact with a type of device receiving the adaptation data from the particular device associated with the particular party. For example, FIG. 3 shows particular party-correlated adaptation data regarding one or more target device common interaction words requesting module 382 requesting adaptation data (e.g., a syllable pronunciation key tied to at least one particular word) regarding one or more vocabulary words (e.g., the word “play movie”) commonly used to interact with a type of device (e.g., a speech-enabled media center or computer) receiving the adaptation data (e.g., the syllable pronunciation key) from the particular device (e.g., the speech adaptation data box carried by the user) associated with the particular party (e.g., the user).

Referring again to FIG. 8H, operation 868 may include operation 884 depicting requesting adaptation data regarding one or more vocabulary words associated with a type of device receiving the adaptation data from the particular device associated with the particular party. For example, FIG. 3 shows particular party-correlated adaptation data regarding one or more target device type associated vocabulary words requesting module 384 requesting adaptation data (e.g., a word pronunciation guide) regarding one or more vocabulary words (e.g., requesting only adaptation data related to vocabulary words associated with a type of device, and either selecting such specific adaptation data from the available adaptation data, or letting the device select the adaptation data based on the vocabulary words associated with the type of device) associated with a type of device (e.g., if the type of device is “home entertainment” then the words might be “movie,” “song,” “play,” “stop,” “fast forward,” “rewind,” “pause,” and the like) receiving the adaptation data (e.g., the word pronunciation guide) from the particular device (e.g., a universal remote control that stores the adaptation data for many types of devices) associated with the particular party (e.g., the user).

Referring now to FIG. 8I, operation 870 may include operation 886 depicting receiving adaptation data that is at least partly based on previous adaptation data derived at least in part from one or more speech interactions of the particular party with at least one prior device. For example, FIG. 3 shows adaptation data partly based on previous adaptation data derived from one or more previous particular party speech interactions with a prior device receiving module 386 receiving adaptation data (e.g., a syllable pronunciation guide) that is at least partly based on previous adaptation data (e.g., a previous syllable pronunciation guide) derived at least in part from one or more speech interactions of the particular party with at least one prior device (e.g., a device that the user previously interacted with).

Referring again to FIG. 8I, operation 886 may include operation 888 depicting receiving adaptation data that is at least partly based on previous adaptation data derived at least in part from one or more previous speech interactions of the particular party with at least one prior device having at least one characteristic in common with the target device. For example, FIG. 3 shows adaptation data partly based on previous adaptation data derived from one or more previous particular party speech interactions with a common characteristic prior device receiving module 388 receiving adaptation data (e.g., a word acceptance algorithm) that is at least partly based on previous adaptation data (e.g., a previous word acceptance algorithm) derived at least in part from one or more previous speech interactions of the particular party with at least one prior device (e.g., a device that the user has previously interacted with, e.g., a clock radio) having at least one characteristic (e.g., has a volume control) in common with the target device (e.g., a DVD player).

Referring again to FIG. 8I, operation 888 may include operation 890 depicting receiving adaptation data that is at least partly based on previous adaptation data derived at least in part from one or more previous speech interactions of the particular party with at least one prior device configured to perform a same function as the target device. For example, FIG. 3 shows adaptation data partly based on previous adaptation data derived from one or more previous particular party speech interactions with a same function prior device receiving module 390 receiving adaptation data (e.g., a probabilistic word model based on that particular user and the target device to which the user is interacting) that is at least partly based on previous adaptation data (e.g., a previous probabilistic word model based on that particular user and a previous device with which the user is interacting) derived at least in part from one or more previous speech interactions of the particular party with at least one prior device (e.g., a handheld GPS navigation system) configured to perform a same function as the target device (e.g., an in-vehicle navigation system).

Referring again to FIG. 8I, operation 890 may include operation 892 depicting receiving adaptation data that is at least partly based on previous adaptation data derived at least in part from one or more previous speech interactions of the particular party with at least one ticket dispensing device that performs a same ticket dispensing function as the target device, said target device comprising a ticket dispensing device. For example, FIG. 3 shows adaptation data partly based on previous adaptation data derived from one or more previous particular party speech interactions with a ticket dispenser receiving module 392 receiving adaptation data (e.g., an expected response-based algorithm) that is at least partly based on previous adaptation data (e.g., a previous expected response-based algorithm) derived at least in part from one or more previous speech interactions of the particular party (e.g., the user) with at least one ticket dispensing device (e.g., a movie ticket dispensing device) that performs a same ticket dispensing function as the target device (e.g., an airplane ticket dispensing device), said target device comprising a ticket dispensing device (e.g., an airplane ticket dispensing device).

Referring now to FIG. 8J, operation 888 may include operation 894 depicting receiving adaptation data that is at least partly based on previous adaptation data derived at least in part from one or more previous speech interactions of the particular party with at least one device configured to provide a same service as the target device. For example, FIG. 3 shows adaptation data partly based on previous adaptation data derived from one or more previous particular party speech interactions with a prior device providing a same service receiving module 394 receiving adaptation data (e.g., a best-model selection algorithm) that is at least partly based on previous adaptation data (e.g., a previous best model selection algorithm) derived at least in part from one or more previous speech interactions of the particular party (e.g., the user) with at least one device (e.g., an automated insurance claim response system) configured to provide a same service (e.g., automated claim response) as the target device (e.g., a different automated insurance claim response system).

Referring again to FIG. 8J, operation 894 may include operation 896 depicting receiving adaptation data that is at least partly based on previous adaptation data derived at least in part from one or more previous speech interactions of the particular party with at least one media player configured to play one or more types of media, wherein the target device also comprises a media player. For example, FIG. 3 shows adaptation data partly based on previous adaptation data derived from one or more previous particular party speech interactions with a media player receiving module 396 receiving adaptation data (e.g., a word conversion hypothesizer) that is at least partly based on previous adaptation data (e.g., a previous word conversion hypothesizer) derived at least in part from one or more previous speech interactions of the particular party (e.g., the user) with at least one media player (e.g., a Blu-ray player) configured to play one or more types of media (e.g., Blu-rays, and movies on USB drives), wherein the target device (e.g., a portable MP3 player that is voice-controllable) also comprises a media player (e.g., the portable MP3 player).

Referring now to FIG. 8K, operation 888 may include operation 898 depicting receiving adaptation data that is at least partly based on previous adaptation data derived at least in part from one or more previous speech interactions of the particular party with at least one prior device sold by a same entity as the target device. For example, FIG. 3 shows adaptation data partly based on previous adaptation data derived from one or more previous particular party speech interactions with a prior device sold by a same entity as the target device receiving module 398 receiving adaptation data (e.g., a continuous word recognition module) that is at least partly based on previous adaptation data (e.g., a previous continuous word recognition module) derived at least in part from one or more previous speech interactions of the particular party (e.g., the user) with at least one prior device (e.g., a Samsung television) sold by a same entity (e.g., Samsung) as the target device (e.g., a Samsung DVD player).

Referring again to FIG. 8K, operation 898 may include operation 801 depicting receiving adaptation data that is at least partly based on previous adaptation data derived at least in part from one or more previous speech interactions of the particular party with at least one prior device sold by a same retailer as the target device. For example, FIG. 3 shows adaptation data partly based on previous adaptation data derived from one or more previous particular party speech interactions with a prior device sold by a same retailer as the target device receiving module 301 receiving adaptation data (e.g., one or more example accuracy rates of various speech models previously used, so that a system can pick one that it desires based on accuracy rates and projected type of usage) that is at least partly based on previous adaptation data (e.g., a previous example accuracy rate) derived at least in part from one or more previous speech interactions of the particular party (e.g., the user) with at least one prior device (e.g., a Sony television with speech recognition) sold by a same retailer (e.g., “Best Buy”) as the target device (e.g., a voice-activated radio/toaster).

Referring now to FIG. 8L, operation 886 may include operation 803 depicting receiving adaptation data that is at least partly based on previous adaptation data derived at least in part from one or more previous speech interactions of the particular party with at least one prior device that shares at least one vocabulary word with the target device. For example, FIG. 3 shows adaptation data partly based on previous adaptation data derived from one or more previous particular party speech interactions with a prior device sharing at least one vocabulary word receiving module 303 receiving adaptation data (e.g., data including one or more of locations, login information, credential information, screens for displaying, software needed to obtain adaptation data, a list of hardware compatible with the adaptation data, etc.) that is at least partly based on previous adaptation data (e.g., a previous version of adaptation data, which may be the same or a subset of the adaptation data) derived at least in part from one or more previous speech interactions of the particular party (e.g., the user) with at least one prior device (e.g., a motor vehicle control system) that shares at least one vocabulary word (e.g., “play music”) with the target device (e.g., a voice-controlled Blu-ray player).

Referring again to FIG. 8L, operation 886 may include operation 805 depicting receiving adaptation data that is at least partly based on previous adaptation data derived at least in part from one or more previous speech interactions of the particular party with at least one prior device that has a larger vocabulary than the target device. For example, FIG. 3 shows adaptation data partly based on previous adaptation data derived from one or more previous particular party speech interactions with a larger vocabulary prior device receiving module 305 receiving adaptation data (e.g., a word acceptance algorithm tailored to the particular party, e.g., the user) that is at least partly based on previous adaptation data (e.g., a previous word acceptance algorithm) derived at least in part from one or more previous speech interactions of the particular party (e.g., the user) with at least one prior device (e.g., a motor vehicle control system) that has a larger vocabulary (e.g., the motor vehicle control system has “volume control” and “play” and “stop,” as well as “move seat forward,” and “adjust passenger side mirror”) than the target device (e.g., a media player, whose vocabulary may include the media playing terms, e.g., volume control, but not the other terms from the motor vehicle control system vocabulary).

Referring now to FIG. 8M, operation 604 may include operation 807 depicting receiving adaptation data correlated to the particular party, said receiving facilitated by a particular device associated with the particular party, wherein the adaptation data is at least partly based on one or more speech interactions of the particular party. For example, FIG. 3 shows particular party-correlated speech interaction based adaptation data from particular party associated particular device receiving module 307 receiving adaptation data (e.g., a probabilistic word model based on the particular user) correlated to the particular party (e.g., the user), said receiving facilitated by a particular device (e.g., a smartphone) associated with the particular party (e.g., the user's smartphone), wherein the adaptation data (e.g., the probabilistic word model) is at least partly based on one or more speech interactions of the particular party (e.g., the smartphone picks up all the words the user says in the course of its speech interactions, and the words that are recognized over a particular confidence level are stored as having been spoken, and a probabilistic word model is generated and updated based on the frequency of detected words).

Referring again to FIG. 8M, operation 604 may include operation 809 depicting receiving adaptation data correlated to the particular party, said receiving facilitated by a particular device associated with the particular party, wherein the adaptation data is at least partly based on one or more particular previous speech interactions of the particular party selected because of their similarity with one or more expected future speech interactions. For example, FIG. 3 shows particular party-correlated speech interaction based adaptation data selected based on previous speech interaction similarity with expected future speech interaction particular device receiving module 309 receiving adaptation data (e.g., an expected response-based algorithm) correlated to the particular party, said receiving facilitated by a particular device (e.g., a computer or server connected to a network and networked with a device carried by the particular party) associated with the particular party (e.g., the user), wherein the adaptation data is at least partly based on one or more particular previous speech interactions of the particular party (e.g., interactions that were recorded and stored on the computer) selected because of their similarity with one or more expected future speech interactions (e.g., it is determined, either through explicit input or computational inference, that the user is at an airline ticket counter, so speech interactions involving airline ticket transactions or speech interactions with people involving airplanes may be selected based on the expectation that a future speech interaction will be an airline ticket counter interaction).

Referring again to FIG. 8M, operation 809 may include operation 811 depicting receiving adaptation data correlated to the particular party, said receiving facilitated by a particular device associated with the particular party, wherein the adaptation data is at least partly based on one or more particular previous speech interactions of the particular party selected because of at least one specific vocabulary word used in said particular one or more previous speech interactions. For example, FIG. 3 shows particular party-correlated speech interaction based adaptation data selected based on use of specific vocabulary word particular device receiving module 311 receiving adaptation data (e.g., a best-model selection algorithm) correlated to the particular party (e.g., the user), said receiving facilitated by a particular device (e.g., a smartkey (e.g., a key that can store, transmit, and receive data) for a motor vehicle) associated with the particular party (e.g., the smartkey unlocks a motor vehicle owned by the user), wherein the adaptation data is at least partly based on one or more particular previous speech interactions of the particular party (e.g., interactions with other motor vehicle control systems) selected because of at least one specific vocabulary word (e.g., “seat position”) used in said particular one or more previous speech interactions (e.g., the user's previous speech interactions with this or other motor vehicles).

Referring again to FIG. 8M, operation 809 may include operation 813 depicting receiving adaptation data correlated to the particular party from a device configured to receive speech that is associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech receiving particular device receiving module 313 receiving adaptation data (e.g., a word conversion hypothesizer) correlated to the particular party (e.g., the user) from a device configured to receive speech (e.g., a tablet with a microphone) that is associated with the particular party (e.g., owned or carried by the user), wherein the adaptation data is at least partly based on previous adaptation data (e.g., a previous word conversion hypothesizer) derived at least in part from one or more previous speech interactions (e.g., previous Skype-like video conference calls using the tablet in which words are recognized by the particular device) of the particular party (e.g., the user).

Referring again to FIG. 8M, operation 813 may include operation 815 depicting receiving adaptation data correlated to the particular party from a smartphone device configured to receive speech that is associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech receiving smartphone receiving module 315 receiving adaptation data (e.g., a continuous word recognition module) correlated to the particular party (e.g., the user) from a smartphone device (e.g., a BlackBerry 8800) configured to receive speech (e.g., is capable of receiving speech, recording speech, and making phone calls) that is associated with the particular party (e.g., carried by the particular party, or licensed to the particular party in an enterprise setting), wherein the adaptation data (e.g., the continuous word recognition module) is at least partly based on previous adaptation data (e.g., a previous continuous word recognition module) derived at least in part from one or more previous speech interactions (e.g., phone calls in which the smartphone recognizes one or more of the words spoken by the user during the conversation) of the particular party).

Referring now to FIG. 8N, operation 813 may include operation 817 depicting receiving adaptation data correlated to the particular party from a device including speech transmission software to receive speech that is associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech receiving particular device having speech transmission software receiving module 317 receiving adaptation data (e.g., a pronunciation model) correlated to the particular party (e.g., the user) from a device including speech transmission software (e.g., a tablet with a microphone and with a videoconferencing software, e.g., Skype, loaded) to receive speech that is associated with the particular party (e.g., the particular party speaks into the device to transmit speech), wherein the adaptation data is at least partly based on previous adaptation data (e.g., a previous pronunciation model) derived at least in part from one or more previous speech interactions (e.g., Skype calls using the device) of the particular party (e.g., the user).

Referring again to FIG. 8N, operation 817 may include operation 819 depicting receiving adaptation data correlated to the particular party from a tablet device configured to receive speech associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech receiving tablet receiving module 319 receiving adaptation data (e.g., example accuracy rates of various speech models previously used) correlated to the particular party from a tablet device (e.g., an iPad) configured to receive speech (e.g., has a microphone) associated with the particular party (e.g., from the user), wherein the adaptation data is at least partly based on previous adaptation data (e.g., example accuracy rates of various speech models used before, but less recently) derived at least in part from one or more previous speech interactions (e.g., interactions that are picked up by the microphone of the tablet such that words can be identified, including, but not limited to, voice interactions with the tablet, e.g., via Apple's voice recognition systems) of the particular party (e.g., the user).

Referring again to FIG. 8N, operation 817 may include operation 821 depicting receiving adaptation data correlated to the particular party from a navigation device configured to receive speech associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech receiving navigation device receiving module 321 receiving adaptation data (e.g., a word acceptance algorithm) correlated to the particular party (e.g., the user) from a navigation device (e.g., an onboard motor vehicle navigation device, or a handheld navigation device used in a car, or a smartphone, tablet, or computer, loaded with navigation software) configured to receive speech associated with the particular party (e.g., the user interacts with the navigation device by speaking to it), wherein the adaptation data (e.g., the word acceptance algorithm) is at least partly based on previous adaptation data (e.g., a previous version of the word acceptance algorithm) derived at least in part from one or more previous speech interactions of the particular party (e.g., previous interactions with the navigation device).

Referring again to FIG. 8N, operation 604 may include operation 823 depicting receiving adaptation data correlated to the particular party from a device configured to detect speech that is associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech detecting particular device receiving module 323 receiving adaptation data (e.g., a probabilistic word model based on that particular user) correlated to the particular party (e.g., the user) from a device configured to detect speech (e.g., has a microphone, e.g., a digital recorder) that is associated with the particular party (e.g., the user), wherein the adaptation data is at least partly based on previous adaptation data (e.g., a previous probabilistic word model) derived at least in part from one or more previous speech interactions of the particular party (e.g., the user).

Referring now to FIG. 8P (there is no FIG. 8O to avoid potential confusion with the nonexistent FIG. Eighty (80)), operation 604 may include operation 825 depicting receiving adaptation data correlated to the particular party from a device configured to record speech that is associated with the particular party, wherein the adaptation data is at least partly based on previous adaptation data derived at least in part from one or more previous speech interactions of the particular party. For example, FIG. 3 shows particular party-correlated previous speech interaction based adaptation data from particular-party speech recording particular device receiving module 325 receiving adaptation data (e.g., an expected response-based algorithm) correlated to the particular party (e.g., the user) from a device (e.g., a digital recorder) that is associated with the particular party (e.g., owned by the user), wherein the adaptation data (e.g., the expected response-based algorithm) is at least partly based on previous adaptation data (e.g., a previous expected response-based algorithm) derived at least in part from one or more previous speech interactions of the particular party (e.g., speech interactions between people and speech input-enabled machines that are recorded by the digital recorder, e.g., and which may or may not later be transmitted to a server, or may be analyzed at a later date by speech analysis software or hardware).

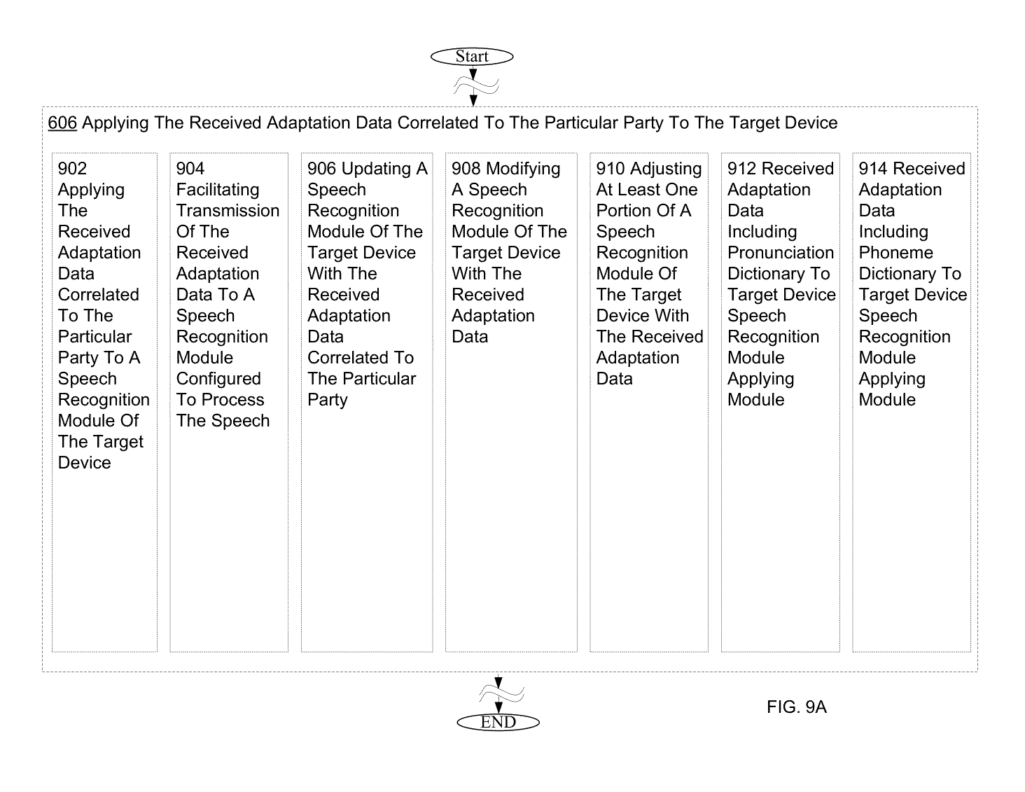

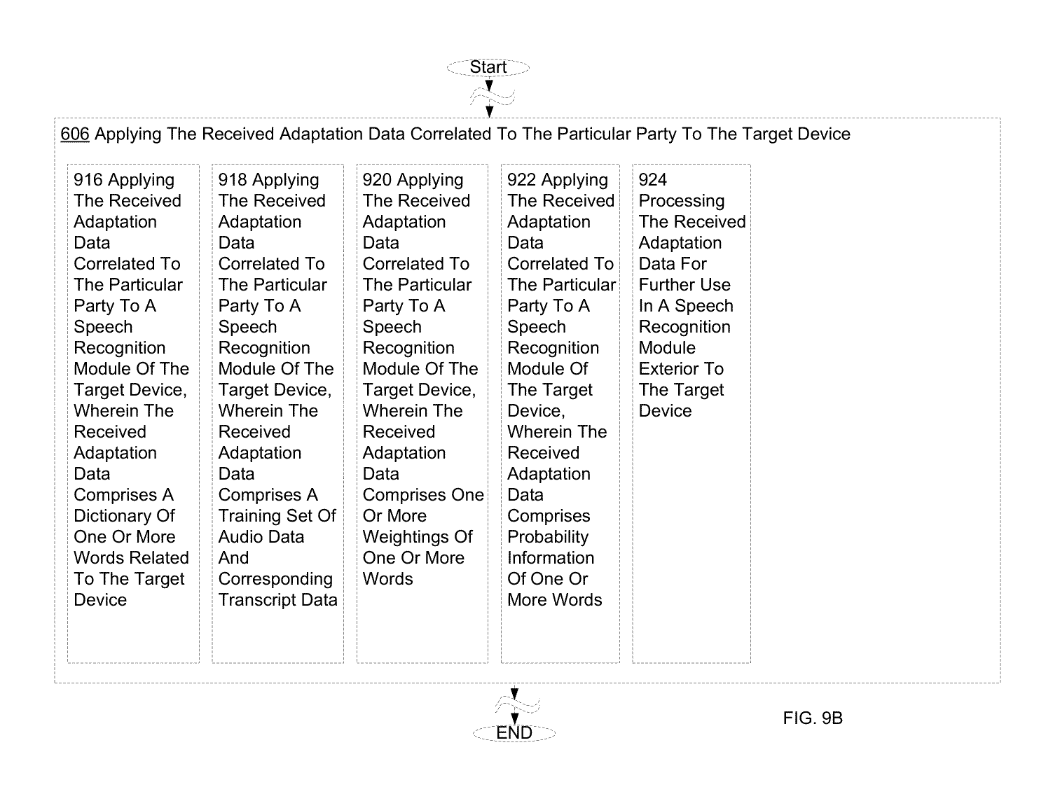

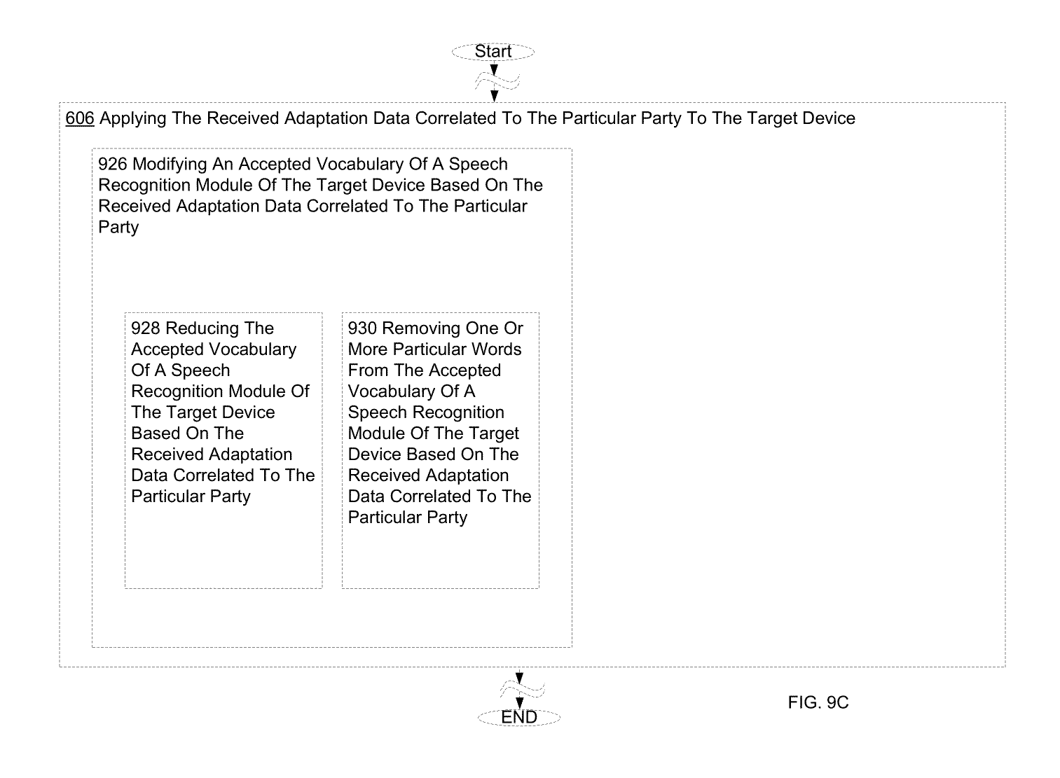

FIGS. 9A-9C depict various implementations of operation 606, according to embodiments. Referring now to FIG. 9A, operation 606 may include operation 902 depicting applying the received adaptation data correlated to the particular party to a speech recognition module of the target device. For example, FIG. 4 shows received adaptation data to speech recognition module of target device applying module 402 applying the received adaptation data (e.g., an expected response-based algorithm) correlated to the particular party (e.g., the user) to a speech recognition module (e.g., a portion of the target device, either hardware or software, that facilitates the processing of speech, e.g., software that performs filler filtering, or software that calculates or determines recognition rate, confidence rate, error rate, or any combination thereof) of the target device (e.g., an automated teller machine).

Referring again to FIG. 9A, operation 606 may include operation 904 depicting facilitating transmission of the received adaptation data to a speech recognition module configured to process the speech. For example, FIG. 4 shows transmission of received adaptation data to speech recognition module configured to process speech facilitating module 404 facilitating transmission (e.g., transmitting, or performing some action which assists in eventual transmitting or attempting to transmit) of the received adaptation data (e.g., a continuous word recognition module) to a speech recognition module (e.g., programmable hardware module of an airline ticket counter terminal) configured to process the speech (e.g., perform one or more steps related to the conversion of speech data into data comprehensible to a processor).

Referring again to FIG. 9A, operation 606 may include operation 906 depicting updating a speech recognition module of the target device with the received adaptation data correlated to the particular party. For example, FIG. 4 shows received adaptation data to target device speech recognition module updating module 406 updating (e.g., determining if changes need to be applied, and if so, applying them, or initializing if no original is found) a speech recognition module (e.g., software for processing speech) of the target device (e.g., a navigation system) with the received adaptation data (e.g., instructions for an adaptation control algorithm) correlated to the particular party (e.g., the user).

Referring again to FIG. 9A, operation 606 may include operation 908 depicting modifying a speech recognition module of the target device with the received adaptation data. For example, FIG. 4 shows received adaptation data to target device speech recognition module modifying module 408 modifying a speech recognition module (e.g., changing at least one portion of an algorithm used by the speech recognition module software routine) of the target device (e.g., a voice-commanded computer) with the received adaptation data (e.g., a phoneme pronunciation guide).

Referring again to FIG. 9A, operation 606 may include operation 910 depicting adjusting at least one portion of a speech recognition module of the target device with the received adaptation data. For example, FIG. 4 shows received adaptation data to target device speech recognition module adjusting module 410 adjusting at least one portion of a speech recognition module (e.g., changing at least one setting of a speech recognition module, e.g., an upper limit number used in at least one recognition algorithm) of the target device (e.g., an automated movie ticket selling machine) with the received adaptation data (e.g., a syllable pronunciation guide).

Referring again to FIG. 9A, operation 606 may include operation 912 depicting applying the received adaptation data correlated to the particular party to a speech recognition module of the target device, wherein the received adaptation data comprises a pronunciation dictionary. For example, FIG. 4 shows received adaptation data including pronunciation dictionary to target device speech recognition module applying module 412 applying the received adaptation data (e.g., a word pronunciation guide) correlated to the particular party (e.g., the user) to a speech recognition module of the target device (e.g., a computer with speech input capabilities), wherein the received adaptation data comprises a pronunciation dictionary (e.g., a word pronunciation guide).

Referring again to FIG. 9A, operation 606 may include operation 914 depicting applying the received adaptation data correlated to the particular party to a speech recognition module of the target device, wherein the received adaptation data comprises a phoneme dictionary. For example, FIG. 4 shows received adaptation data including phoneme dictionary to target device speech recognition module applying module 414 applying the received adaptation data (e.g., the phoneme dictionary) correlated to the particular party (e.g., the user) to a speech recognition module of the target device (e.g., a tablet device), wherein the received adaptation data comprises a phoneme dictionary.

Referring now to FIG. 9B, operation 606 may include operation 916 depicting applying the received adaptation data correlated to the particular party to a speech recognition module of the target device, wherein the received adaptation data comprises a dictionary of one or more words related to the target device. For example, FIG. 4 shows received adaptation data including dictionary of target device related words to target device speech recognition module applying module 416 applying the received adaptation data (e.g., a word dictionary, which was selected from a larger word dictionary based on the target device, e.g., an Automated Teller Machine) correlated to the particular party (e.g., the word dictionary is based on pronunciations by the particular party) to a speech recognition module (e.g., software residing inside the ATM) of the target device (e.g., an automated teller machine), wherein the received adaptation data comprises a dictionary of one or more words related to the target device (e.g., one or more words related to an ATM, e.g., “money”).

Referring again to FIG. 9B, operation 606 may include operation 918 depicting applying the received adaptation data correlated to the particular party to a speech recognition module of the target device, wherein the received adaptation data comprises a training set of audio data and corresponding transcript data. For example, FIG. 4 shows received adaptation data including training set of audio data and corresponding transcript data to target device applying module 418 applying the received adaptation data (e.g., training data) correlated to the particular party (e.g., the user) to a speech recognition module (e.g., the hardware and software that are used to receive speech and convert the speech into a format recognized by a processor) of the target device (e.g., a speech input accepting fountain drink ordering machine), wherein the received adaptation data comprises a training set of audio data and corresponding transcript data (e.g., the adaptation data includes recordings of the user saying particular words, and a table linking the recordings of those words to the electronic representation of those words, in order to train a device regarding pronunciations by the user, either generally, or with respect to those specific words, or both).

Referring again to FIG. 9B, operation 606 may include operation 920 depicting applying the received adaptation data correlated to the particular party to a speech recognition module of the target device, wherein the received adaptation data comprises one or more weightings of one or more words. For example, FIG. 4 shows received adaptation data including one or more word weightings data to target device applying module 420 applying the received adaptation data (e.g., word weighting data) correlated to the particular party (e.g., the user) to a speech recognition module of the target device (e.g., an automated telephone call routing system), wherein the received adaptation data comprises one or more weightings of one or more words (e.g., for a credit card company hotline, the word “stolen” might get a higher weight than the words “tuna fish”).

Referring again to FIG. 9B, operation 606 may include operation 922 depicting applying the received adaptation data correlated to the particular party to a speech recognition module of the target device, wherein the received adaptation data comprises probability information of one or more words. For example, FIG. 4 shows received adaptation data including one or more words probability information to target device applying module 422 applying the received adaptation data (e.g., probability information) correlated to the particular party (e.g., the user) to a speech recognition module of the target device (e.g., a portable navigation system), wherein the received adaptation data comprises probability information of one or more words (e.g., a word includes a probability of how often that word shows up in a conversation).

Referring again to FIG. 9B, operation 606 may include operation 924 depicting processing the received adaptation data for further use in a speech recognition module exterior to the target device. For example, FIG. 4 shows received adaptation data processing for exterior speech recognition module usage processing module 424 processing the received adaptation data (e.g., a phoneme pronunciation guide) for further use in a speech recognition module (e.g., a device that acts as an intermediary speech processing device, or speech transmitting or relaying device, with processing not required) exterior to the target device (e.g., the speech recognition module might be inside a device carried by the user, and the target device may be one or more terminals that the user wants to interact with).

Referring now to FIG. 9C, operation 606 may include operation 926 depicting modifying an accepted vocabulary of a speech recognition module of the target device based on the received adaptation data correlated to the particular party. For example, FIG. 4 shows accepted vocabulary of speech recognition module of target device modifying module 426 modifying an accepted vocabulary (e.g., changing or adding to the words that are recognized) of a speech recognition module of the target device (e.g., an airline ticket dispensing terminal) based on the received adaptation data (e.g., instructions to modify or change the vocabulary) correlated to the particular party (e.g., the user).

Referring again to FIG. 9C, operation 926 may include operation 928 depicting reducing the accepted vocabulary of a speech recognition module of the target device based on the received adaptation data correlated to the particular party. For example, FIG. 4 shows accepted vocabulary of speech recognition module of target device reducing module 428 reducing the accepted vocabulary (e.g., changing or subtracting from the words that are recognized) of a speech recognition module of the target device (e.g., a motor vehicle control system) based on the received adaptation data (e.g., a limited list of words to accept) correlated to the particular party (e.g., the user).

Referring again to FIG. 9C, operation 926 may include operation 930 depicting removing one or more particular words from the accepted vocabulary of a speech recognition module of the target device based on the received adaptation data correlated to the particular party. For example, FIG. 4 shows accepted vocabulary of speech recognition module of target device removing module 430 removing one or more particular words from the accepted vocabulary (e.g., removing a word that is not relevant or that the user does not use) of a speech recognition module of the target device (e.g., a speech-controlled DVD player) based on the received adaptation data correlated to the particular party (e.g., the user).

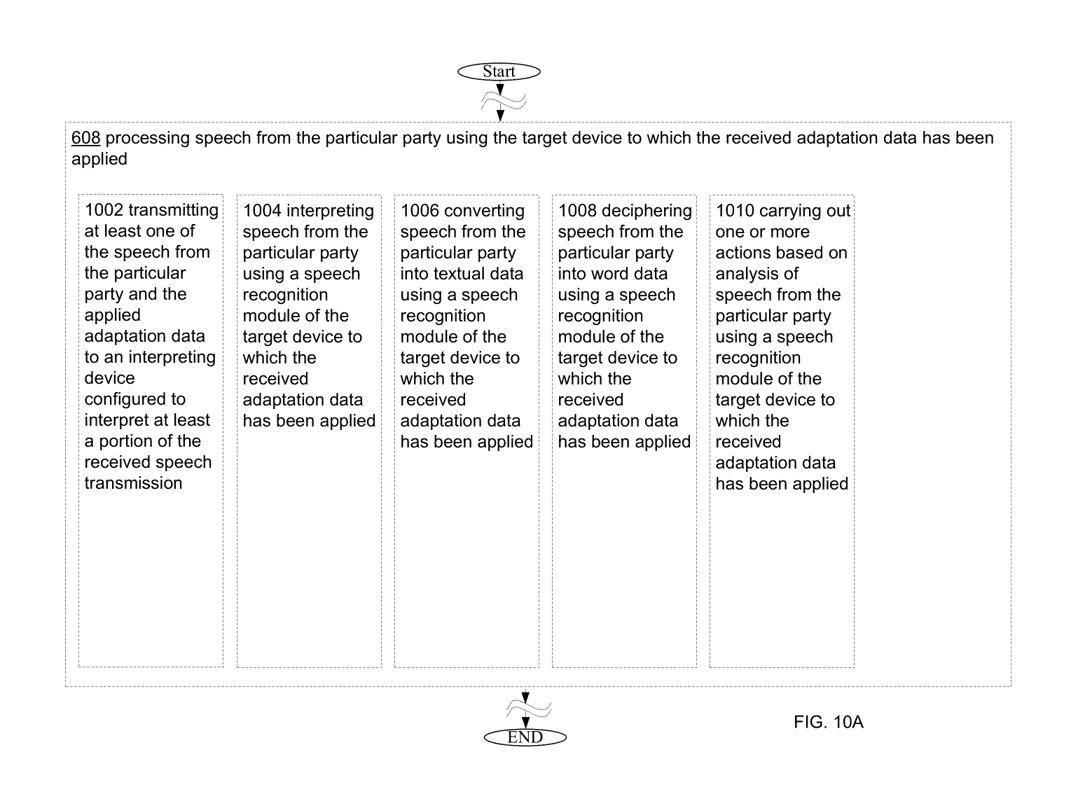

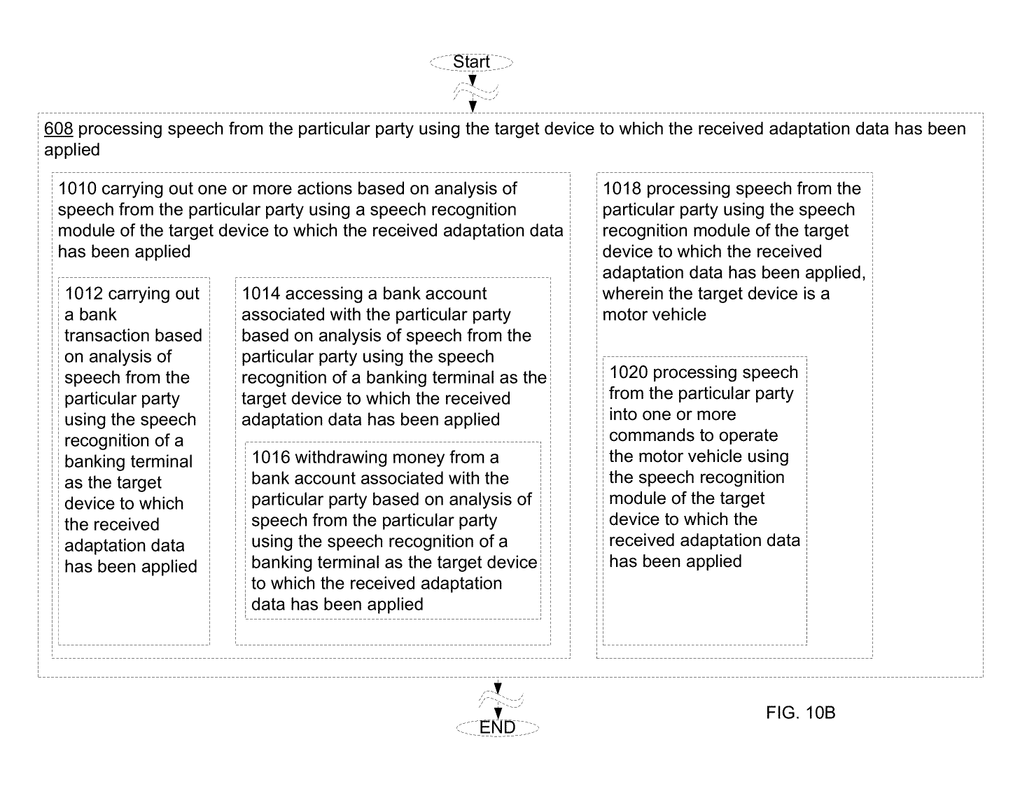

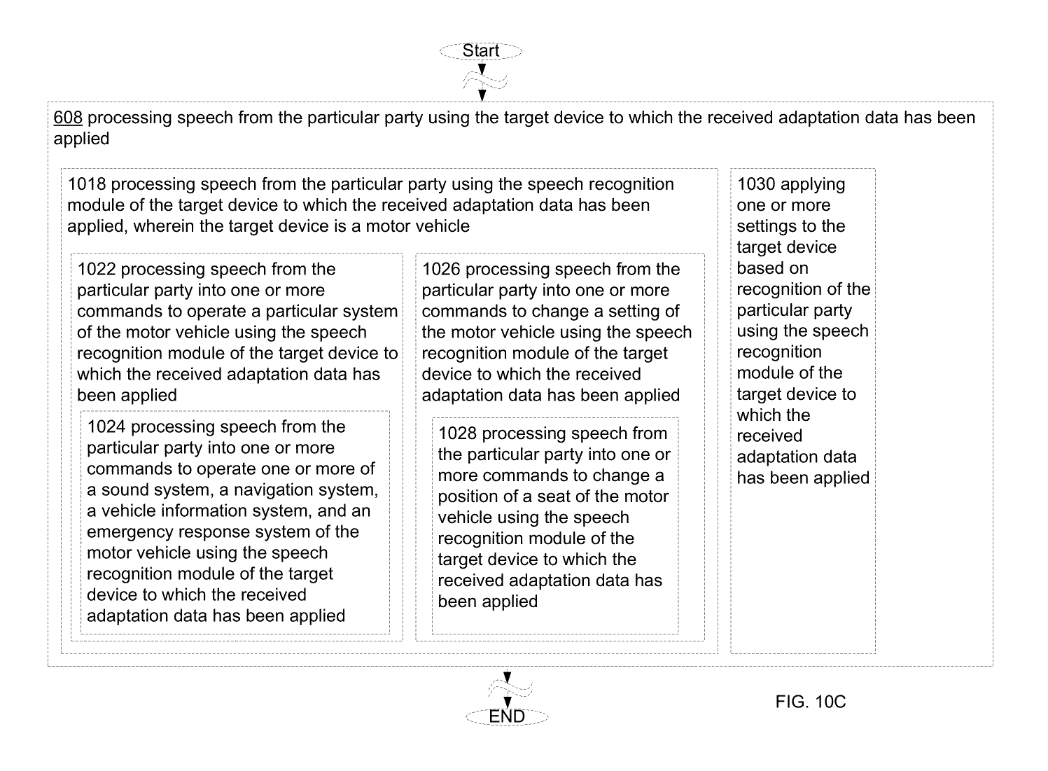

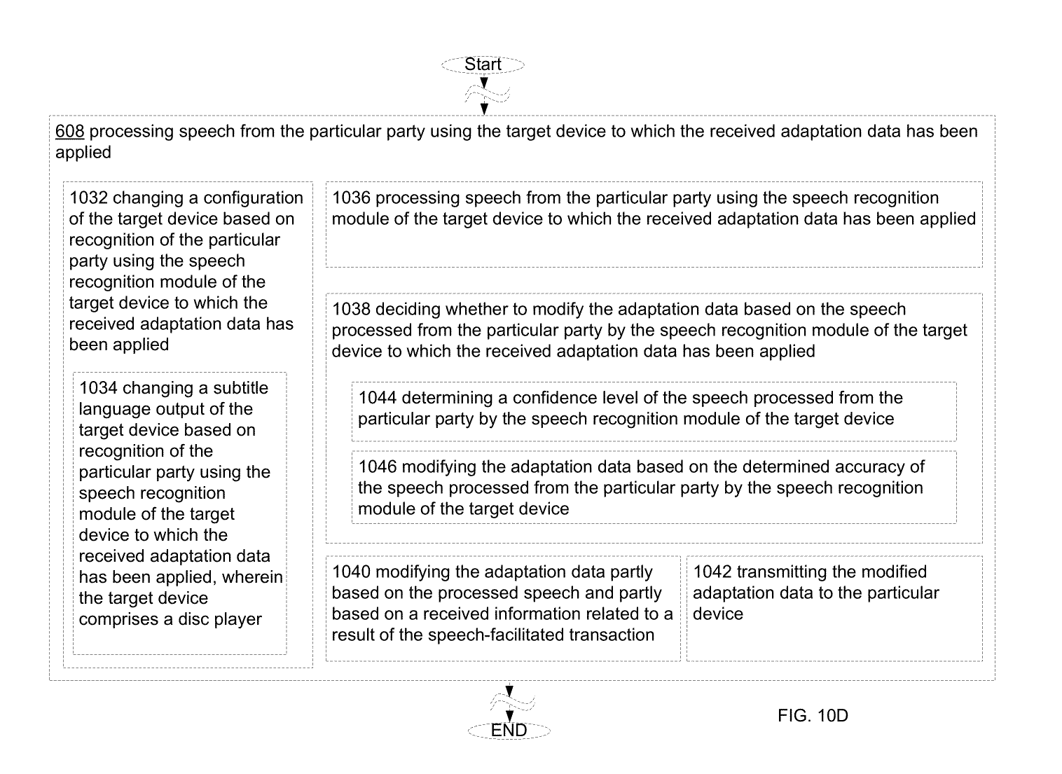

FIGS. 10A-10C depict various implementations of operation 608, according to embodiments. Referring to FIG. 10A, operation 608 may include operation 1002 depicting transmitting at least one of the speech from the particular party and the applied adaptation data to an interpreting device configured to interpret at least a portion of the received speech transmission. For example, FIG. 5 shows at least one of speech and applied adaptation data transmitting to interpreting device configured to interpret at least a portion of speech module 502 transmitting at least one of the speech from the particular party and the applied adaptation data (e.g., one or more elements, e.g., a vocabulary, or an algorithm parameter, or a selection criterion, or the entire module configured to process speech) to an interpreting device (e.g., a device configured to process the speech, e.g., the end terminal, e.g., the ATM machine, which receives the applied adaptation data and/or the speech from an intermediate, e.g., a device carried by the user) configured to interpret at least a portion of the received speech transmission.

Referring again to FIG. 10A, operation 608 may include operation 1004 depicting interpreting speech from the particular party using a speech recognition module of the target device to which the received adaptation data has been applied. For example, FIG. 5 shows speech recognition module of target device particular party speech interpreting using received adaptation data module 504 interpreting speech (e.g., converting speech into a format recognizable by a processor) from the particular party (e.g., the user) using a speech recognition module (e.g., hardware or software, or both) of the target device (e.g., a speech-commandable security system) to which the received adaptation data (e.g., a word confidence factor lookup table, (e.g., a lookup table for the confidence factor required to accept recognition of a particular word)) has been applied.

Referring again to FIG. 10A, operation 608 may include operation 1006 depicting converting speech from the particular party into textual data using a speech recognition module of the target device to which the received adaptation data has been applied. For example, FIG. 5 shows speech recognition module of target device particular party speech converting into textual data using received adaptation data module 506 converting speech from the particular party (e.g., the user) into textual data (e.g., text data, e.g., data in a text format, e.g., that can appear in a program) using a speech recognition module (e.g., software) of the target device (e.g., a speech input enabled computer) to which the received adaptation data (e.g., pronunciations of words commonly mispronounced or pronounced strangely by the user) has been applied.

Referring again to FIG. 10A, operation 608 may include operation 1008 depicting deciphering speech from the particular party into word data using a speech recognition module of the target device to which the received adaptation data has been applied. For example, FIG. 5 shows speech recognition module of target device particular party speech deciphering into word data using received adaptation data module 508 deciphering speech from the particular party (e.g., the user) into word data (e.g., words appearing on the screen) using a speech recognition module of the target device (e.g., a dictation machine that converts speech into a text document) to which the received adaptation data (e.g., a discourse marker ignoring algorithm) has been applied.

Referring now to FIG. 10B, operation 608 may include operation 1010 depicting carrying out one or more actions based on analysis of speech from the particular party using a speech recognition module of the target device to which the received adaptation data has been applied. For example, FIG. 5 shows speech analysis based action carrying out by target device particular party speech processing using received adaptation data module 510 carrying out one or more actions (e.g., “move seat backwards) based on analysis of speech from the particular party (e.g., the driver of a motor vehicle) using a speech recognition module of the target device (e.g., a motor vehicle) to which the received adaptation data (e.g., a best-model selection algorithm) has been applied.

Referring again to FIG. 10B, operation 1010 may include operation 1012 depicting carrying out a bank transaction based on analysis of speech from the particular party using the speech recognition module of a banking terminal as the target device to which the received adaptation data has been applied. For example, FIG. 5 shows speech analysis based bank transaction carrying out by banking terminal target device using received adaptation data module 512 carrying out a bank transaction (e.g., withdrawing 300 dollars from a checking account) based on analysis of speech from the particular party (e.g., the user, e.g., the account holder) using the speech recognition module of a banking terminal as the target device to which the received adaptation data (e.g., a word conversion hypothesizer) has been applied.

Referring again to FIG. 10B, operation 1010 may include operation 1014 depicting accessing a bank account associated with the particular party based on analysis of speech from the particular party using the speech recognition module of a banking terminal as the target device to which the received adaptation data has been applied. For example, FIG. 5 shows speech analysis based bank account accessing by banking terminal target device using received adaptation data module 514 accessing a bank account (e.g., checking the balance of a savings account) associated with the particular party (e.g., a user's savings account) using the speech recognition module of a banking terminal as the target device to which the received adaptation data (e.g., a continuous word recognition module) has been applied.

Referring again to FIG. 10B, operation 1014 may include operation 1016 depicting withdrawing money from a bank account associated with the particular party based on analysis of speech from the particular party using the speech recognition module of a banking terminal as the target device to which the received adaptation data has been applied. For example, FIG. 5 shows speech analysis based bank account money withdrawal by banking terminal target device using received adaptation data module 516 withdrawing money from a bank account associated with the particular party (e.g., the user) based on analysis of speech from the particular party (e.g., “withdraw 300 dollars from my account”) using the speech recognition module of a banking terminal as the target device to which the received adaptation data has been applied.

Referring again to FIG. 10B, operation 608 may include operation 1018 depicting processing speech from the particular party using the speech recognition module of the target device to which the received adaptation data has been applied, wherein the target device is a motor vehicle. For example, FIG. 5 shows motor vehicle particular party speech processing using received adaptation data module 518 processing speech from the particular party (e.g., the user) using the speech recognition module of the target device (e.g., the user's motor vehicle) to which the received adaptation data (e.g., instructions for an adaptation control algorithm) has been applied, wherein the target device is a motor vehicle (e.g., a car equipped with speech recognition).

Referring again to FIG. 10B, operation 1018 may include operation 1020 depicting processing speech from the particular party into one or more commands to operate the motor vehicle using the speech recognition module of the target device to which the received adaptation data has been applied. For example, FIG. 5 shows motor vehicle particular party speech processing into motor vehicle operation command using received adaptation data module 520 processing speech from the particular party into one or more commands to operate the motor vehicle (e.g., “start engine,” “apply emergency brake”) using the speech recognition module of the target device to which the received adaptation data (e.g., a phoneme pronunciation guide) has been applied.

Referring now to FIG. 10C, operation 1018 may include operation 1022 depicting processing speech from the particular party into one or more commands to operate a particular system of the motor vehicle using the speech recognition module of the target device to which the received adaptation data has been applied. For example, FIG. 5 shows motor vehicle particular party speech processing into motor vehicle particular system operation command using received adaptation data module 522 processing speech from the particular party (e.g., the user) into one or more commands to operate a particular system (e.g., the sound system) of the motor vehicle using the speech recognition module of the target device (e.g., the motor vehicle) to which the received adaptation data has been applied.

Referring again to FIG. 10C, operation 1022 may include operation 1024 depicting processing speech from the particular party into one or more commands to operate one or more of a sound system, a navigation system, a vehicle information system, and an emergency response system of the motor vehicle using the speech recognition module of the target device to which the received adaptation data has been applied. For example, FIG. 5 shows motor vehicle particular party speech processing into one or more motor vehicle systems including sound, navigation, information, and emergency response operation command using received adaptation data module 524 processing speech from the particular party (e.g., the user) into one or more commands (e.g., “tell me how much air is in my front right tire”) to operate one or more of a sound system, a navigation system, a vehicle information system, and an emergency response system of the motor vehicle using the speech recognition module of the target device (e.g., the motor vehicle) to which the received adaptation data (e.g., a syllable pronunciation guide) has been applied.

Referring again to FIG. 10C, operation 1018 may include operation 1026 depicting processing speech from the particular party into one or more commands to change a setting of the motor vehicle using the speech recognition module of the target device to which the received adaptation data has been applied. For example, FIG. 5 shows motor vehicle particular party speech processing into motor vehicle setting change command using received adaptation data module 526 processing speech from the particular party (e.g., the user) into one or more commands to change a setting of the motor vehicle (e.g., “set temperature to 68 degrees,” “adjust driver side mirror clockwise and up”) using the speech recognition module of the target device to which the received adaptation data (e.g., a word pronunciation guide) has been applied.

Referring again to FIG. 10C, operation 1026 may include operation 1028 depicting processing speech from the particular party into one or more commands to change a position of a seat of the motor vehicle using the speech recognition module of the target device to which the received adaptation data has been applied. For example, FIG. 5 shows motor vehicle particular party speech processing into motor vehicle seat position change command using received adaptation data module 528 processing speech from the particular party (e.g., the user) into one or more commands to change a position of a seat of the motor vehicle using the speech recognition module of the target device to which the received adaptation data party (e.g., a guide of the pronunciation keys for at least one word) has been applied.

Referring again to FIG. 10C, operation 608 may include operation 1030 depicting applying one or more settings to the target device based on recognition of the particular party using the speech recognition module of the target device to which the received adaptation data has been applied. For example, FIG. 5 shows target device setting based on recognition of particular party using speech recognition module of target device applying using received adaptation data module 530 applying one or more settings (e.g., a position of seat and mirrors and ambient temperature) to the target device (e.g., the motor vehicle) based on recognition of the particular party (e.g., recognizing a passphrase spoken by the particular user) using the speech recognition module of the target device (e.g., a motor vehicle) to which the received adaptation data (e.g., a phoneme pronunciation guide) has been applied.

Referring now to FIG. 10D, operation 608 may include operation 1032 depicting changing a configuration of the target device based on recognition of the particular party using the speech recognition module of the target device to which the received adaptation data has been applied. For example, FIG. 5 shows target device configuration changing based on recognition of particular party using speech recognition module of target device module 532 changing a configuration (e.g., changing which programs are loaded, or modifying access levels to particular network drives) of the target device (e.g., a computer in an enterprise setting) based on recognition of the particular party (e.g., recognizing a passphrase, e.g., in conjunction with another identifier, e.g., a login or a token) using the speech recognition module of the target device to which the received adaptation data (e.g., a word confidence factor lookup table) has been applied.

Referring again to FIG. 10D, operation 1032 may include operation 1034 depicting changing a subtitle language output of the target device based on recognition of the particular party using the speech recognition module of the target device to which the received adaptation data has been applied, wherein the target device comprises a disc player. For example, FIG. 5 shows disc player subtitle language output changing based on recognition of particular party using speech recognition module of target device module 534 changing a subtitle language output (e.g., from Japanese to Spanish) of the target device (e.g., a Blu-Ray player) based on recognition of the particular party using the speech recognition module of the target device (e.g., a speech-enabled Blu-Ray player) to which the received adaptation data has been applied, wherein the target device comprises a disc player.

Referring again to FIG. 10D, operation 608 may include operation 1036 depicting processing speech from the particular party using the speech recognition module of the target device to which the received adaptation data has been applied. For example, FIG. 5 shows target device speech recognition module particular party speech processing using received adaptation data module 536 processing speech from the particular party (e.g., the user) using the speech recognition module of the target device (e.g., the portable navigation system) to which the received adaptation data (e.g., a speech deviation algorithm for words often said in stressful conditions) has been applied.

Referring again to FIG. 10D, operation 608 may include operation 1038 depicting deciding whether to modify the adaptation data based on the speech processed from the particular party by the speech recognition module of the target device to which the received adaptation data has been applied. For example, FIG. 5 shows adaptation data modification based on processed speech from particular party deciding module 538 deciding whether to modify the adaptation data (e.g., deciding whether to change the speech deviation algorithm) based on the speech processed from the particular party by the speech recognition module of the target device (e.g., the portable navigation system) to which the received adaptation data has been applied.

Referring again to FIG. 10D, in some embodiments in which operation 608 includes operations 1036 and 1038, operation 608 may further include operation 1040 depicting modifying the adaptation data partly based on the processed speech and partly based on a received information related to a result of the speech-facilitated transaction. For example, FIG. 5 shows adaptation data modifying partly based on processed speech and partly based on received information module 540 modifying the adaptation data (e.g., the speech deviation algorithm) partly based on the processed speech and partly based on a received information related to a result of the speech-facilitated transaction (e.g., a user score rating the transaction).

Referring again to FIG. 10D, in some embodiments in which operation 608 includes operations 1036 and 1038, operation 608, which may, in some embodiments, also include operation 1040 may further include operation 1042 depicting transmitting the modified adaptation data to the particular device. For example, FIG. 5 shows modified adaptation data transmitting to particular device module 542 transmitting the modified adaptation data (e.g., an updated version of the speech deviation algorithm) to the particular device (e.g., a smartphone).

Referring again to FIG. 10D, operation 1036 may further include operation 1044 depicting determining a confidence level of the speech processed from the particular party by the speech recognition module of the target device. For example, FIG. 5 shows particular party processed speech confidence level determining module 544 determining a confidence level (e.g., a numeric representation of how accurate the conversion from the speech data is estimated to be) of the speech processed from the particular party by the speech recognition module of the target device (e.g., an Automated Teller Machine).

Referring again to FIG. 10D, operation 1036 may further include operation 1046 depicting modifying the adaptation data based on the determined confidence level of the speech processed from the particular party by the speech recognition module of the target device. For example, FIG. 5 shows adaptation data modifying based on determined confidence level of processed speech module 546 modifying the adaptation data (e.g., a pronunciation guide) based on the determined confidence level of the speech processed from the particular party by the speech recognition module of the target device (e.g., if the confidence level of words is too low, then modifying the pronunciation guide).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. In addition, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1-231. (canceled)

232. A system, comprising:
a speech-facilitated transaction initiation between particular party and target device indicator receiving module configured to receive indication of initiation of a speech-facilitated transaction between a particular party and a target device;
a particular party-correlated previous speech interaction based adaptation data from particular-party associated particular device receiving module configured to receive adaptation data correlated to the particular party, said receiving facilitated by a particular device associated with the particular party, wherein the adaptation data is at least partly based on previous adaptation data derived at least in part from one or more previous speech interactions of the particular party;
a received adaptation data to target device applying module configured to apply the received adaptation data correlated to the particular party to the target device; and
a target device particular party speech processing using received adaptation data module configured to process speech from the particular party using the target device to which the received adaptation data has been applied.

233. The system of claim 232, wherein said speech-facilitated transaction initiation between particular party and target device indicator receiving module comprises:
a speech-facilitated and partly using speech transaction initiation between particular party and target device indicator receiving module configured to receive indication of initiation of a transaction in which the particular party interacts with the target device at least partly using speech.

234. (canceled)

235. (canceled)

236. (canceled)

237. (canceled)

238. The system of claim 232, wherein said speech-facilitated transaction initiation between particular party and target device indicator receiving module comprises:
a particular party intention to conduct target device speech-facilitated transaction indicator receiving module configured to receive indication of a property of a particular party indicating intent to conduct a speech-facilitated transaction with the target device.

239. (canceled)

240. (canceled)

241. The system of claim 238, wherein said particular party intention to conduct target device speech-facilitated transaction indicator receiving module comprises:
a particular party and target device particular proximity and particular condition indication receiving module.

242. (canceled)

243. (canceled)

244. (canceled)

245. (canceled)

246. (canceled)

247. (canceled)

248. (canceled)

249. (canceled)

250. The system of claim 232, wherein said particular party-correlated previous speech interaction based adaptation data from particular-party associated particular device receiving module comprises:
a particular party-correlated previous speech interaction based instructions for adapting one or more speech recognition modules from particular-party associated particular device receiving module.

251. The system of claim 232, wherein said particular party-correlated previous speech interaction based adaptation data from particular-party associated particular device receiving module comprises:
a particular party-correlated previous speech interaction based instructions for updating one or more speech recognition modules from particular-party associated particular device receiving module.

252. (canceled)

253. (canceled)

254. (canceled)

255. The system of claim 232, wherein said particular party-correlated previous speech interaction based adaptation data from particular-party associated particular device receiving module comprises:
a particular party-correlated audibly distinguishable sound linking to concept adaptation data from particular-party associated particular device receiving module configured to receive data comprising a location at which adaptation data correlated to the particular party is available, from a particular device associated with the particular party.

256. (canceled)

257. (canceled)

258. (canceled)

259. (canceled)

260. (canceled)

261. (canceled)

262. (canceled)

263. (canceled)

264. (canceled)

265. (canceled)

266. The system of claim 232, wherein said particular party-correlated previous speech interaction based adaptation data from particular-party associated particular device receiving module comprises:
a particular party-correlated previous speech interaction based adaptation data particular device configured to store particular party data receiving module configured to receive adaptation data correlated to the particular party from a particular device configured to store data regarding the particular party, wherein the adaptation data is at least partly based on previous adaptation data derived at least in part from one or more previous speech interactions of the particular party.

267. The system of claim 266, wherein said particular party-correlated previous speech interaction based adaptation data particular device configured to store particular party data receiving module comprises:
a particular party-correlated previous speech interaction based adaptation data particular device configured to store particular party profile data receiving module.

268. The system of claim 266, wherein said particular party-correlated previous speech interaction based adaptation data particular device configured to store particular party data receiving module comprises:
a particular party-correlated previous speech interaction based adaptation data particular device configured to store particular party speech profile unrelated data receiving module configured to receive adaptation data correlated to the particular party from a particular device configured to store data unrelated to speech recognition modules regarding the particular party.

269. (canceled)

270. (canceled)

271. (canceled)

272. The system of claim 232, wherein said particular party-correlated previous speech interaction based adaptation data from particular-party associated particular device receiving module comprises:
a particular party-correlated previous other related device speech interaction based adaptation data from particular-party associated particular device receiving module, wherein the adaptation data is at least partly based on previous adaptation data derived at least in part from one or more previous speech interactions of the particular party with one or more devices related to the target device.

273. (canceled)

274. The system of claim 232, wherein said particular party-correlated previous speech interaction based adaptation data from particular-party associated particular device receiving module comprises:
a particular party-correlated previous other device having same manufacturer as target device speech interaction based adaptation data from particular-party associated particular device receiving module.

275. (canceled)

276. The system of claim 232, wherein said particular party-correlated previous speech interaction based adaptation data from particular-party associated particular device receiving module comprises:
a particular party-correlated previous other same-function configured device speech interaction based adaptation data from particular-party associated particular device receiving module, wherein the adaptation data is at least partly based on previous adaptation data derived at least in part from one or more previous speech interactions with one or more devices configured to carry out similar functions as the target device.

277. (canceled)

278. The system of claim 232, wherein said particular party-correlated previous speech interaction based adaptation data from particular-party associated particular device receiving module comprises:
a particular party-correlated previous other same-type device speech interaction based adaptation data from particular-party associated particular device receiving module.

279. (canceled)

280. The system of claim 232, wherein said particular party-correlated previous speech interaction based adaptation data from particular-party associated particular device receiving module comprises:
a particular party-correlated previous speech interactions observed by particular device based adaptation data from particular-party associated particular device receiving module.

281. (canceled)

282. (canceled)

283. The system of claim 232, wherein said particular party-correlated previous speech interaction based adaptation data from particular-party associated particular device receiving module comprises:
a particular party-correlated adaptation data from particular party associated particular device requesting module; and
an adaptation data partly based on previous adaptation data derived from one or more previous particular party speech interactions receiving module.

284. (canceled)

285. (canceled)

286. (canceled)

287. (canceled)

288. (canceled)

289. (canceled)

290. The system of claim 283, wherein said particular party-correlated adaptation data from particular party associated particular device requesting module comprises:
a particular party-correlated adaptation data regarding one or more target device type associated vocabulary words requesting module configured to request adaptation data regarding one or more vocabulary words associated with a type of device receiving the adaptation data from the particular device associated with the particular party.

291. The system of claim 283, wherein said adaptation data partly based on previous adaptation data derived from one or more previous particular party speech interactions receiving module comprises:
an adaptation data partly based on previous adaptation data derived from one or more previous particular party speech interactions with a prior device receiving module configured to receive adaptation data that is at least partly based on previous adaptation data derived at least in part from one or more speech interactions of the particular party with at least one prior device.

292. The system of claim 291, wherein said adaptation data partly based on previous adaptation data derived from one or more previous particular party speech interactions with a prior device receiving module comprises:
an adaptation data partly based on previous adaptation data derived from one or more previous particular party speech interactions with a common characteristic prior device receiving module.

293. The system of claim 292, wherein said adaptation data partly based on previous adaptation data derived from one or more previous particular party speech interactions with a common characteristic prior device receiving module comprises:
an adaptation data partly based on previous adaptation data derived from one or more previous particular party speech interactions with a same function prior device receiving module.

294. The system of claim 293, wherein said adaptation data partly based on previous adaptation data derived from one or more previous particular party speech interactions with a same function prior device receiving module comprises:
an adaptation data partly based on previous adaptation data derived from one or more previous particular party speech interactions with a ticket dispenser receiving module.

295. (canceled)

296. (canceled)

297. (canceled)

298. (canceled)

299. The system of claim 291, wherein said adaptation data partly based on previous adaptation data derived from one or more previous particular party speech interactions with a prior device receiving module comprises:
an adaptation data partly based on previous adaptation data derived from one or more previous particular party speech interactions with a prior device sharing at least one vocabulary word receiving module.

300. The system of claim 291, wherein said adaptation data partly based on previous adaptation data derived from one or more previous particular party speech interactions with a prior device receiving module comprises:
an adaptation data partly based on previous adaptation data derived from one or more previous particular party speech interactions with a larger vocabulary prior device receiving module.

301. (canceled)

302. The system of claim 232, wherein said particular party-correlated previous speech interaction based adaptation data from particular-party associated particular device receiving module comprises:
a particular party-correlated speech interaction based adaptation data selected based on previous speech interaction similarity with expected future speech interaction particular device receiving module.

303. The system of claim 232, wherein said particular party-correlated previous speech interaction based adaptation data from particular-party associated particular device receiving module comprises:
a particular party-correlated speech interaction based adaptation data selected based on use of specific vocabulary word particular device receiving module.

304. The system of claim 232, wherein said particular party-correlated previous speech interaction based adaptation data from particular-party associated particular device receiving module comprises:
a particular party-correlated previous speech interaction based adaptation data from particular-party speech receiving particular device receiving module, wherein the adaptation data is at least partly based on previous adaptation data derived at least in part from one or more previous speech interactions of the particular party.

305. The system of claim 304, wherein said particular party-correlated previous speech interaction based adaptation data from particular-party speech receiving particular device receiving module comprises:
a particular party-correlated previous speech interaction based adaptation data from particular-party speech receiving smartphone receiving module, wherein the adaptation data is at least partly based on previous adaptation data derived at least in part from one or more previous speech interactions of the particular party.

306. The system of claim 304, wherein said particular party-correlated previous speech interaction based adaptation data from particular-party speech receiving smartphone receiving module comprises:
a particular party-correlated previous speech interaction based adaptation data from particular-party speech receiving particular device having speech transmission software receiving module configured to receive adaptation data correlated to the particular party from a device including speech transmission software to receive speech that is associated with the particular party.

307. (canceled)

308. (canceled)

309. (canceled)

310. (canceled)

311. (canceled)

312. (canceled)

313. (canceled)

314. The system of claim 232, wherein said received adaptation data to target device applying module comprises:
a received adaptation data to target device speech recognition module updating module.

315. (canceled)

316. The system of claim 232, wherein said received adaptation data to target device applying module comprises:
a received adaptation data to target device speech recognition module adjusting module.

317. The system of claim 232, wherein said received adaptation data to target device applying module comprises:
a received adaptation data including pronunciation dictionary to target device speech recognition module applying module.

318. The system of claim 232, wherein said received adaptation data to target device applying module comprises:
a received adaptation data including phoneme dictionary to target device speech recognition module applying module.

319. (canceled)

320. The system of claim 232, wherein said received adaptation data to target device applying module comprises:
a received adaptation data including training set of audio data and corresponding transcript data to target device applying module.

321. (canceled)

322. (canceled)

323. The system of claim 232, wherein said received adaptation data to target device applying module comprises:
a received adaptation data processing for exterior speech recognition module usage processing module.

324. The system of claim 323, wherein said received adaptation data processing for exterior speech recognition module usage processing module comprises:
an accepted vocabulary of speech recognition module of target device reducing module configured to reduce the accepted vocabulary of a speech recognition module of the target device based on the received adaptation data correlated to the particular party.

325. (canceled)

326. The system of claim 232, wherein said target device particular party speech processing using received adaptation data module comprises:
an at least one of speech and applied adaptation data transmitting to interpreting device configured to interpret at least a portion of speech module.

327. (canceled)

328. (canceled)

329. (canceled)

330. (canceled)

331. (canceled)

332. (canceled)

333. (canceled)

334. The system of claim 232, wherein said target device particular party speech processing using received adaptation data module comprises:
a motor vehicle particular party speech processing using received adaptation data module configured to process speech from the particular party using the speech recognition module of the target device to which the received adaptation data has been applied, wherein the target device is a motor vehicle.

335. (canceled)

336. (canceled)

337. (canceled)

338. (canceled)

339. (canceled)

340. (canceled)

341. (canceled)

342. (canceled)

343. The system of claim 232, wherein said target device particular party speech processing using received adaptation data module comprises:
a target device speech recognition module particular party speech processing using received adaptation data module configured to process speech from the particular party using the speech recognition module of the target device to which the received adaptation data has been applied; and
an adaptation data modification based on processed speech from particular party deciding module configured to decide whether to modify the adaptation data based on the speech processed from the particular party by the speech recognition module of the target device to which the received adaptation data has been applied.

344. (canceled)

345. The system of claim 232, wherein said target device particular party speech processing using received adaptation data module comprises:
a modified adaptation data transmitting to particular device module configured to transmit the modified adaptation data to the particular device.

346. The system of claim 343, wherein said adaptation data modification based on processed speech from particular party deciding module comprises:
an adaptation data modifying based on determined confidence level of processed speech module particular party processed speech confidence level determining module configured to determine a confidence level of the speech processed from the particular party by the speech recognition module of the target device; and
a configured to modify the adaptation data based on the determined confidence level of the speech processed from the particular party by the speech recognition module of the target device.
